(19) United States
(12) Patent Application Publication
(10) Pub. No.: US 2026/0370710 A1
(43) Pub. Date: Nov. 19, 2026

(54) DYNAMIC RENDERING OFFLOAD FOR MULTI-MEDIA COMMUNICATIONS

(71) Applicant: QUALCOMM Incorporated, San Diego, CA (US)

(72) Inventors: Mickaël MONDET, Louannec (FR); Saadallah KASSIR, San Diego, CA (US); Prashanth Haridas HANDE, San Diego, CA (US); Peerapol TINNAKORNSRISUPHAP, San Diego, CA (US)

(21) Appl. No.: 19/206,807

(22) Filed: May 13, 2025

(51) Int. Cl. H04L 67/1004

(52) U.S. Cl. CPC H04L 67/1004

(57) ABSTRACT

Dynamic rendering offload for multi-media communications is described. An apparatus transmits, to a network entity, an offload indication of a rendering offload request for an offload rendering operation of UE multi-media content, and receives, from the network entity, an offload indication response based on the offload indication. Another apparatus receives, from a network entity, an offload indication of a rendering offload request for an offload rendering operation of UE multi-media content, and transmits, to another network entity, an offload indication response based on the offload indication. Another apparatus, at a UE, obtains an offload indication of a rendering offload request for an offload rendering operation of multi-media content for the UE, transmits, to a network entity, viewport information for the rendering offload request and offload rendering operation of the multi-media content, and receives, from the network entity, a viewport for a rendering based on the viewport information.

### TECHNICAL FIELD

The present disclosure relates generally to communication systems, and more particularly, to wireless communications utilizing rendering for multi-media communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology, such as 6G, among other examples. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be or may comprise a network entity. The apparatus is configured to transmit, to a second network entity that is different from the first network entity, an offload indication of a rendering offload request associated with an offload rendering operation of multi-media content for a user equipment (UE). The apparatus is configured to receive, from the second network entity, an offload indication response based on the offload indication.

In the aspect, the method includes transmitting, to a second network entity that is different from the first network entity, an offload indication of a rendering offload request associated with an offload rendering operation of multi-media content for a UE. The method also includes receiving, from the second network entity, an offload indication response based on the offload indication.

In an aspect of the disclosure, a method, a computer-readable medium, and an apparatus are provided. The apparatus may be or may comprise a network entity. The apparatus is configured to receive, from a second network entity that is different from the first network entity, an offload indication of a rendering offload request associated with an offload rendering operation of multi-media content for a UE. The apparatus is configured to transmit, to a third network entity that is different from the first network entity, an offload indication response based on the offload indication.

In the aspect, the method receiving, from a second network entity that is different from the first network entity, an offload indication of a rendering offload request associated with an offload rendering operation of multi-media content for a UE. The method also includes transmitting, to a third network entity that is different from the first network entity, an offload indication response based on the offload indication. In an aspect of the disclosure, a method, a computer-readable medium, and an apparatus are provided. The apparatus may be or may comprise a UE. The apparatus is configured to obtain an offload indication of a rendering offload request associated with an offload rendering operation of multi-media content for the UE. The apparatus is configured to transmit, to a first network entity via first out-of-band signaling, viewport information associated with the rendering offload request and the offload rendering operation of the multi-media content. The apparatus is configured to receive, from the first network entity, a viewport associated with a rendering that is based on the viewport information.

In the aspect, the method includes obtaining an offload indication of a rendering offload request associated with an offload rendering operation of multi-media content for the UE. The method also includes transmitting, to a first network entity via first out-of-band signaling, viewport information associated with the rendering offload request and the offload rendering operation of the multi-media content. The method further includes receiving, from the first network entity, a viewport associated with a rendering that is based on the viewport information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an examples of Selective Forwarding Unit (SFU) and Multipoint Conferencing Unit (MCU) architectures, in accordance with various aspects of the present disclosure.

FIG. 5 is a diagram illustrating an example of rendering offload in an SFU architecture, in accordance with various aspects of the present disclosure.

FIG. 6 is a diagram illustrating an example of rendering offload in an MCU architecture, in accordance with various aspects of the present disclosure.

FIG. 7 is a diagram illustrating examples of dynamic rendering offload in SFU and MCU architectures, in accordance with various aspects of the present disclosure.

FIG. 8 is a call flow diagram for wireless and/or wired communications, in accordance with various aspects of the present disclosure.

FIG. 9 is a call flow diagram for wireless and/or wired communications, in accordance with various aspects of the present disclosure.

FIG. 10 is a call flow diagram for wireless and/or wired communications, in accordance with various aspects of the present disclosure.

FIG. 11 is a diagram illustrating an example of rendering offload initiated by a UE, in accordance with various aspects of the present disclosure.

FIG. 12 is a diagram illustrating an example of rendering offload initiated by a UE, in accordance with various aspects of the present disclosure.

FIG. 13 is a diagram illustrating an example of rendering offload initiated by a host server, in accordance with various aspects of the present disclosure.

FIG. 14 is a diagram illustrating an example of rendering offload initiated by a UE or a host sever, and facilitated by a render server, in accordance with various aspects of the present disclosure.

FIG. 15 is a diagram illustrating an example of rendering offload initiated by a UE, in accordance with various aspects of the present disclosure.

FIG. 16 is a diagram illustrating an example of rendering offload canceled by a UE via a host server, in accordance with various aspects of the present disclosure.

FIG. 17 is a diagram illustrating an example of rendering offload canceled by a host server, in accordance with various aspects of the present disclosure.

FIG. 18 is a diagram illustrating an example of rendering offload canceled by a render server, in accordance with various aspects of the present disclosure.

FIG. 19 is a diagram illustrating an example of rendering offload canceled by a UE via a render server, in accordance with various aspects of the present disclosure.

FIG. 20 is a flowchart of a method of wireless communication.

FIG. 21 is a flowchart of a method of wireless communication.

FIG. 22 is a flowchart of a method of wireless communication.

FIG. 23 is a flowchart of a method of wireless communication.

FIG. 24 is a flowchart of a method of wireless communication.

FIG. 25 is a flowchart of a method of wireless communication.

FIG. 26 is a diagram illustrating an example of a hardware implementation for an example apparatus and/or network entity.

FIG. 27 is a diagram illustrating an example of a hardware implementation for an example network entity.

FIG. 28 is a diagram illustrating an example of a hardware implementation for an example network entity.

### DETAILED DESCRIPTION

Wireless communication networks and systems may be utilized for communications between network nodes and/or network entities (e.g., base stations, gNBs, host servers, etc.) and UEs, etc. Some wireless communication systems (such as a 5G system (or another type of system described herein, or advanced systems such as 5G derivatives, 6G, etc.)) may provide multi-media communications (e.g., holographic communications) between UEs utilizing host servers (e.g., main servers, application servers, etc.) that provide applications for such communications. Each UE participating in multi-media communication sessions may provide user data (e.g., video capture data) to a host server. In some implementations, a host server may forward the user data of other UEs to each UE such that each UE renders image content, such as a viewport, based on its own user data and user data from the other UEs. In other implementations, a host server may periodically render a common scene based on the user data of each UE and forward the rendered common scene to each UE, while each UE renders image content, such as a viewport, based on its own user data.

However, adaptations to scenarios associated with radio conditions, numbers of users or UEs in multi-media sessions, device (e.g., a UE) processing power, host server and/or edge server processing power, user preferences, and/or the like, may be improved through adaptive utilization of offload rendering from a device (e.g., a UE) to a render server (also a rendering server) and rendering at the device without offloading.

Various aspects relate generally to rendering for multi-media communications. Some aspects more specifically relate to dynamic rendering offload for multi-media communications (e.g., holographic communications). In some examples, aspects of dynamic rendering offload for multi-media communications, a device (e.g., a UE) in a communications session, via a host server, may offload rendering of viewports to a render server, which may be a separate server than the host or main server hosting a multi-media communications application. In some examples, aspects herein provide signaling techniques for dynamic rendering offloads in both Selective Forwarding Unit (SFU) and Multipoint Conferencing Unit (MCU) architectures, although aspects are not so limited and may be utilized in other architectures as would be understood by persons of skill in the relevant art(s) having the benefit of this disclosure. In some examples, dynamic rendering offload for multi-media communications may be initiated by a device, by a render server, or by a host server, and similarly, dynamic rendering offloads may be canceled by a device, by a render server, or by a host server.

Particular aspects of the subject matter described in this disclosure can be implemented to realize one or more of the following potential advantages. In some examples, by providing adaptive utilization of offload rendering from a device to a render server, the described techniques can be used to account for changes to radio links in communication sessions, numbers of users in communication sessions, device processing power utilization, and user preferences. In some examples, by providing adaptive utilization of offload rendering to switch back from offloading to rendering at the device without offloading, the described techniques can be used to account for changes to radio links in communication sessions, numbers of users in communication sessions, server (e.g., including edge servers) and/or device processing power utilization, and user preferences.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

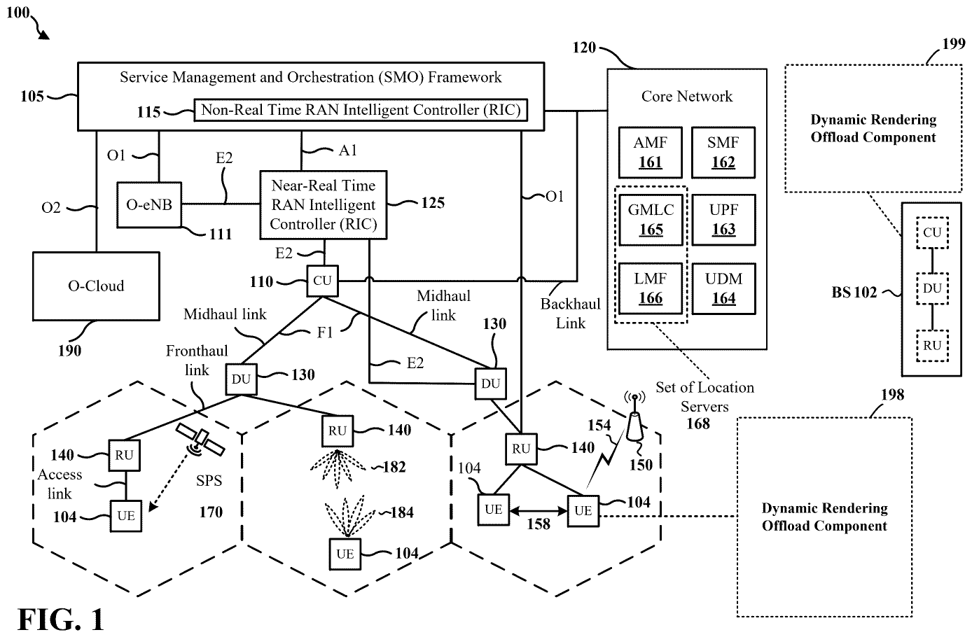

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. The electromagnetic spectrum is often subdivided, based on frequency/wavelength, into various classes, bands, channels, etc. As an example, to illustrate the concept, in 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHZ-24.25 GHZ), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a dynamic rendering offload component 198 (“a component 198”) that may be configured to obtain an offload indication of a rendering offload request associated with an offload rendering operation of multi-media content for the UE. The component 198 may be configured to transmit, to a first network entity via first out-of-band signaling, viewport information associated with the rendering offload request and the offload rendering operation of the multi-media content. The component 198 may be configured to receive, from the first network entity, a viewport associated with a rendering that is based on the viewport information. The component 198 may be configured to transmit, to the second network entity via second out-of-band signaling and based on the determined offload condition, the rendering offload request associated with the offload rendering operation of the multi-media content. The component 198 may be configured to receive, from the second network entity, a response indication associated with an offload indication response. The component 198 may be configured to transmit, to the first network entity via first out-of-band signaling and subsequent to reception of the viewport, a first offload cancelation indication, and receive, from the first network entity via second out-of-band signaling and based on the first offload cancelation indication, an offload cancelation acknowledgement. The component 198 may be configured to receive, from the first network entity, a second offload cancelation indication. The component 198 may be configured to cease transmissions of further viewport information based on at least one of the first offload cancelation indication or the second offload cancelation indication. In certain aspects, the base station 102 may have a dynamic rendering offload component 199 (“a component 199”) that may be configured to transmit, to a second network entity that is different from the first network entity, an offload indication of a rendering offload request associated with an offload rendering operation of multi-media content for a UE. The component 199 may also be configured to receive, from the second network entity, an offload indication response based on the offload indication. The component 199 may also be configured to receive, from the UE via first out-of-band signaling, the rendering offload request associated with the offload rendering operation of the multi-media content. The component 199 may also be configured to transmit, to the UE, a response indication associated with the offload indication response. The component 199 may also be configured to transmit, to the second network entity, information of at least one additional UE that is associated with the offload rendering operation of the multi-media content. The component 199 may also be configured to transmit, to the UE via out-of-band signaling, an offload notification that is associated with the offload indication response and that is indicative of transmission of the offload indication of the rendering offload request. The component 199 may also be configured to transmit, to the second network entity and subsequent to reception of the offload indication response, a first offload cancelation indication, and receive, from the second network entity based on the first offload cancelation indication, an offload cancelation acknowledgement. The component 199 may also be configured to receive, from the second network entity, a second offload cancelation indication. The component 199 may be configured to receive, from a second network entity that is different from the first network entity, an offload indication of a rendering offload request associated with an offload rendering operation of multi-media content for a UE. The component 199 may also be configured to transmit, to a third network entity that is different from the first network entity, an offload indication response based on the offload indication. The component 199 may also be configured to obtain, subsequent to transmission of the offload indication response, a rendering availability indication indicative of an absence of the rendering overload. The component 199 may also be configured to transmit, to the second network entity and based on the rendering availability indication, an offload availability indication indicative of an availability at the first network entity for offload rendering. The component 199 may also be configured to render a viewport based on the viewport information and an offload notification acknowledgement. The component 199 may also be configured to transmit, for the UE, the viewport. The component 199 may also be configured to receive, from the host server, the offload notification acknowledgement subsequent to transmission of the offload notification. The component 199 may also be configured to receive, from the third network entity, information of at least one additional UE that is associated with the offload rendering operation of the multi-media content. The component 199 may also be configured to receive, from the third network entity and subsequent to transmission of the offload indication response, a first offload cancelation indication, and transmit, to the third network entity based on the first offload cancelation indication, an offload cancelation acknowledgement. The component 199 may also be configured to transmit, to at least one of the second network entity or the third network entity, a second offload cancelation indication. Aspects herein for dynamic rendering offload for multi-media communications, such as holographic communications, sessions thereof, and/or the like, enable a device in a communications session, via a host server, to offload the rendering of viewports to a render server, enable signaling for dynamic rendering offloads in both SFU and MCU architectures, and provide for dynamic rendering offloads to be initiated and/or canceled by a device, by a render server, or by a host server. Aspects further account for changes to radio links in communication sessions, numbers of users in communication sessions, device processing power utilization, user preferences, and/or the like.

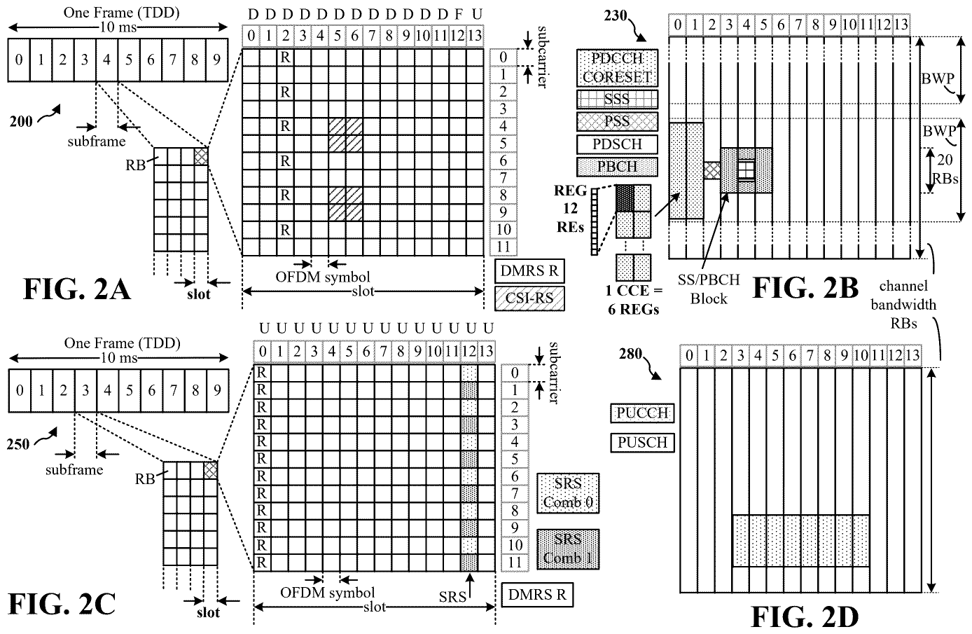

FIG. 2A is a diagram 200 illustrating an example of a first subframe within a 5G NR frame structure. The examples in FIGS. 2A-2D, illustrate aspects of a frame structure based on 5G NR to illustrate the concept of time and frequency resources based on a frame structure. Some aspects may be used in connection with other technology, such as 6G, for example. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

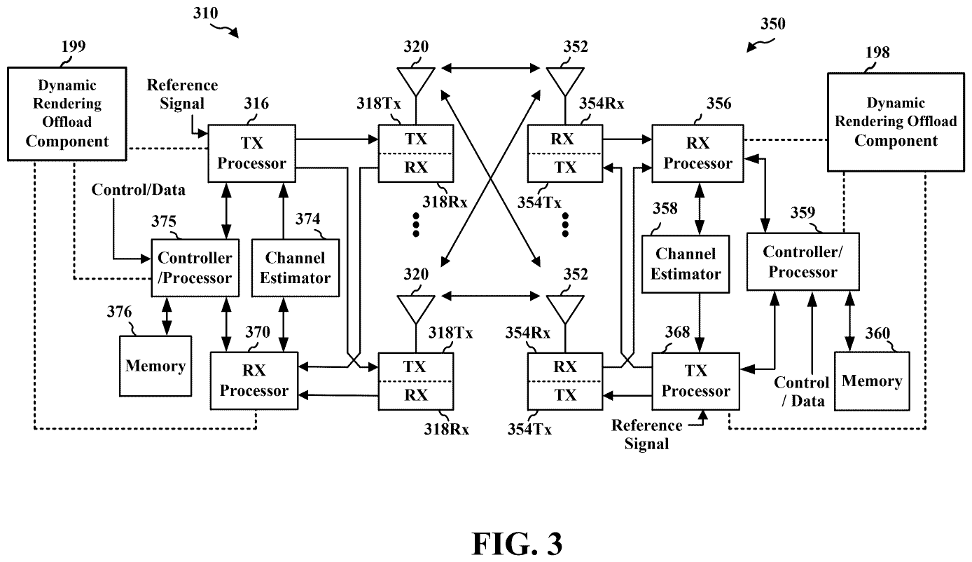

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

As used herein, the term user data may refer to data issued by an application client, e.g., a video frame (such as a volumetric capture), animation parameters (avatar), and/or the like. As used herein, the term viewport information may refer to information about the user, such as but not limited to the head pose of the user, that is may be used by the viewport rendering. As used herein, the term scene may refer to a general environment common to all users of a communication session. As used herein, the term scene processing may refer to a scene generated from all user data, which may be common to all users. As used herein, the term rendering may refer to a user-specific viewport rendered from the latest common scene and viewport information.

As noted above, aspects herein may provide for signaling techniques for dynamic rendering offloads in both SFU and MCU architectures, although aspects are not so limited and may be utilized in other architectures as would be understood by persons of skill in the relevant art(s) having the benefit of this disclosure. In some examples, an SFU architecture may include an application or host server which forwards the user data (e.g., video capture) from one user to all other users immediately, and in which rendering may be fully performed at the device (e.g., the UE). In some examples, an MCU architecture may include an application or host server which periodically processes a common scene from all user data (e.g., the common scene is transmitted to each user), and in which rendering may be split between the server application or host and the device.

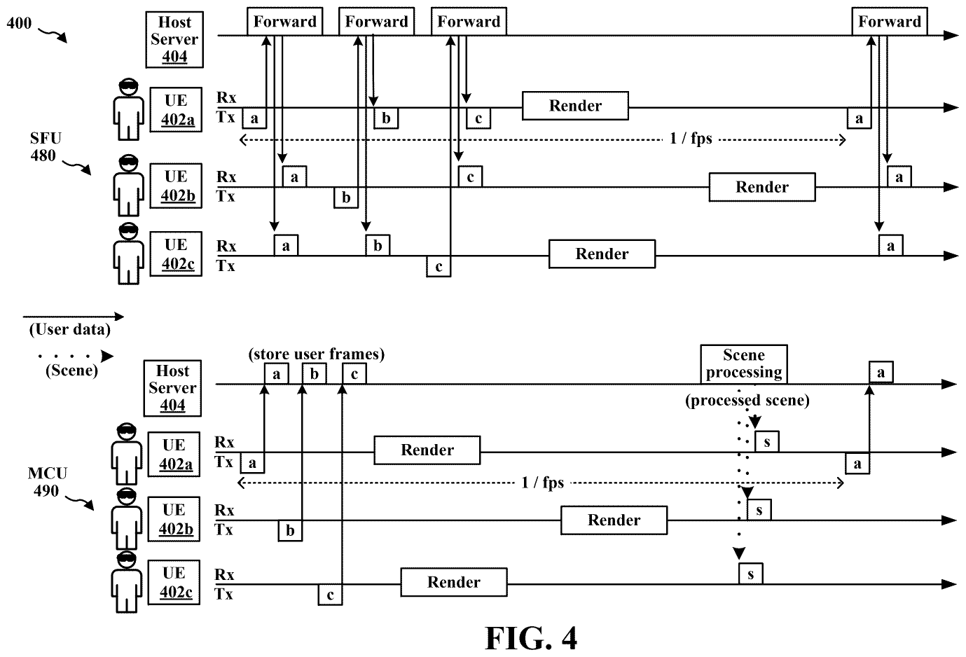

FIG. 4 is a diagram 400 illustrating an examples of SFU and MCU architectures, in various aspects. Diagram 400 shows an example SFU architecture 480 and an example MCU architecture 490, each of which include, by way of example, a host server 404, as well as a UE 402a, a UE 402b, and a UE 402c, which may be UEs in a multi-media communication session via the host server 404.

In the example SFU architecture 480, user data of each UE (e.g., the UE 402a, the UE 402b, and the UE 402c) may be transmitted to the host server 404, and the host server 404 may forward data of the respective UEs to the other UEs. Each of the UE 402a, the UE 402b, and the UE 402c may be configured to render its own viewport based on its own user data, as well as based on the user data of the other UEs.

In the example MCU architecture 490, user data of each UE (e.g., the UE 402a, the UE 402b, and the UE 402c) may be transmitted to the host server 404. Each of the UE 402a, the UE 402b, and the UE 402c may be configured to render its own viewport based on its own user data, as well as based on a processed scene associated with the user data of all the UEs.

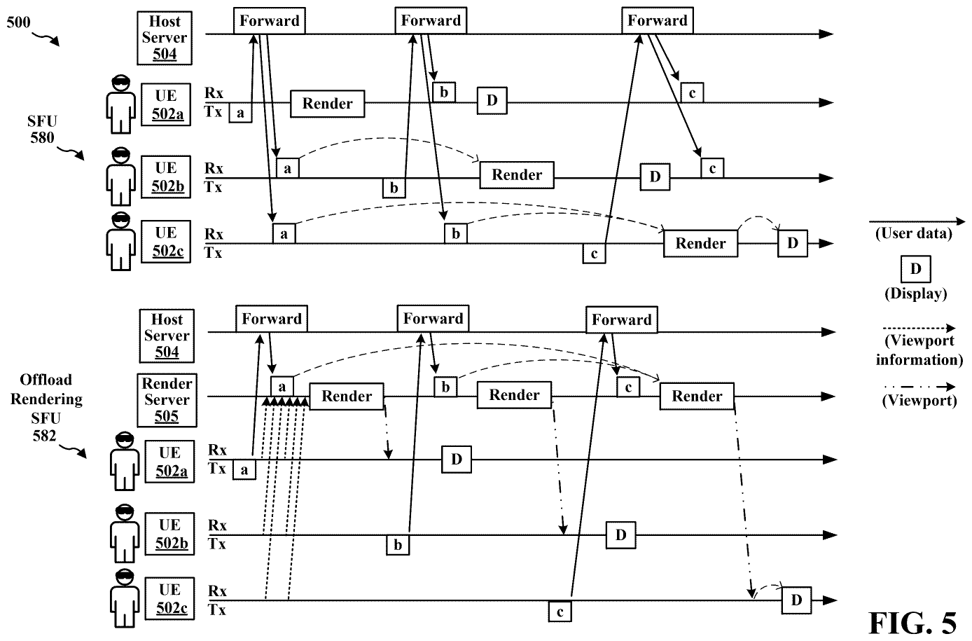

FIG. 5 is a diagram 500 illustrating an example of rendering offload in an SFU architecture, in various aspects. Diagram 500 shows an example SFU architecture 580 and an example SFU architecture 582 with offload rendering, each of which include, by way of example, a host server 504, as well as a UE 502a, a UE 502b, and a UE 502c, which may be UEs in a multi-media communication session via the host server 504.

In the example SFU architecture 580, user data of each UE (e.g., the UE 502a, the UE 502b, and the UE 502c) may be transmitted to the host server 504, and the host server 504 may forward data of the respective UEs to the other UEs. Each of the UE 502a, the UE 502b, and the UE 502c may be configured to render its own viewport based on its own user data, as well as based on the user data of the other UEs. However, given that a user receives data from all other users, with some traffic types, e.g., volumetric capture, the data rate may be high, and thus a given user may not be able to sustain the high data rates, e.g., if there are many users in the multi-media communication session. Additionally, the rendering may be fully performed at the device (e.g., the UE 502a, the UE 502b, and the UE 502c), and rendering operations may consume significant processing power and may impact the device power consumption and/or timeliness of rendering.

In the example SFU architecture 582 with offload rendering, a render server 505, which is a different server (e.g., logically and/or physically) from the host server 504, may be included. Thus, rendering operations of a given UE may be offloaded to the render server 505. For instance, each UE (e.g., the UE 502a, the UE 502b, and the UE 502c) may transmit its viewport information (e.g., a head pose) to the render server 505, and may transmit its user data to the host server 504. The host server 504 may forward the user data to the render server 505, which may render a user-specific viewport from all user data and from viewport information. That is, a UE may no longer receive data from all other users via such offload rendering; instead, the UE may receive the viewport, as rendered by the render server 505 based on the user data and the viewports. As the render server 505 performs the rendering, a UE that has offloaded its render may receive and display the rendered viewport, as received from the render server 505, and the UE processing power and power consumption may be reduced. In some examples, however, configuration for hosting the rendering at a UE or at the render server 505 may be set during the deployment or when the service is being setup, which is suboptimal.

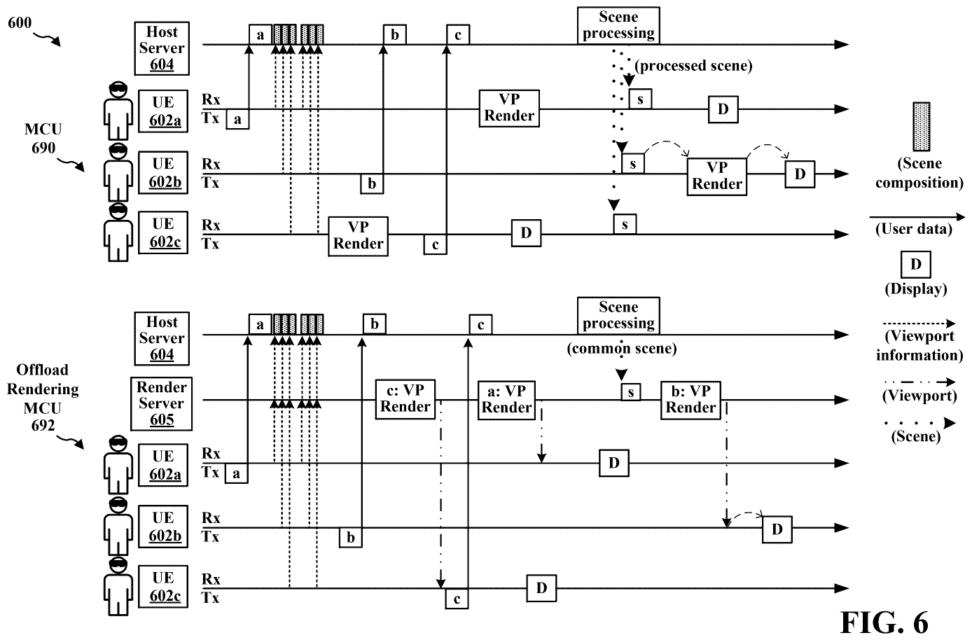

FIG. 6 is a diagram 600 illustrating an example of rendering offload in an MCU architecture, in various aspects. Diagram 600 shows an example MCU architecture 690 and an example MCU architecture 692 with offload rendering, each of which include, by way of example, a host server 604, as well as a UE 602a, a UE 602b, and a UE 602c, which may be UEs in a multi-media communication session via the host server 604.

In the example MCU architecture 690, rendering may be split between the host server 604 and a give UE (e.g., the UE 602a, the UE 602b, the UE 602c). The host server 604 may process a scene that is common to all UEs, and this common scene may be transmitted to each of the UE 602a, the UE 602b, and the UE 602c. Each UE may render a viewport from this common scene, and even though this process may be expected to be less costly than with the SFU architectures described above, the operations performed by each UE may still consume processing power and may impact the power consumption.

In the example MCU architecture 692 with offload rendering, a render server 605 may be included, which may be an edge server and is a different server (e.g., logically and/or physically) from the host server 604, which may be a cloud server, a core network server, etc. The host server 604 may perform scene composition and processing, and may provide common scenes to the render server 605. The render server 605 may perform UE-specific viewport (VP) rendering based on viewport information and/or the user data of each UE (e.g., the UE 602a, the UE 602b, and the UE 602c), and may transmit or provide respective rendered viewports to the UEs. Thus, a given UE may simply display its rendered viewport that is received from the render server 605, and the UE processing power and power consumption may be reduced. In some examples, however, configuration for hosting the rendering at a UE or at the render server 605 may be set during the deployment or when the service is being setup, which is suboptimal.

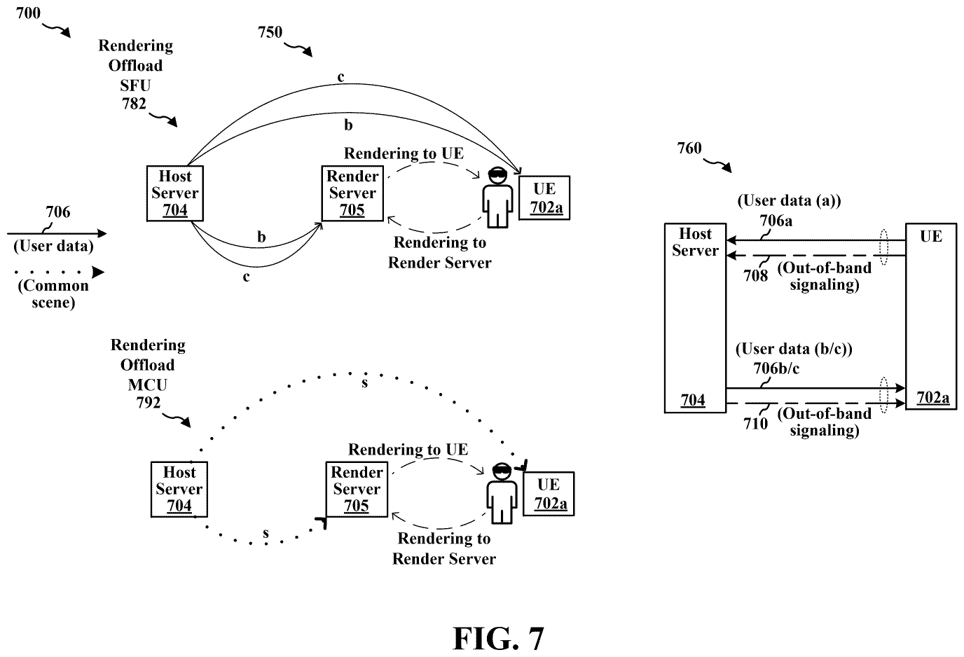

FIG. 7 is a diagram 700 illustrating examples of dynamic rendering offload in SFU and MCU architectures, in various aspects. Diagram 700 shows simplified examples of configurations 750 for rendering offload in an SFU architecture 782 and rendering offload in an MCU architecture 792, for a UE 702a, a host server 704, and a render server 705. Diagram 700 also shows a simplified example of a configuration 760 for rendering offload communications via out-of-band signaling.

In the context of the configurations 750, and for rendering offload in the SFU architecture 782, the UE 702a may dynamically offload rendering to the render server 705, which may render viewports based on received user data 706 of other UEs (e.g., a UE ‘b’ and a UE ‘c’) from the host server 704, and based on user data of the UE 702a. The offload rendering may be dynamically canceled such that the UE 702a performs its own rendering based its own user data and based on received user data 706 of other UEs (e.g., a UE ‘b’ and a UE ‘c’) from the host server 704.

In the context of the configurations 750, and for rendering offload in the MCU architecture 792, the UE 702a may dynamically offload rendering to the render server 705, which may render viewports based on received common scenes (e.g., associated with user data and composition for the UE 702a, a UE ‘b’, and a UE ‘c’) from the host server 704. The offload rendering may be dynamically canceled such that the UE 702a performs its own rendering based its own user data and based on received common scenes from the host server 704.

In the context of the configuration 760, the host server 704 may receive, and the UE 702a may transmit or provide, user data 706a associated with the UE 702a, which may be transmitted or provided with, e.g., accompanied by, out-of-band signaling 708. In aspects, the out-of-band signaling 708 may comprise a rendering offload request and/or the like, as described herein. The host server 704 may transmit or provide, and the UE 702a may receive, user data 706b/c associated with other UEs (e.g., such as the UE ‘b’, the UE ‘c’, etc.), as noted above. The user data 706b/c may be transmitted or provided with, e.g., accompanied by, out-of-band signaling 710. In aspects, the out-of-band signaling 710 may comprise a rendering offload notification or response, and/or the like, as described herein.

Dynamically offloaded rendering to a render server provides adaptations to scenarios associated with radio conditions (e.g., radio link quality deteriorates and may no longer sustain the data rates (such as for volumetric traffic); radio link quality improves and may sustain viewport data rates), numbers of users or UEs in multi-media sessions (e.g., additional user(s) join a session and data rates may no longer be supported by the wireless link (such as for volumetric traffic)), device (e.g., a UE) processing power or heat dissipation are not sustainable, user preferences (e.g., offloaded rendering may be preferred by a user to improve the user experience), and/or the like. Likewise, cancelation of dynamically offloaded rendering, e.g., returning rendering to the device (e.g., the UE) without offloading provides adaptations to scenarios associated with radio conditions (e.g., radio link quality improves and may sustain individual device data rates (such as for volumetric traffic); radio link quality deteriorates and may no longer sustain viewport data rates), numbers of users or UEs in multi-media sessions (e.g., user(s) leave a session and data rates may again be supported by the wireless link (such as for volumetric traffic)), device (e.g., a UE) processing power or heat dissipation are again sustainable, host server and/or edge server processing power exceed sustainability, and/or the like. Such adaptation to the rendering, e.g., to at times offload rendering to the render server, may be referred to as dynamic offloading, e.g., because it enables changes to be implemented as conditions change.

That is, aspects herein provide for dynamic rendering offload for multi-media communications in which rendering may be offloaded from a UE to a render server, and in which offload rendering may be canceled to return rendering operations to the UE. The aspects herein provide for signaling techniques for dynamic rendering offloads in both SFU and MCU architectures between UEs and host servers (e.g., application servers, main servers, etc.), between host servers and render servers, between UEs and render servers, and/or the like. Aspects herein may be described in the context of three devices (e.g., UEs) for dynamic rendering offload for multi-media communications, although aspects include additional devices and/or fewer devices.

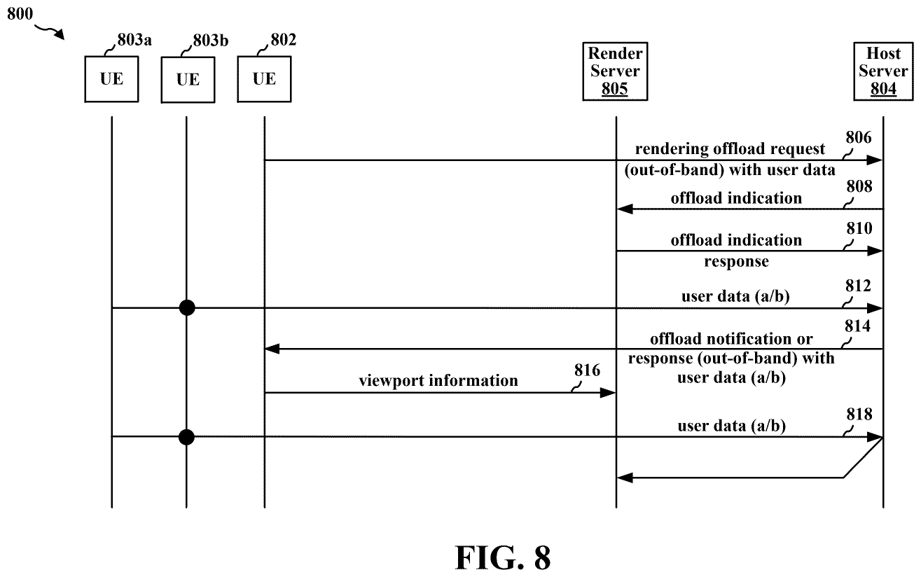

FIG. 8 is a call flow diagram 800 for wireless and/or wired communications, in various aspects. Call flow diagram 800 may be an example of rendering offload at a host server and illustrates dynamic rendering offload for multi-media communications between a UE 802, a host server 804, and a render server 805. In aspects, the UE 802, the host server 804, and/or the render server 805 may be network entities that communicate at least in part via a wireless communication network. In some aspects, the wireless communication network may comprise one or more base stations and/or gNBs, TRPs, etc., by which the UE 802 communicates with the host server 804 and/or the render server 805. In aspects, the host server 804 and/or the render server 805 may reside at a core network and/or may be an edge server.

The host server 804 (e.g., a first network entity) may be configured to transmit, to a second network entity (e.g., the render server 805) that is different from the first network entity, an offload indication 808 of a rendering offload request 806 (via first out-of-band signaling) associated with an offload rendering operation of multi-media content for a UE (e.g., the UE 802).

The host server 804 may be configured to receive, from the second network entity (e.g., the render server 805), an offload indication response 810 based on the offload indication 808. The host server 804 may be configured to transmit, to the UE 802, a response indication (e.g., an offload notification or response 814) associated with the offload indication response 810. In some aspects, the UE 802 may initiate offload rendering to the render server 805, while in other aspects, the host server 804 may be configured to initiate offload rendering to the render server 805.

For example, in offload rendering initiated by the host server 804, the offload indication response 810 may be an offload acknowledgement indicative of an acceptance of the rendering offload request 806 via the offload indication 808. In such aspects, e.g., to notify the UE 802 of the offload rendering, the host server 804 may be configured to transmit, to the UE 802 via second out-of-band signaling, an offload notification (e.g., the offload notification or response 814) that is associated with the offload indication response 810 and that is indicative of transmission of the offload indication 808 of the rendering offload request 806. As another example, in offload rendering initiated by the UE 802, the host server 804 may be configured to receive, from the UE 802, via first out-of-band signaling (e.g., with user data associated with the UE 802), the rendering offload request 806 associated with the offload rendering operation of the multi-media content.

In some aspects, at least one of the first out-of-band signaling or the second out-of-band signaling may be associated with user data provision(s), and such user data (e.g., from the UE 802 and received by the UE 802 from the host server 804 in association with the offload notification or response 814 via second out-of-band signaling) may comprise information of at least one additional UE (e.g., the user data 812 of the UE 803a and/or the UE 803b) that is associated with the offload rendering operation of the multi-media content. In aspects, the host server 804 may receive the user data 812 for forwarding to other UEs and/or for rendering common scenes of a multi-media communication session between the UEs. In aspects for which the offload indication response 810 may be an offload acknowledgement indicative of an acceptance of the rendering offload request 806 via the offload indication 808, the host server 804 may be configured to transmit, to the second network entity (e.g., the render server 805), information of the at least one additional UE (e.g., the UE 803a and/or the UE 803b) that is associated with the offload rendering operation of the multi-media content (e.g., user data 818).

Accordingly, the UE 802 may be configured to transmit, to the render server 805, the viewport information 816. Additionally, the host server 804 may be configured to receive, from the UE 803a and/or the UE 803b, the user data 818, and to transmit or provide, to the render server 805 for utilization in rendering, the user data 818 rather than transmitting or providing the user data 818 of the UE 803a and/or the UE 803b to the UE 802 for utilization in rendering a viewport (e.g., transmitted or provided to the UE 802 from the render server 805).

In aspects, the offload indication response 810 may be an offload rejection indicative of a denial of the rendering offload request 806. In such aspects, the response indication (e.g., the offload notification or response 814) may indicate the denial and may comprise second out-of-band signaling (e.g., associated with the user data for the UE 803a and/or the UE 803b). The host server 804 may be configured to transmit, to the second network entity (e.g., the render server 805) and subsequent to reception of the offload indication response 810), a first offload cancelation indication, and in such aspects, the host server 804 may be configured to receive, from the second network entity based on the first offload cancelation indication, an offload cancelation acknowledgement (e.g., where the UE 802 or the host server 804 initiates cancelation of the offload rendering). The host server 804 may be configured to obtain an offload cancelation request associated with at least one of a UE request (e.g., UE 802 initiates cancelation) or a determination of a cancelation condition at the first network entity (e.g., host server 804 initiates cancelation). In some aspects, the host server 804 may be configured to receive, from the second network entity (e.g., the render server 805), a second offload cancelation indication (e.g., where the render server 805 initiates cancelation of the offload rendering).

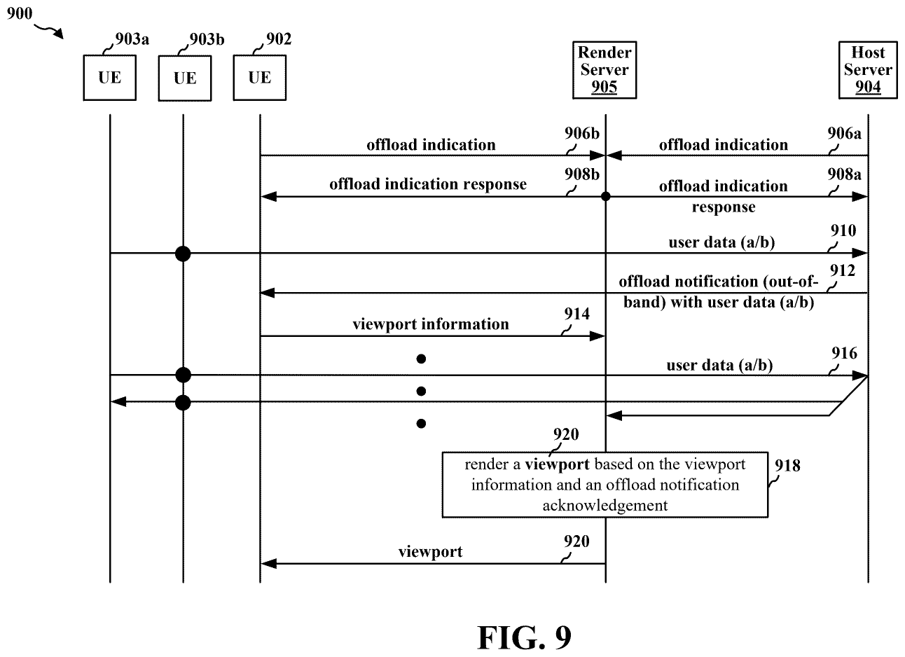

FIG. 9 is a call flow diagram 900 for wireless and/or wired communications, in various aspects. Call flow diagram 900 may be an example of rendering offload for a render server and illustrates dynamic rendering offload for multi-media communications between a UE 902, a host server 904, and a render server 905. In aspects, the UE 902, the host server 904, and/or the render server 905 may be network entities that communicate at least in part via a wireless communication network. In some aspects, the wireless communication network may comprise one or more base stations and/or gNBs, TRPs, etc., by which the UE 902 communicates with the host server 904 and/or the render server 905. In aspects, the host server 904 and/or the render server 905 may reside at a core network and/or may be an edge server.

The render server 905 (e.g., a first network entity) may be configured to receive, from a second network entity (e.g., the host server 904 when initiating offload rendering or the UE 902 when initiating offload rendering) that is different from the first network entity, an offload indication (e.g., an offload indication 906a or an offload indication 906b) of a rendering offload request associated with an offload rendering operation of multi-media content for the UE 902.

The render server 905 (e.g., the first network entity) may be configured to transmit, to a third network entity (e.g., the UE 902 when initiating offload rendering or the host server 904 when initiating offload rendering) that is different from the first network entity, an offload indication response (e.g., an offload indication response 908b or an offload indication response 908a) based on the offload indication (e.g., the offload indication 906b or the offload indication 906a).

In some aspects, e.g., where the host server 904 initiates offload rendering), the host server 904 may be configured to receive, from the UE 903a and/or the UE 903b, user data 910, and to transmit or provide, which may be received by the UE 902, an offload notification 912 as out-of-band signaling with the user data 910. In aspects, the host server 904 may receive the user data 910 for forwarding to other UEs and/or for rendering common scenes of a multi-media communication session between the UEs.

The render server 905 may be configured to render (at 918) a viewport based on the viewport information and an offload notification acknowledgement. As one example, the host server 904 may be configured to receive, from the UE 903a and/or the UE 903b, user data 916, and to transmit or provide, which may be received by the render server 905 for utilization in rendering (at 918), the user data 916 rather than transmitting or providing the user data 916 of the UE 903a and/or the UE 903b to the UE 902 for utilization in rendering (at 918) the viewport 920. The render server 905 may be configured to transmit or provide the viewport 920 (rendered at (918)) to the UE 902.

In aspects for which the first network entity is the render server 905 and the second network entity is the UE 902, the render server 905 may be configured to receive the offload indication 906b of the rendering offload request, including to receive, from the UE 902, the viewport information 914 associated with the rendering offload request and the offload rendering operation of the multi-media content for the UE 902. In such aspects, the render server 905 may be configured to render (at 918) the viewport 920 based on the viewport information 914 and an offload notification acknowledgement (e.g., with the offload indication response 908b), and to transmit, to the UE 902, the viewport 920.

In aspects for which the third network entity is the host server 904, and the offload indication response 908a is an offload notification, the render server 905 may be configured to receive, from the host server 904, an offload notification acknowledgement subsequent to transmission of the offload notification.

The render server 905 may be configured to receive, from the third network entity (e.g., the host server 904), information (e.g., the user data 916) of at least one additional UE (the UE 803a and/or the UE 803b) that is associated with the offload rendering operation of the multi-media content. The render server 905 may be configured to render (at 918) the viewport 920 further based on the information of the at least one additional UE.

In some aspects, the render server 905 may be unavailable for offload rendering (e.g., based on a rendering overload). Accordingly, the render server 905 may deny offload requests and/or offload indications. For example, the render server 905 may be configured to transmit or provide the offload indication response (e.g., 908a or 908b) as an offload rejection indicative of a denial of the rendering offload request based on an indication of a rendering overload at the render server 905). In such aspects, the render server 905 may be configured to obtain, subsequent to transmission of the offload indication response (e.g., 908a or 908b), a rendering availability indication indicative of an absence of the rendering overload. The render server 905 may be configured to the transmit, to the second network entity (e.g., the host server 904) and based on the rendering availability indication, an offload availability indication indicative of an availability at the first network entity (e.g., the render server 905) for offload rendering. In aspects, the offload availability indication may be further indicative of a number of rendering processes associated with the availability at the first network entity (e.g., the render server 905) for the offload rendering.

The render server 905 may be configured (i) to receive, from the third network entity (e.g., the host server 904) and subsequent to transmission of the offload indication response, a first offload cancelation indication, and transmit, to the third network entity based on the first offload cancelation indication, an offload cancelation acknowledgement and/or (ii) to transmit, to at least one of the second network entity or the third network entity (e.g., the UE 902 and/or the host server 904), a second offload cancelation indication. The render server 905 may be configured to transmit the second offload cancelation indication subsequent to obtainment of an offload cancelation request associated with at least one of a UE 902 request or a determination of a cancelation condition at the first network entity (e.g., the render server 905).

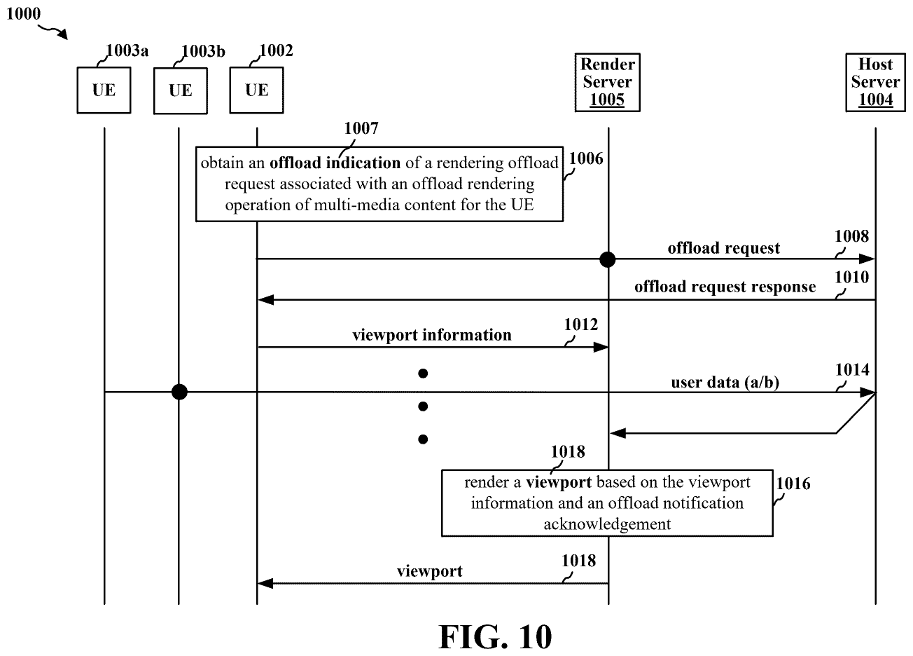

FIG. 10 is a call flow diagram 1000 for wireless and/or wired communications, in various aspects. Call flow diagram 1000 may be an example of rendering offload for a UE and illustrates dynamic rendering offload for multi-media communications between a UE 1002, a host server 1004, and a render server 1005. In aspects, the UE 1002, the host server 1004, and/or the render server 1005 may be network entities that communicate at least in part via a wireless communication network. In some aspects, the wireless communication network may comprise one or more base stations and/or gNBs, TRPs, etc., by which the UE 1002 communicates with the host server 1004 and/or the render server 1005. In aspects, the host server 1004 and/or the render server 1005 may reside at a core network and/or may be an edge server.

The UE 1002 may be configured to obtain (at 1006) an offload indication 1007 of a rendering offload request 1008 associated with an offload rendering operation of multi-media content for the UE 1002. In aspects, to obtain (at 1006) the offload indication 1007 of the rendering offload request 1008, the UE 1002 may be configured to at least one of determine an offload condition at the UE 1002 and/or to receive, from a second network entity (e.g., the host server 1004) via first out-of-band signaling, the offload indication 1007 of the rendering offload request 1008. In aspects, the host server 1004 may receive the user data for forwarding to other UEs and/or for rendering common scenes of a multi-media communication session between the UEs.

In some aspects, the UE 1002 may be configured to transmit, to the second network entity (e.g., the host server 1004) via second out-of-band signaling and based on the determined offload condition, the rendering offload request 1008 associated with the offload rendering operation of the multi-media content. In such aspects, the UE 1002 may be configured to receive, from the second network entity, a response indication associated with an offload indication response (e.g., an offload request response 1010). The offload indication response may be an offload acknowledgement indicative of an acceptance of the rendering offload request 1008, and the UE 1002 may be configured to transmit, to the first network entity (e.g., the render server 1005), the viewport information 1012, the UE 1002 may be configured to transmit the viewport information 1012 based on the offload acknowledgement indicative of the acceptance of the rendering offload request. In aspects, state information associated with a session of the multi-media communications may comprise the viewport information 1012.

The UE 1003a and/or the UE 1003b may be configured to transmit, to the second network entity (e.g., the host server 1004), respective instances of user data 1014, and the host server 1004 may be configured to transmit or provide the user data 1014 to the render server 1005 (e.g., the first network entity) for the offload rendering operation of the multi-media content (e.g., rendering (at 1016) of the viewport 1018). That is, rather than provide the user data 1014 of the UE 1003a and/or the UE 1003b to the UE 1002, the host server 1004 may provide the user data 1014 to the render server 1005 in accordance with the offload rendering.

The UE 1002 may be configured to receive, from the first network entity (e.g., the render server 1005), a viewport 1018 associated with a rendering (at 1016) that is based on the viewport information 1012. In aspects, the UE 1002 may be configured to display the viewport 1018 that was rendered (at 1016) by the render server 1005.

In aspects, the UE 1002 may be configured to transmit, to the first network entity (e.g., the render server 1005) via first out-of-band signaling (e.g., accompanying viewport information) and subsequent to reception of the viewport 1018, a first offload cancelation indication, and to receive, from the first network entity via second out-of-band signaling (e.g., accompanying a viewport) and based on the first offload cancelation indication, an offload cancelation acknowledgement. To transmit the first offload cancelation indication, the UE 1002 may be configured to obtain an offload cancelation request associated with a determination of a cancelation condition at the UE 1002, in aspects, while in some aspects, the UE 1002 may be configured to cease transmissions of further viewport information (e.g., subsequent to the viewport information 1012) based on at least one of the first offload cancelation indication or a second offload cancelation indication. In some aspects, the UE 1002 may be configured to receive, from the first network entity, the second offload cancelation indication (e.g., from the host server 1004 or from the render server 1005 via out-of-band signaling, such as with user data or with a common scene).

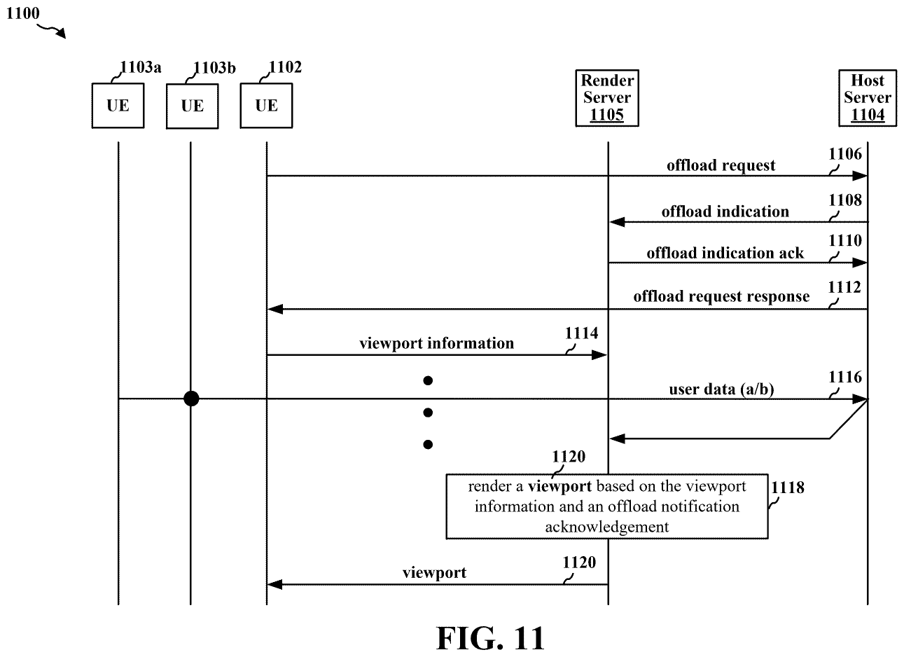

FIG. 11 is a diagram 1100 illustrating an example of rendering offload initiated by a UE, in various aspects. Diagram 1100 is shown in the context of dynamic rendering offload for multi-media communications between a UE 1102, a host server 1104, and a render server 1105. In aspects, the UE 1102, the host server 1104, and/or the render server 1105 may be network entities that communicate at least in part via a wireless communication network. As noted herein, a UE (e.g., the UE 1102) may initiate offload rendering to a render server (e.g., the render server 1105) via communications to a host server (e.g., the host server 1104).

The UE 1102 may be configured to obtain an offload determination or indication of a rendering offload request 1106 associated with an offload rendering operation of multi-media content for the UE 1102. In some aspects, the UE 1102 may be configured to transmit, to the second network entity (e.g., the host server 1104) via out-of-band signaling (e.g., with user data from the UE 1102) and based on the offload condition, the rendering offload request 1106 associated with the offload rendering operation of the multi-media content. In such aspects, the host server 1104 may transmit or provide, to the render server 1105, an offload indication 1108 based on the rendering offload request 1106, and may receive, from the render server 1105 and based on the offload indication 1108, an offload indication acknowledgement 1110 (ack). In aspects, the host server 1104 may receive the user data for forwarding to other UEs and/or for rendering common scenes of a multi-media communication session between the UEs.

The UE 1102 may be configured to then receive, from the second network entity (e.g., the host server 1104), a response indication (e.g., an offload request response 1112) associated with an offload indication acknowledgement. In cases where the offload request response 1112 is an offload acknowledgement indicative of an acceptance of the rendering offload request 1106, the UE 1102 may be configured to transmit, to the first network entity (e.g., the render server 1105), the viewport information 1114. The UE 1102 may be configured to transmit the viewport information 1114 based on the offload request response 1112 (e.g., the acknowledgement) being indicative of the acceptance of the rendering offload request 1106. In aspects, state information associated with a session of the multi-media communications may comprise the viewport information 1114.

The UE 1103a and/or the UE 1103b may be configured to transmit, to the second network entity (e.g., the host server 1104), respective instances of user data 1116, and the host server 1104 may be configured to transmit or provide the user data 1116 to the render server 1105 (e.g., the first network entity) for the offload rendering operation of the multi-media content (e.g., rendering (at 1118) of the viewport 1120).

That is, rather than provide the user data 1116 of the UE 1103a and/or the UE 1103b to the UE 1102, the host server 1104 may provide the user data 1116 to the render server 1105 in accordance with the offload rendering of the viewport 1120.

In aspects, the UE 1102 (e.g., a client (Cl)) may transmit or provide to the host server 1104 (e.g., a main server (Ms)) an offload request indication (e.g., which may be referred to as a “Cl_Ms_Offload_Request indication”) via its out-of-band signaling. In aspects, the host server 1104 may transmit or provide to the render server 1105 (e.g., an R-Server (Rs)) an offload request indication (e.g., which may be referred to as a “Ms_Rs_Offload_Request indication”). In aspects, the host server 1104 may transmit or provide to the UE 1102 an offload reject indication (e.g., which may be referred to as a “Ms_CL_Offload_Reject indication”) and/or an offload acknowledge indication (e.g., which may be referred to as a “Ms_CL_Offload_Acknowledge indication”) via out-of-band signaling. In aspects, the render server 1105 may transmit or provide to the host server 1104 an offload reject indication (e.g., which may be referred to as a “Rs_Ms_Offload_Reject indication”) and/or an offload reject indication (e.g., which may be referred to as a “Rs_Ms_Offload_Acknowledge indication”).

The UE 1102 may be configured to receive, from the first network entity (e.g., the render server 1105), the viewport 1120 associated with the rendering (at 1118) that is based on the viewport information 1114. In aspects, the UE 1102 may be configured to display the viewport 1120 that was rendered (at 1118) by the render server 1105.

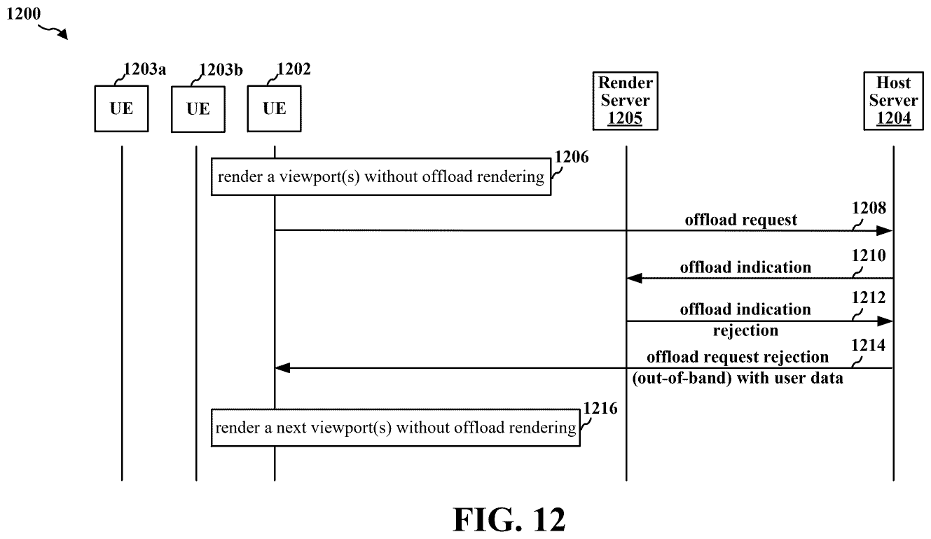

FIG. 12 is a diagram 1200 illustrating an example of rendering offload initiated by a UE, in various aspects. Diagram 1200 is shown in the context of dynamic rendering offload for multi-media communications between a UE 1202, a host server 1204, and a render server 1205. In aspects, the UE 1202, the host server 1204, and/or the render server 1205 may be network entities that communicate at least in part via a wireless communication network. As noted herein, a UE (e.g., the UE 1202) may initiate offload rendering that targets a render server (e.g., the render server 1205) via communications to a host server (e.g., the host server 1204), where the render server rejects the offload rendering request.

The UE 1202 may be configured to render (at 1206) a viewport(s) without offload rendering. The UE 1202 may be configured to determine an offload condition associated with an offload rendering operation of multi-media content for the UE 1202. The determination of the offload condition may be based on one or more of changes to radio links in communication sessions, numbers of users in communication sessions, device processing power utilization, server (e.g., including edge servers) processing power utilization, user preferences, and/or the like. Based on the offload condition, the UE 1202 may be configured to transmit or provide a rendering offload request 1208 to the host server 1204, e.g., to initiate the offload rendering that targets the render server 1205. In aspects, the rendering offload request 1208 may be provided via out-of-band signaling (e.g., with user data from the UE 1202). In aspects, the host server 1204 may receive the user data for forwarding to other UEs and/or for rendering common scenes of a multi-media communication session between the UEs.

In such aspects, the host server 1204 may be configured to transmit or provide, to the render server 1205, an offload indication 1210 based on the rendering offload request 1208. The render server 1205 may be unavailable for offloading rendering, e.g., based on an overload at the render server 1205, and may transmit or provide, to the host server 1204 and based on the offload indication 1210 and/or the overload, an offload indication rejection 1212. The host server 1204, based on the offload indication rejection 1212, may be configured to transmit or provide, and the UE 1202 may be configured to receive, an offload request rejection 1214 in out-of-band signaling. In aspects, the offload request rejection 1214 may be included with user data associated with a UE 1203a and/or a UE 1203b.

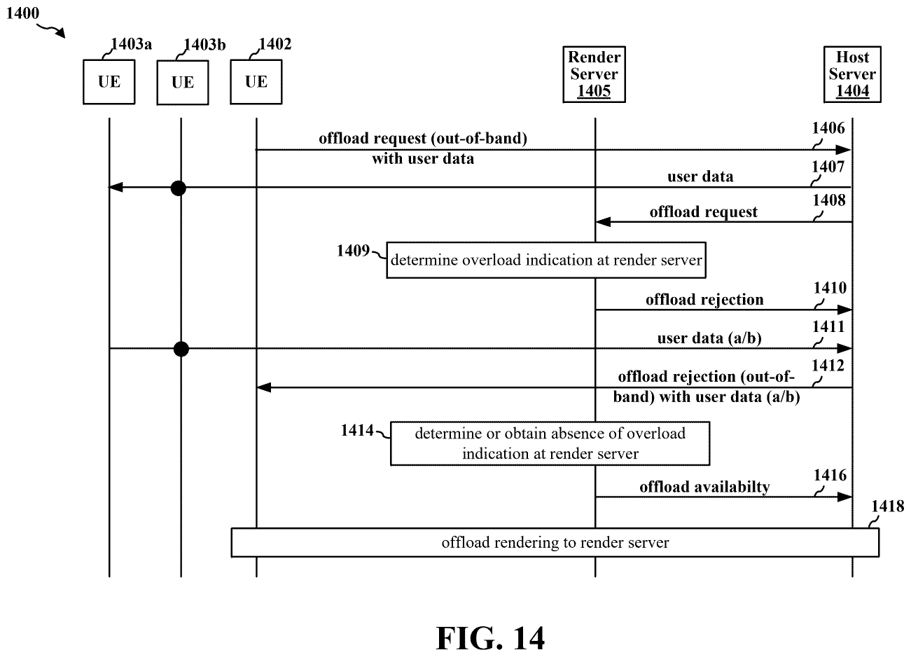

Based on the offload request rejection 1214 received, the UE 1202 may be configured to render (at 1216) a next viewport(s) without offload rendering. In such aspects, the UE 1202 may refrain from providing viewport information to the render server 1205 based on the offload request rejection 1214. Additional aspects in the context of the offload request rejection 1214 and overloads at the render server 1205 are provided below herein, e.g., for FIG. 14.

In aspects, the UE 1202 (e.g., a client (Cl)) may transmit or provide to the host server 1204 (e.g., a main server (Ms)) an offload request indication (e.g., which may be referred to as a “Cl_Ms_Offload_Request indication”) via its out-of-band signaling. In aspects, the host server 1204 may transmit or provide to the render server 1205 (e.g., an R-Server (Rs)) an offload request indication (e.g., which may be referred to as a “Ms_Rs_Offload_Request indication”). In aspects, the host server 1204 may transmit or provide to the UE 1202 an offload reject indication (e.g., which may be referred to as a “Ms_CL_Offload_Reject indication”) and/or an offload acknowledge indication (e.g., which may be referred to as a “Ms_CL_Offload_Acknowledge indication”) via out-of-band signaling. In aspects, the render server 1205 may transmit or provide to the host server 1204 an offload reject indication (e.g., which may be referred to as a “Rs_Ms_Offload_Reject indication”) and/or an offload reject indication (e.g., which may be referred to as a “Rs_Ms_Offload_Acknowledge indication”).

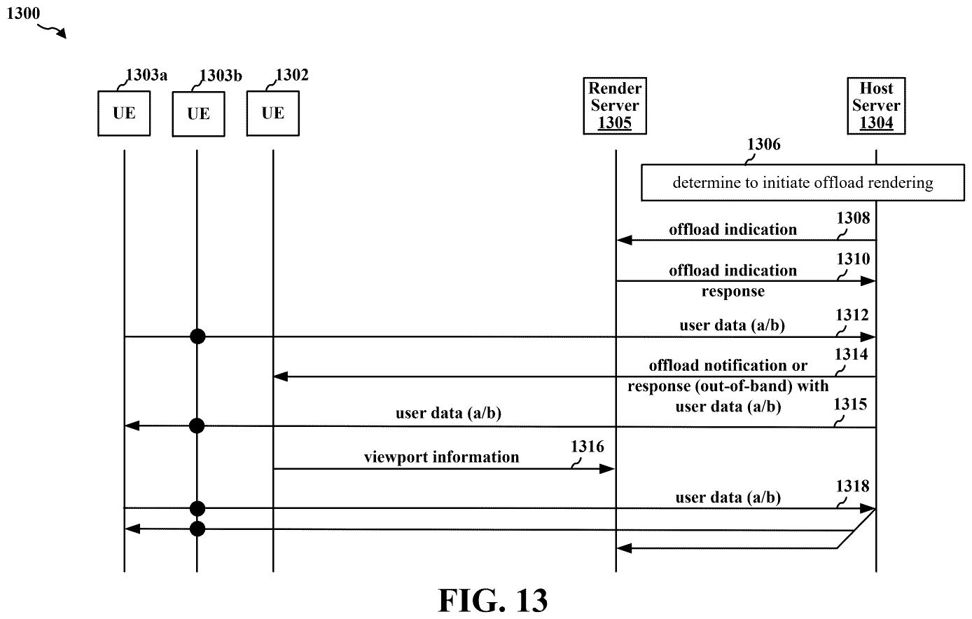

FIG. 13 is a diagram 1300 illustrating an example of rendering offload initiated by a host server, in various aspects. Diagram 1300 may be an example of rendering offload at a host server and is shown in the context of dynamic rendering offload for multi-media communications between a UE 1302, a host server 1304, and a render server 1305. In aspects, the UE 1302, the host server 1304, and/or the render server 1305 may be network entities that communicate at least in part via a wireless communication network. As noted herein, a host server (e.g., the host server 1304) may initiate offload rendering to a render server (e.g., the render server 1305) for a UE (e.g., the UE 1302).

The host server 1304 may be configured to determine (at 1306) to initiate offload rendering for the UE 1302 that targets the render server 1305. The determination (at 1306) may be based on an offload condition associated with one or more of changes to radio links in communication sessions, numbers of users in communication sessions, device processing power utilization, server (e.g., including edge servers) processing power utilization, user preferences, and/or the like.

Based on the determination (at 1306) to initiate offload rendering for the UE 1302, the host server 1304 may be configured to transmit or provide, to the render server 1305, an offload indication 1308. The render server 1305 may be available for offloading rendering, e.g., based on an absence of an overload at the render server 1305, and may transmit or provide, to the host server 1304 and based on the offload indication 1308, an offload indication response 1310.

The host server 1304 may be configured to receive user data 1312 associated with a UE 1303a and/or a UE 1303b. In aspects, the host server 1304 may receive the user data 1312 for forwarding to other UEs and/or for rendering common scenes of a multi-media communication session between the UEs. The host server 1304, based on the offload indication response 1310, may be configured to transmit or provide, and the UE 1302 may be configured to receive, an offload notification 1314. In aspects, the offload notification 1314 may be included in out-of-band signaling associated with the user data 1312 that is in turn associated with the UE 1303a and/or the UE 1303b, as forwarded to the UE 1302. As shown, the user data 1312 associated with the UE 1303a and/or the UE 1303b may also be forwarded as user data 1315, by the host server 1304, to the other of the UE 1303a and/or the UE 1303b.

The UE 1302, based on the offload notification 1314 (e.g., via out-of-band signaling), may be configured to transmit or provide, to the render server 1305, viewport information 1316. Accordingly, the host server 1304 may be configured to receive next user data (e.g., user data 1318) associated with the UE 1303a and/or the UE 1303b, and may be configured to provide the user data 1318 to the render server 1305 for the offload rendering operation instead of providing the user data 1318 to the to the UE 1302, while still forwarding the user data 1318 to the other of the UE 1303a and/or the UE 1303b, as similarly performed for the user data 1315. The render server 1305 may then render a viewport, via offload rendering, and transmit or provide the viewport to the UE 1302.

In aspects, the host server 1304 (e.g., a main server (Ms)) may transmit or provide to the UE 1302 (e.g., a client (Cl)) an offload notify indication (e.g., which may be referred to as a “Ms_Cl_Offload_Notify indication”) via out-of-band signaling.

FIG. 14 is a diagram 1400 illustrating an example of rendering offload initiated by a UE or a host server, and facilitated by a render server, in various aspects. Diagram 1400 is shown in the context of dynamic rendering offload for multi-media communications between a UE 1402, a host server 1404, and a render server 1405. In aspects, the UE 1402, the host server 1404, and/or the render server 1405 may be network entities that communicate at least in part via a wireless communication network. As noted herein, a UE (e.g., the UE 1402) or a host server (e.g., the host server 1404) may initiate offload rendering that targets a render server (e.g., the render server 1405) via communications to a host server (e.g., the host server 1404), where the render server rejects the offload rendering request. FIG. 14 may be an aspect of FIG. 12, and in such an aspect, the render server 1405 may subsequently become available for offload rendering.

In aspects where the UE 1402 initiates offload rendering that targets the render server 1405, the host server 1404 may receive, and the UE 1402 may be configured to transmit or provide, an offload request 1406, which may be included in out-of-band signaling with user data, as described herein. The host server 1404 may transmit or provide (e.g., forward) commensurate user data of the UE 1402 (e.g., user data 1407) to a UE 1403a and/or a UE 1403b. Additionally, the host server 1404 may transmit or provide, and the render server 1405 may receive, an offload request 1408 based on reception of the offload request 1406. In aspects where the host server 1404 initiates offload rendering that targets the render server 1405, the host server 1404 may transmit or provide, and the render server 1405 may receive, the offload request 1408 (e.g., based on a determined offload condition).

In some aspects, as noted herein, the render server 1405 may be unavailable for offload rendering (e.g., based on a rendering overload). The render server 1405 may be configured to determine (at 1409) an overload indication at the render server 1405 that is indicative of the rendering overload (e.g., based on unavailability of processing resources, power utilization, a communication or throughput threshold, etc.). Based on the determination (at 1409) of the overload indication, the render server 1405 may be configured to transmit or provide, and the host server 1404 may be configured to receive, an offload rejection 1410, and to transmit or provide an offload rejection 1412 to the UE 1402. Thus, offload rendering is rejected, as described herein, and the UE 1402 may continue to perform rendering of viewports. Additionally, the host server 1404 may continue to receive user data of the UEs (e.g., user data 1411) from the UE 1403a and/or the UE 1403b, by way of example, and to provide the user data to others of the UEs (e.g., the offload rejection 1412 may be provided or forwarded via out-of-band signaling to the UE 1402 with the user data 1411).

Subsequent to the offload rejection 1410 and/or the offload rejection 1412, the render server 1405 may determine (at 1414) an absence of the overload indication at the render server 1405 that was previously determined (at 1409) (e.g., a UE of a user has left the multi-media session). Based on the absence of the overload indication determined (at 1414), the render server 1405 may be configured to transmit or provide, and the host server 1404 may be configured to receive, a rendering availability indication 1416 indicative of an absence of the rendering overload and of an availability at the render server 1405 for offload rendering. In aspects, the offload availability indication may be further indicative of a number of rendering processes associated with the availability at the render server 1405 for the offload rendering.

The UE 1402, the host server 1404, and the render server 1405 may thus be configured to perform offload rendering (at 1418), e.g., by UE or server initiation, as described above. For example, the UE 1402 may be notified of the offload availability and may provide viewport information to the render server 1405, and the render server 1405 may render and provide viewports to the UE 1402 based on the provided viewport information. In some aspects, providing to, or rendering at, the render server 1405 of the viewports may be based on the number of rendering processes associated with the availability at the render server 1405.

In aspects, the host server 1404 (e.g., a main server (Ms)) may transmit or provide to the UE 1402 (e.g., a client (Cl)) an offload available indication (e.g., which may be referred to as a “Ms_Cl_Offload_Available indication”) via out-of-band signaling. In aspects, the render server 1405 (e.g., an R-Server (Rs)) may transmit or provide to the host server 1404 an offload available indication (e.g., which may be referred to as a “Rs_Ms_Offload_Available indication”).

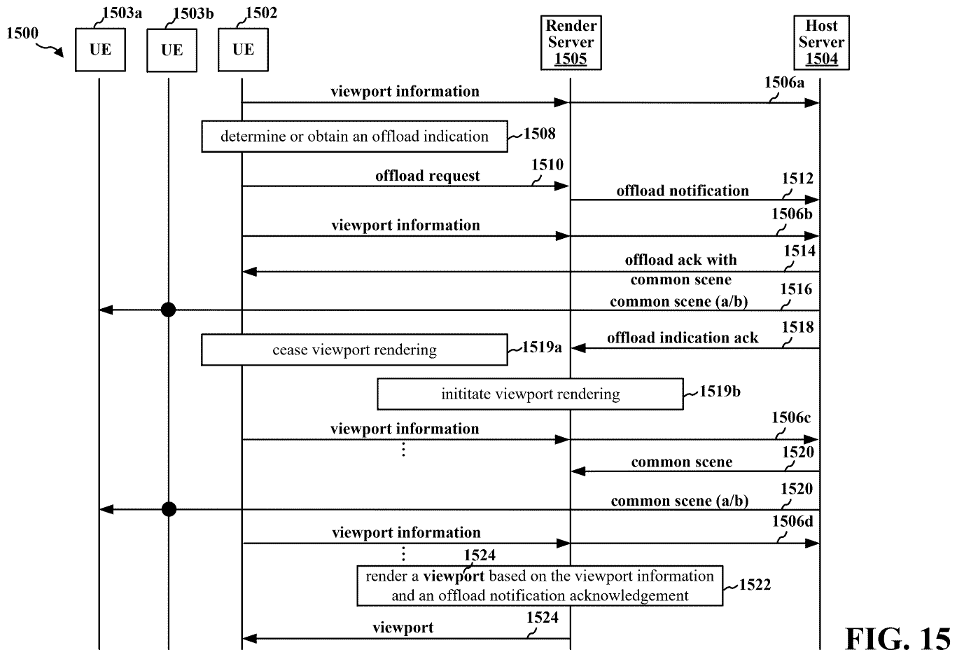

FIG. 15 is a diagram 1500 illustrating an example of rendering offload initiated by a UE, in various aspects. Diagram 1500 is shown in the context of dynamic rendering offload for multi-media communications between a UE 1502, a host server 1504, and a render server 1505. In aspects, the UE 1502, the host server 1504, and/or the render server 1505 may be network entities that communicate at least in part via a wireless communication network. As noted herein, a UE (e.g., the UE 1502) may initiate offload rendering to a render server (e.g., the render server 1505) via communications to the render server. In aspects, diagram 1500 may represent dynamic rendering offload for multi-media communications in an MCU architecture.

The UE 1502 may be configured to transmit or provide viewport information 1506a to the render server 1505 and/or to the host server 1504. In aspects for MCU architectures, the UE 1502 may be configured to transmit or provide the viewport information 1506a irrespective of where viewport rendering takes place, and may provide subsequent instances of viewport information periodically or intermittently for processing of common scenes (not shown for clarity of illustration) by the host server 1504.

The UE 1502 may be configured to obtain (at 1508) an offload indication. In aspects, the UE 1502 may be configured to obtain an offload determination or indication of a rendering offload request 1510 associated with an offload rendering operation of multi-media content for the UE 1502. In aspects, the rendering offload request 1510 may be provided as out-of-band signaling in association with viewport information. In some aspects, the UE 1502 may be configured to determine an offload condition (e.g., of which the offload indication may be indicative) that associated with an offload rendering operation of multi-media content for the UE 1502. The determination of the offload condition may be based on one or more of changes to radio links in communication sessions, numbers of users in communication sessions, device processing power utilization, server (e.g., including edge servers) processing power utilization, user preferences, and/or the like. Based on the offload condition, the UE 1502 may be configured to transmit or provide a rendering offload request 1508 to the render server 1505, e.g., to initiate the offload rendering that targets the render server 1505. In some aspects, the rendering offload request 1508 may be transmitted or provided with, or as, state information.

The render server 1505 may be configured to transmit or provide, and the host server 1504 may be configured to receive, a; 1512 that may notify the host server 1504 that the UE 1502 has requested offload rendering and that the render server 1505 has accepted the rendering offload request 1510. During the request and notification time period of offload rendering, the UE 1502 may continue to transmit or provide viewport information (e.g., viewport information 1506b) to the render server 1505 and/or to the host server 1504.

The host server 1504 may be configured to transmit or provide, and the UE 1502 may be configured to receive, an offload acknowledgement 1514 (ack) associated with a common scene (e.g., a common scene 1516, which may be a final common scene provided to the UE 1502 from the host server 1504; the offload acknowledgement 1514 as out-of-band signaling), while a UE 1503a and/or a UE 1503b may receive the common scene (e.g., the common scene 1516) without the offload acknowledgement 1514. Additionally, the host server 1504 may be configured to transmit or provide, and the render server 1505 may be configured to receive, an offload indication acknowledgement 1518 in response to the rendering offload notification 1512.

The UE 1502, based on the offload acknowledgement 1514, may be configured to cease (at 1519a) viewport rendering, and the render server, subsequent to the offload acknowledgement 1514, may be configured to initiate (at 1519b) viewport rendering. During the initiation time period of offload rendering, the UE 1502 may continue to transmit or provide viewport information (e.g., viewport information 1506c) to the render server 1505 and/or to the host server 1504.

The render server 1505 may be configured to receive, and the host server may be configured to transmit or provide, a common scene 1520 for viewport rendering (e.g., for offload rendering rather than rendering at the UE 1502), while the UE 1503a and/or the UE 1503b may continue to receive the common scene 1520 that is processed by the host server 1504, and as noted above, the UE 1502 may continue to transmit or provide viewport information (e.g., viewport information 1506d) to the render server 1505 and/or to the host server 1504.

The render server 1505 may be configured to render (at 1522) a viewport 1524. The viewport 1524 may be rendered (at 1522) based on the viewport information 1506d, the offload acknowledgement 1514, the common scene 1520, and/or the like, in aspects. The render server 1505 may be configured to transmit or provide the viewport 1524, rendered by the render server 1505 (at 1522) to the UE 1502, and the UE 1502 may be configured to display the viewport 1524.

In aspects, the UE 1502 (e.g., a client (Cl)) may transmit or provide to the render server 1505 (e.g., an R-Server (Rs)) an offload request indication (e.g., which may be referred to as a “Cl_Ms_Offload_Request indication”) via its out-of-band signaling. In aspects, the host server 1504 (e.g., a main server (Ms)) may transmit or provide to the render server 1505 an offload notify acknowledge indication (e.g., which may be referred to as a “Ms_Rs_Offload_Notify_Acknowledge indication”). In aspects, the render server 1505 may transmit or provide to the host server 1504 an offload notify indication (e.g., which may be referred to as a “Rs_Ms_Offload_Notify indication”).

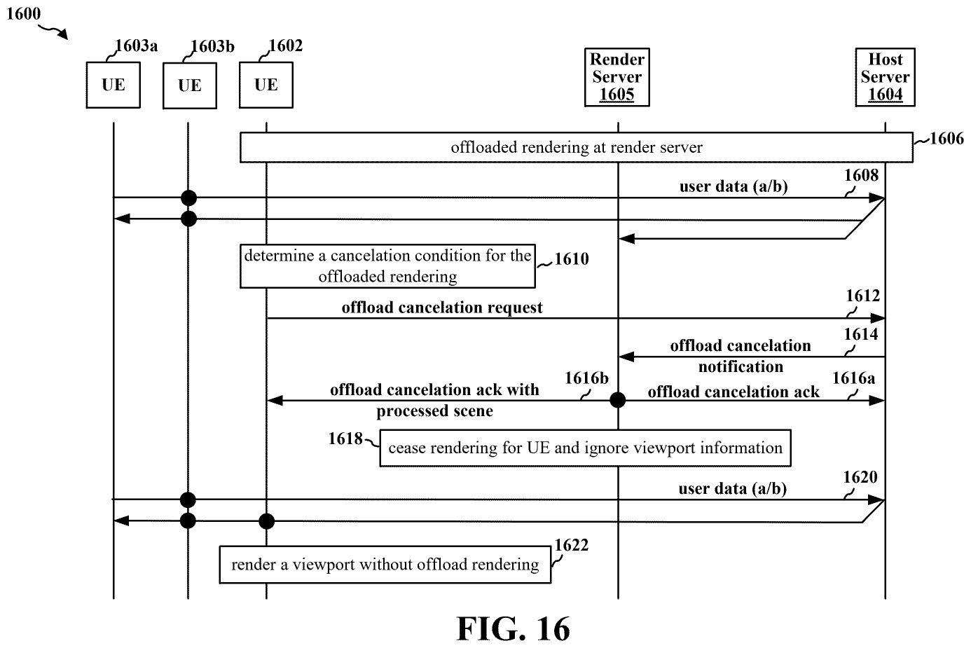

FIG. 16 is a diagram 1600 illustrating an example of rendering offload canceled by a UE via a host server, in various aspects. Diagram 1600 is shown in the context of dynamic rendering offload for multi-media communications between a UE 1602, a host server 1604, and a render server 1605. In aspects, the UE 1602, the host server 1604, and/or the render server 1605 may be network entities that communicate at least in part via a wireless communication network. As noted herein, a UE (e.g., the UE 1602) may initiate a cancelation of offload rendering that targets a render server (e.g., the render server 1605) via communications to a host server (e.g., the host server 1604).

As shown, the UE 1602, the host server 1604, and the render server 1605 may perform (at 1606) offloaded rendering that targets the render server 1605. For instance, a UE 1603a and/or a UE 1603b may be configured to transmit, to a second network entity (e.g., the host server 1604), respective instances of user data 1608, and the host server 1604 may be configured to transmit or provide the user data 1608 to the render server 1605 (e.g., a first network entity) for the offload rendering operation of multi-media content (e.g., rendering of viewports to be provided to the UE 1602). That is, rather than provide the user data 1608 of the UE 1603a and/or the UE 1603b to the UE 1602, the host server 1604 may provide the user data 1608 to the render server 1605 in accordance with the offload rendering (at 1606).

The UE 1602 may be configured to determine (at 1610) a cancelation condition for the offloaded rendering (at 1606). The determination (at 1610) of the cancelation condition may be based on one or more of changes to radio links in communication sessions, numbers of users in communication sessions, device processing power utilization, server (e.g., including edge servers) processing power utilization, user preferences, and/or the like. Based on the cancelation condition, the UE 1602 may be configured to transmit or provide a rendering offload cancelation request 1612 to the host server 1604, e.g., to initiate a cancelation of the offload rendering that targets the render server 1605.

In aspects, the host server 1604 may be configured to transmit or provide, based on the determination (at 1610) of the cancelation condition, and the render server 1605 may be configured to receive, an offload cancelation notification 1614. Based on the offload cancelation notification 1614, the render server 1605 may configured to transmit or provide, and the host server 1604 may be configured to receive, an offload cancelation acknowledgement 1616a (ack). Additionally, based on the offload cancelation notification 1614, the render server 1605 may configured to transmit or provide, and the UE 1602 may be configured to receive, an offload cancelation acknowledgement 1616b (ack). In aspects, the offload cancelation acknowledgement 1616b may be included with or may be in association with a processed common scene or viewport, as described herein. Subsequently, the render server 1605 may be configured to cease (at 1618) offload rendering for the UE 1602 and to ignore viewport information transmitted or provided thereto from the UE 1602.

Based on the offload cancelation acknowledgement 1616a, the UE 1603a and/or the UE 1603b may be configured to transmit, to the host server 1604, respective instances of user data 1620, and the host server 1604 may be configured to transmit or provide the user data 1620 to the UE 1602 and to the other of the UE 1603a and/or the UE 1603b for rendering of viewports, rather than providing the user data 1620 to the render server 1605 as the offload rendering operation of multi-media content have ceased (at 1618). Accordingly, the UE 1602 may be configured to render (at 1622) a viewport, e.g., without offload rendering, based on the user data 1620, user data of the UE 1602, a common scene, and/or the like, as described herein.

In aspects, the UE 1602 (e.g., a client (Cl)) may transmit or provide to the host server 1604 (e.g., a main server (Ms)) a Cl_Ms_Cancel_Offload_Request indication via its out-of-band signaling. In aspects, the host server 1604 may transmit or provide to the render server 1605 (e.g., an R-Server (Rs)) a cancel offload notify indication (e.g., which may be referred to as a “Ms_Rs_Cancel_Offload_Notify indication”). In aspects, the render server 1605 may transmit or provide to the UE 1602 a cancel offload notify indication (e.g., which may be referred to as a “Ms_CL_Cancel_Offload_Notify indication” and/or a cancel offload acknowledge indication (e.g., which may be referred to as a “Ms_CL_Cancel_Offload_Acknowledge indication”) via out-of-band signaling. In aspects, the render server 1605 may transmit or provide to the host server 1604 a cancel offload notify acknowledge indication (e.g., which may be referred to as a “Rs_Ms_Cancel_Offload_Notify_Acknowledge indication”).

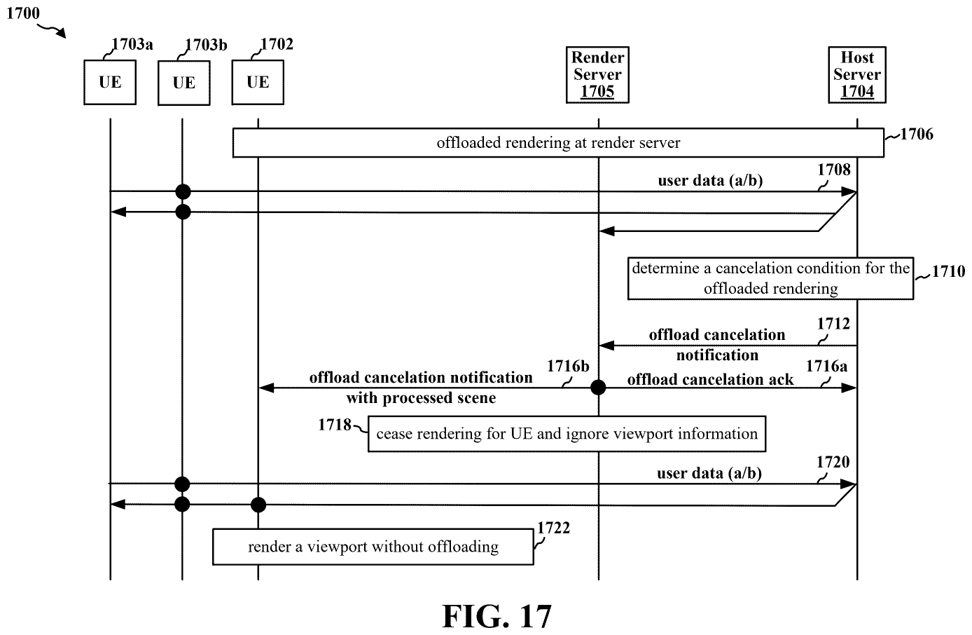

FIG. 17 is a diagram 1700 illustrating an example of rendering offload canceled by a host server, in various aspects. Diagram 1700 is shown in the context of dynamic rendering offload for multi-media communications between a UE 1702, a host server 1704, and a render server 1705. In aspects, the UE 1702, the host server 1704, and/or the render server 1705 may be network entities that communicate at least in part via a wireless communication network. As noted herein, a host server (e.g., the host server 1704) may initiate a cancelation of offload rendering that targets a render server (e.g., the render server 1705).

As shown, the UE 1702, the host server 1704, and the render server 1705 may perform (at 1706) offloaded rendering that targets the render server 1705. For instance, a UE 1703a and/or a UE 1703b may be configured to transmit, to a second network entity (e.g., the host server 1704), respective instances of user data 1708, and the host server 1704 may be configured to transmit or provide the user data 1708 to the render server 1705 (e.g., a first network entity) for the offload rendering operation of multi-media content (e.g., rendering of viewports to be provided to the UE 1702). That is, rather than provide the user data 1708 of the UE 1703a and/or the UE 1703b to the UE 1702, the host server 1704 may provide the user data 1708 to the render server 1705 in accordance with the offload rendering (at 1706).

The host server 1704 may be configured to determine (at 1710) a cancelation condition for the offloaded rendering (at 1706). The determination (at 1710) of the cancelation condition may be based on one or more of changes to radio links in communication sessions, numbers of users in communication sessions, device processing power utilization, server (e.g., including edge servers) processing power utilization, user preferences, and/or the like. Based on the cancelation condition, the host server 1704 may be configured to transmit or provide a rendering offload cancelation notification 1712 to the render server 1705, e.g., to initiate a cancelation of the offload rendering that targets the render server 1705.

In aspects, the render server 1705 may be configured to transmit or provide, based on the rendering offload cancelation notification 1712, and the host server 1704 may be configured to receive, an offload cancelation acknowledgement 1716a (ack). Additionally, based on the rendering offload cancelation notification 1712, the render server 1705 may configured to transmit or provide, and the UE 1702 may be configured to receive, an offload cancelation notification 1716b. In aspects, the offload cancelation notification 1716b may be included with or may be in association with a processed common scene or viewport, as described herein. Subsequently, the render server 1705 may be configured to cease (at 1718) offload rendering for the UE 1702 and to ignore viewport information transmitted or provided thereto from the UE 1702.

Based on the offload cancelation acknowledgement 1716a, the UE 1703a and/or the UE 1703b may be configured to transmit, to the host server 1704, respective instances of user data 1720, and the host server 1704 may be configured to transmit or provide the user data 1720 to the UE 1702 and to the other of the UE 1703a and/or the UE 1703b for rendering of viewports, rather than providing the user data 1720 to the render server 1705 as the offload rendering operation of multi-media content have ceased (at 1718). Accordingly, the UE 1702 may be configured to render (at 1722) a viewport, e.g., without offload rendering, based on the user data 1720, user data of the UE 1702, a common scene, and/or the like, as described herein.

In aspects, the UE 1702 (e.g., a client (Cl)) may transmit or provide to the host server 1704 (e.g., a main server (Ms)) a cancel offload request indication (e.g., which may be referred to as a “Cl_Ms_Cancel_Offload_Request indication”) via its out-of-band signaling. In aspects, the host server 1704 may transmit or provide to the render server 1705 (e.g., an R-Server (Rs)) a cancel offload notify indication (e.g., which may be referred to as a “Ms_Rs_Cancel_Offload_Notify indication”). In aspects, the render server 1705 may transmit or provide to the UE 1702 a cancel offload notify indication (e.g., which may be referred to as a “Ms_CL_Cancel_Offload_Notify indication”) and/or a cancel offload acknowledge (e.g., which may be referred to as a “Ms_CL_Cancel_Offload_Acknowledge indication”) via out-of-band signaling. In aspects, the render server 1705 may transmit or provide to the host server 1704 a cancel offload notify acknowledge indication (e.g., which may be referred to as a “Rs_Ms_Cancel_Offload_Notify_Acknowledge indication”).

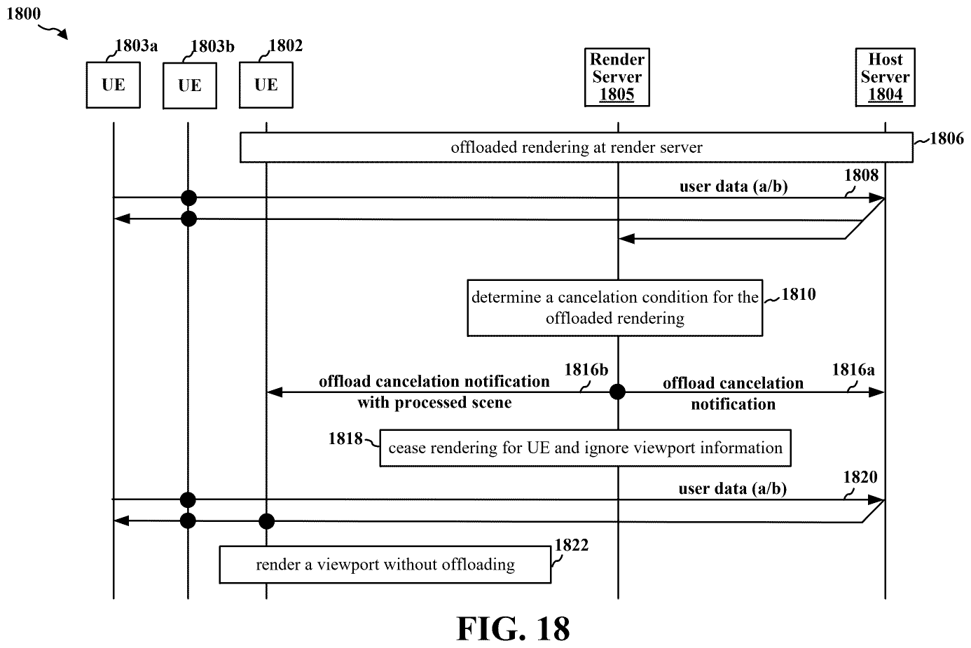

FIG. 18 is a diagram 1800 illustrating an example of rendering offload canceled by a render server, in various aspects. Diagram 1800 is shown in the context of dynamic rendering offload for multi-media communications between a UE 1802, a host server 1804, and a render server 1805. In aspects, the UE 1802, the host server 1804, and/or the render server 1805 may be network entities that communicate at least in part via a wireless communication network. As noted herein, a UE (e.g., the UE 1802) may initiate a cancelation of offload rendering that targets a render server (e.g., the render server 1805) via communications to a host server (e.g., the host server 1804).

As shown, the UE 1802, the host server 1804, and the render server 1805 may perform (at 1806) offloaded rendering that targets the render server 1805. For instance, a UE 1803a and/or a UE 1803b may be configured to transmit, to a second network entity (e.g., the host server 1804), respective instances of user data 1808, and the host server 1804 may be configured to transmit or provide the user data 1808 to the render server 1805 (e.g., a first network entity) for the offload rendering operation of multi-media content (e.g., rendering of viewports to be provided to the UE 1802). That is, rather than provide the user data 1808 of the UE 1803a and/or the UE 1803b to the UE 1802, the host server 1804 may provide the user data 1808 to the render server 1805 in accordance with the offload rendering (at 1806).

The render server 1805 may be configured to determine (at 1810) a cancelation condition for the offloaded rendering (at 1806). The determination (at 1810) of the cancelation condition may be based on one or more of changes to radio links in communication sessions, numbers of users in communication sessions, device processing power utilization, server (e.g., including edge servers) processing power utilization, user preferences, and/or the like.

In aspects, the render server 1805 may be configured to transmit or provide, based on the determination (at 1810) of the cancelation condition, and the host server 1804 may be configured to receive, an offload cancelation notification 1816a. Additionally, based on the offload cancelation notification 1816a and/or the determination (at 1810), the render server 1805 may configured to transmit or provide, and the UE 1802 may be configured to receive, an offload cancelation notification 1816b. In aspects, the offload cancelation notification 1816b may be included with or may be in association with a processed common scene or viewport, as described herein. Subsequently, the render server 1805 may be configured to cease (at 1818) offload rendering for the UE 1802 and to ignore viewport information transmitted or provided thereto from the UE 1802.

Based on the offload cancelation notification 1816a, the UE 1803a and/or the UE 1803b may be configured to transmit, to the host server 1804, respective instances of user data 1820, and the host server 1804 may be configured to transmit or provide the user data 1820 to the UE 1802 and to the other of the UE 1803a and/or the UE 1803b for rendering of viewports, rather than providing the user data 1820 to the render server 1805 as the offload rendering operation of multi-media content have ceased (at 1818). Accordingly, the UE 1802 may be configured to render (at 1822) a viewport, e.g., without offload rendering, based on the user data 1820, user data of the UE 1802, a common scene, and/or the like, as described herein.

In aspects, the render server 1805 (e.g., an R-Server (Rs)) may transmit or provide to the host server 1804 (e.g., a main server (Ms)) a cancel offload notify indication (e.g., which may be referred to as a “Rx_Ms_Cancel_Offload_Notify indication”).

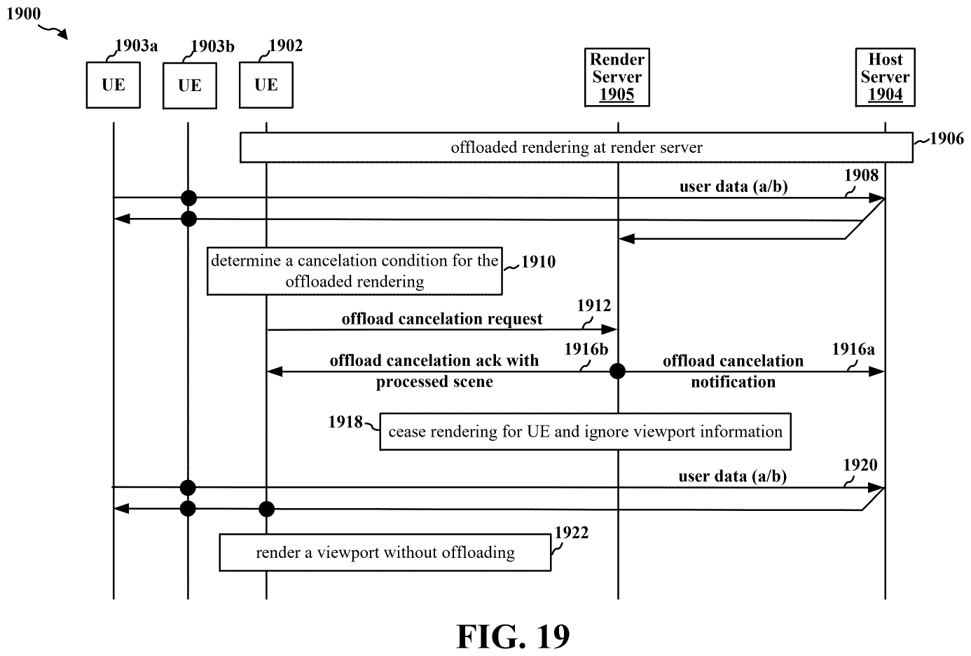

FIG. 19 is a diagram 1900 illustrating an example of rendering offload canceled by a UE via a render server, in various aspects. Diagram 1900 is shown in the context of dynamic rendering offload for multi-media communications between a UE 1902, a host server 1904, and a render server 1905. In aspects, the UE 1902, the host server 1904, and/or the render server 1905 may be network entities that communicate at least in part via a wireless communication network. As noted herein, a UE (e.g., the UE 1902) may initiate a cancelation of offload rendering that targets a render server (e.g., the render server 1905) via communications to a host server (e.g., the host server 1904).

As shown, the UE 1902, the host server 1904, and the render server 1905 may perform (at 1906) offloaded rendering that targets the render server 1905. For instance, a UE 1903a and/or a UE 1903b may be configured to transmit, to a second network entity (e.g., the host server 1904), respective instances of user data 1908, and the host server 1904 may be configured to transmit or provide the user data 1908 to the render server 1905 (e.g., a first network entity) for the offload rendering operation of multi-media content (e.g., rendering of viewports to be provided to the UE 1902). That is, rather than provide the user data 1908 of the UE 1903a and/or the UE 1903b to the UE 1902, the host server 1904 may provide the user data 1908 to the render server 1905 in accordance with the offload rendering (at 1906).

The UE 1902 may be configured to determine (at 1910) a cancelation condition for the offloaded rendering (at 1906). The determination (at 1910) of the cancelation condition may be based on one or more of changes to radio links in communication sessions, numbers of users in communication sessions, device processing power utilization, server (e.g., including edge servers) processing power utilization, user preferences, and/or the like. Based on the cancelation condition, the UE 1902 may be configured to transmit or provide a rendering offload cancelation request 1912 to the render server 1905, e.g., to initiate a cancelation of the offload rendering that targets the render server 1905.

In aspects, the render server 1905 may be configured to transmit or provide, based on the determination (at 1910) of the cancelation condition and/or the rendering offload cancelation request 1912, and the host server 1904 may be configured to receive, an offload cancelation notification 1916a. Additionally, based on the rendering offload cancelation request 1912, the render server 1905 may configured to transmit or provide, and the UE 1902 may be configured to receive, an offload cancelation acknowledgement 1916b (ack). In aspects, the offload cancelation acknowledgement 1916b may be included with or may be in association with a processed common scene or viewport, as described herein. Subsequently, the render server 1905 may be configured to cease (at 1918) offload rendering for the UE 1902 and to ignore viewport information transmitted or provided thereto from the UE 1902.

Based on the offload cancelation notification 1916a, the UE 1903a and/or the UE 1903b may be configured to transmit, to the host server 1904, respective instances of user data 1920, and the host server 1904 may be configured to transmit or provide the user data 1920 to the UE 1902 and to the other of the UE 1903a and/or the UE 1903b for rendering of viewports, rather than providing the user data 1920 to the render server 1905 as the offload rendering operations of multi-media content have ceased (at 1918). Accordingly, the UE 1902 may be configured to render (at 1922) a viewport, e.g., without offload rendering, based on the user data 1920, user data of the UE 1902, a common scene, and/or the like, as described herein.

In aspects, the UE 1902 (e.g., a client (Cl)) may transmit or provide to the render server 1905 (e.g., an R-Server (Rs)) a cancel offload request indication (e.g., which may be referred to as a “Cl_Rs_Cancel_Offload_Request indication”) via out-of-band signaling.

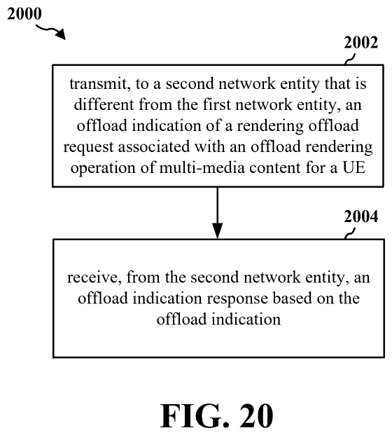

FIG. 20 is a flowchart 2000 of a method of wireless communication. The method may be performed by a base station or a first network entity (such as a server) (e.g., the base station 102; the host server 704, 804, 904, 1004, 1104, 1204, 1304, 1404, 1504, 1604, 1704, 1804, 1904; the network entity 2602, 2702, 2860). The method may be for dynamic rendering offload for multi-media communications. The method may enable a device in a communications session, via a host server, to offload the rendering of viewports to a render server, may enable signaling for dynamic rendering offloads in both SFU and MCU architectures and provide for dynamic rendering offloads to be initiated and/or canceled by a device, by a render server, or by a host server, and may further enable handling of conditions for changes to radio links in communication sessions, numbers of users in communication sessions, device processing power utilization, user preferences, and/or the like.

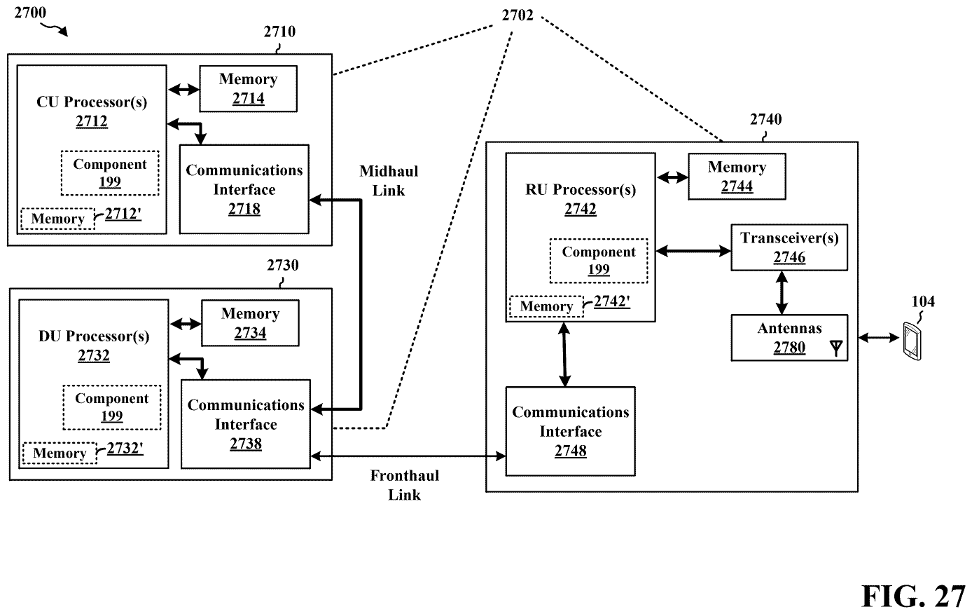

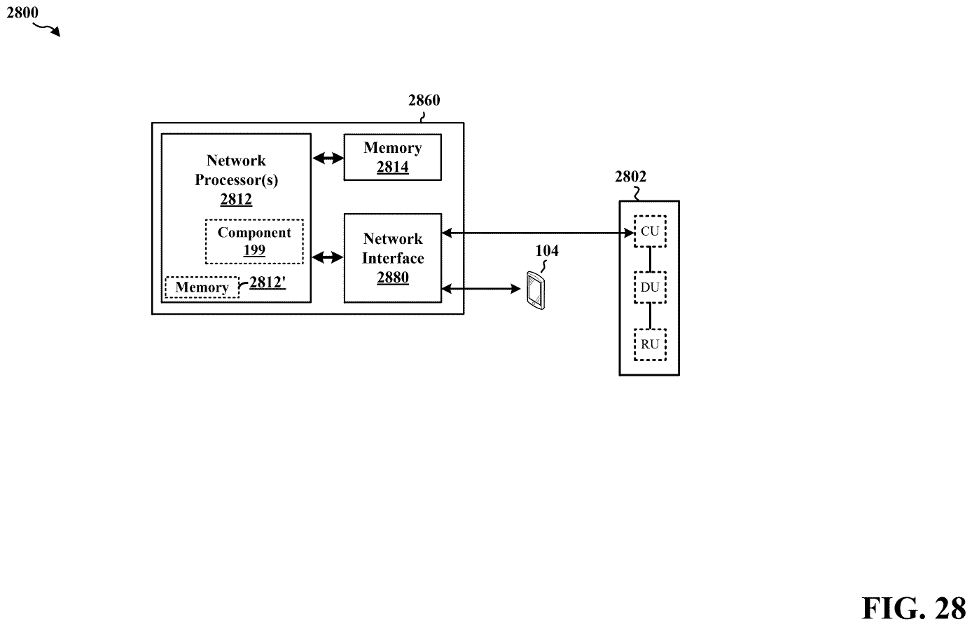

At 2002, the first network entity transmits, to a second network entity that is different from the first network entity, an offload indication of a rendering offload request associated with an offload rendering operation of multi-media content for a UE. As an example, the transmission may be performed by one or more of the component 199, the transceiver(s) 2746 and/or the antenna 2780 in FIG. 27, the network interface 2880 in FIG. 28. FIG. 8 illustrates, in the context of FIGS. 11-19, an example of the host server 804 transmitting such an offload indication.

The host server 804 (e.g., a first network entity) may be configured to transmit, to a second network entity (e.g., the render server 805) that is different from the first network entity, an offload indication 808 (e.g., 1108 in FIG. 11; 1210 in FIG. 12; 1308 in FIG. 13; 1408 in FIG. 14; 1518 in FIG. 15) of a rendering offload request 806 (e.g., 1106 in FIG. 11; 1208 in FIG. 12; at 1306 in FIG. 13; 1406 in FIG. 14; 1510 in FIG. 15) (via first out-of-band signaling (e.g., 708, 710 in FIG. 7)) associated with an offload rendering operation (e.g., 1118 in FIG. 11; 1418 in FIG. 14; 1524 in FIG. 15) of multi-media content (e.g., user data, common scene, viewport in FIGS. 7-19) for a UE (e.g., the UE 802).

At 2004, the first network entity receives, from the second network entity, an offload indication response based on the offload indication. As an example, the reception may be performed by one or more of the component 199, the transceiver(s) 2746 and/or the antenna 2780 in FIG. 27, the network interface 2880 in FIG. 28. FIG. 8 illustrates, in the context of FIGS. 11-19, an example of the host server 904 receiving such an offload indication response.

The host server 804 may be configured to receive, from the second network entity (e.g., the render server 805), an offload indication response 810 (e.g., 1110 in FIG. 11; 1212 in FIG. 12; 1310 in FIG. 13; 1410, 1416 in FIG. 14) based on the offload indication 808 (e.g., 1108 in FIG. 11; 1210 in FIG. 12; 1308 in FIG. 13; 1408 in FIG. 14; 1518 in FIG. 15). The host server 804 may be configured to transmit, to the UE 802, a response indication (e.g., an offload notification or response 814) (e.g., 1112 in FIG. 11; 1214 in FIG. 12; 1314 in FIG. 13; 1412 in FIG. 14; 1514 in FIG. 15) associated with the offload indication response 810 (e.g., 1110 in FIG. 11; 1212 in FIG. 12; 1310 in FIG. 13; 1410, 1416 in FIG. 14). In some aspects, the UE 802 may initiate offload rendering (e.g., 1510 in FIG. 13) to the render server 805, while in other aspects, the host server 804 may be configured to initiate offload rendering (e.g., at 1306 in FIG. 13) to the render server 805.

For example, in offload rendering initiated (e.g., at 1306 in FIG. 13) by the host server 804, the offload indication response 810 (e.g., 1310 in FIG. 13) may be an offload acknowledgement indicative of an acceptance of the rendering offload request via the offload indication 808 (e.g., 1108 in FIG. 11; 1210 in FIG. 12; 1308 in FIG. 13; 1408 in FIG. 14; 1518 in FIG. 15). In such aspects, e.g., to notify the UE 802 of the offload rendering, the host server 804 may be configured to transmit, to the UE 802 via second out-of-band signaling (e.g., 708, 710 in FIG. 7), an offload notification (e.g., the offload notification or response 814 (e.g., 1112 in FIG. 11; 1214 in FIG. 12; 1314 in FIG. 13; 1412 in FIG. 14; 1514 in FIG. 15)) that is associated with the offload indication response 810 (e.g., 1110 in FIG. 11; 1212 in FIG. 12; 1310 in FIG. 13; 1410, 1416 in FIG. 14) and that is indicative of transmission of the offload indication 808 (e.g., 1108 in FIG. 11; 1210 in FIG. 12; 1308 in FIG. 13; 1408 in FIG. 14; 1518 in FIG. 15) of the rendering offload request 806 (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15). As another example, in offload rendering initiated (e.g., 1510 in FIG. 13) by the UE 802, the host server 804 may be configured to receive, from the UE 802, via first out-of-band signaling (e.g., 708, 710 in FIG. 7) (e.g., with user data (e.g., 706a, 706b/c in FIG. 7) associated with the UE 802), the rendering offload request 806 (e.g., 1106 in FIG. 11; 1208 in FIG. 12; at 1306 in FIG. 13; 1406 in FIG. 14; 1510 in FIG. 15) associated with the offload rendering operation (e.g., 1118 in FIG. 11; 1418 in FIG. 14; 1524 in FIG. 15) of the multi-media content (e.g., user data, common scene, viewport in FIGS. 7-19).

In some aspects, at least one of the first out-of-band signaling (e.g., 708, 710 in FIG. 7) or the second out-of-band signaling (e.g., 708, 710 in FIG. 7) may be associated with user data (e.g., 706a, 706b/c in FIG. 7) provision(s), and such user data (e.g., 706a, 706b/c in FIG. 7) (e.g., from the UE 802 and received by the UE 802 from the host server 804 in association with the offload notification or response 814 (e.g., 1112 in FIG. 11; 1214 in FIG. 12; 1314 in FIG. 13; 1412 in FIG. 14; 1514 in FIG. 15) via second out-of-band signaling (e.g., 708, 710 in FIG. 7)) may comprise information of at least one additional UE (e.g., the user data 812 of the UE 803a and/or the UE 803b) that is associated with the offload rendering operation (e.g., 1118 in FIG. 11; 1418 in FIG. 14; 1524 in FIG. 15) of the multi-media content (e.g., user data, common scene, viewport in FIGS. 7-19). In aspects, the host server 804 may receive the user data 812 (e.g., 706a, 706b/c in FIG. 7; 1116 in FIG. 11; 1315 in FIG. 13; 1411 in FIG. 14) for forwarding to other UEs and/or for rendering common scenes (e.g., 1516, 1520 in FIG. 15) of a multi-media communication session between the UEs. In aspects for which the offload indication response 810 (e.g., 1110 in FIG. 11; 1212 in FIG. 12; 1310 in FIG. 13; 1410, 1416 in FIG. 14) may be an offload acknowledgement (e.g., 1514 in FIG. 15) indicative of an acceptance of the rendering offload request 806 (e.g., 1106 in FIG. 11; 1208 in FIG. 12; at 1306 in FIG. 13; 1406 in FIG. 14; 1510 in FIG. 15), the host server 804 may be configured to transmit, to the second network entity (e.g., the render server 805), information (e.g., 706a, 706b/c in FIG. 7; 1116 in FIG. 11; 1315 in FIG. 13; 1411 in FIG. 14) of the at least one additional UE (e.g., the UE 803a and/or the UE 803b) that is associated with the offload rendering operation (e.g., 1118 in FIG. 11; 1418 in FIG. 14; 1524 in FIG. 15) of the multi-media content (e.g., user data 818) (e.g., user data, common scene, viewport in FIGS. 7-19).

Accordingly, the UE 802 may be configured to transmit, to the render server 805, the viewport information 816 (e.g., 1114 in FIG. 11; 1506a-d in FIG. 15). Additionally, the host server 804 may be configured to receive, from the UE 803a and/or the UE 803b, the user data 818 (e.g., 706a, 706b/c in FIG. 7; 1116 in FIG. 11; 1315 in FIG. 13; 1411 in FIG. 14), and to transmit or provide, to the render server 805 for utilization in rendering (e.g., 1118 in FIG. 11; 1418 in FIG. 14; 1524 in FIG. 15), the user data 818 (e.g., 706a, 706b/c in FIG. 7; 1116 in FIG. 11; 1315 in FIG. 13; 1411 in FIG. 14) rather than transmitting or providing the user data 818 of the UE 803a and/or the UE 803b to the UE 802 for utilization in rendering a viewport (e.g., 1120 in FIG. 11; 1524 in FIG. 15) (e.g., transmitted or provided to the UE 802 from the render server 805).

In aspects, the offload indication response 810 (e.g., 1110 in FIG. 11; 1212 in FIG. 12; 1310 in FIG. 13; 1410, 1416 in FIG. 14) may be an offload rejection (e.g., 1212 in FIG. 12; 1412 in FIG. 14) indicative of a denial of the rendering offload request 806 (e.g., 1106 in FIG. 11; 1208 in FIG. 12; at 1306 in FIG. 13; 1406 in FIG. 14; 1510 in FIG. 15). In such aspects, the response indication (e.g., the offload notification or response 814 (e.g., 1112 in FIG. 11; 1214 in FIG. 12; 1314 in FIG. 13; 1412 in FIG. 14; 1514 in FIG. 15)) may indicate the denial and may comprise second out-of-band signaling (e.g., 708, 710 in FIG. 7) (e.g., associated with the user data (e.g., 706a, 706b/c in FIG. 7) for the UE 803a and/or the UE 803b). The host server 804 may be configured to transmit, to the second network entity (e.g., the render server 805) and subsequent to reception of the offload indication response 810 (e.g., 1110 in FIG. 11; 1212 in FIG. 12; 1310 in FIG. 13; 1410, 1416 in FIG. 14)), a first offload cancelation indication (e.g., 1614 in FIG. 16; 1712 in FIG. 17), and in such aspects, the host server 804 may be configured to receive, from the second network entity based on the first offload cancelation indication (e.g., 1614 in FIG. 16; 1712 in FIG. 17), an offload cancelation acknowledgement (e.g., 1616a in FIG. 16; 1716a in FIG. 17) (e.g., where the UE 802 or the host server 804 initiates cancelation (e.g., at 1610 in FIG. 16; at 1710 in FIG. 7) of the offload rendering). The host server 804 may be configured to obtain an offload cancelation request associated with at least one of a UE request (e.g., 1612 in FIG. 16) (e.g., UE 802 initiates cancelation) or a determination (e.g., at 1710 in FIG. 17) of a cancelation condition at the first network entity (e.g., host server 804 initiates cancelation). In some aspects, the host server 804 may be configured to receive, from the second network entity (e.g., the render server 805), a second offload cancelation indication (e.g., 1816a in FIG. 18) (e.g., where the render server 805 initiates cancelation (e.g., at 1810 in FIG. 18) of the offload rendering).

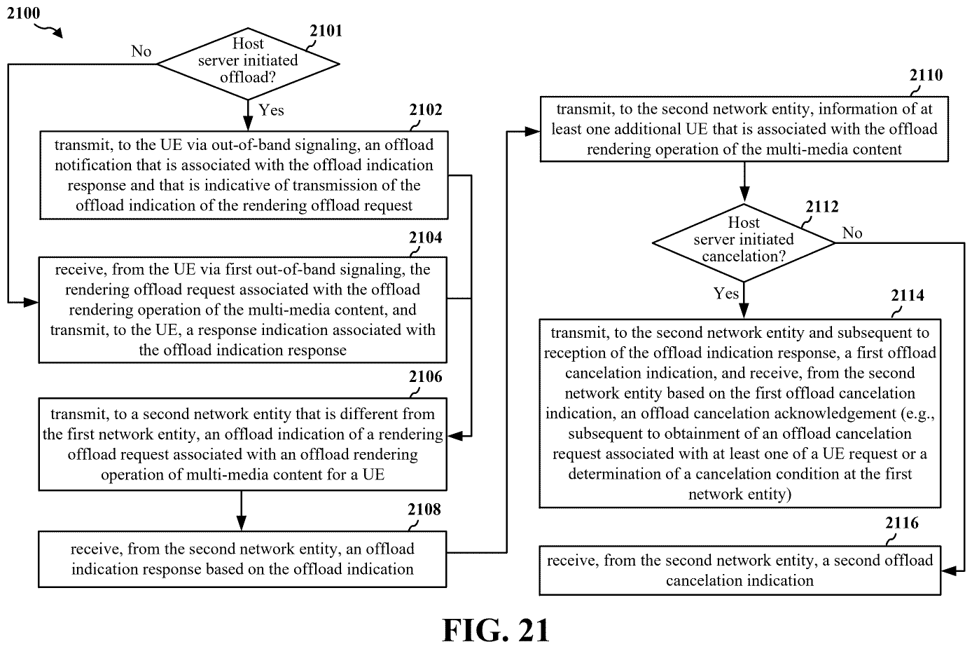

FIG. 21 is a flowchart 2100 of a method of wireless communication. The method may be performed by a base station or a first network entity (such as a server) (e.g., the base station 102; the host server 704, 804, 904, 1004, 1104, 1204, 1304, 1404, 1504, 1604, 1704, 1804, 1904; the network entity 2602, 2702, 2860). The method may be for dynamic rendering offload for multi-media communications. The method may enable a device in a communications session, via a host server, to offload the rendering of viewports to a render server, may enable signaling for dynamic rendering offloads in both SFU and MCU architectures and provide for dynamic rendering offloads to be initiated and/or canceled by a device, by a render server, or by a host server, and may further enable handling of conditions for changes to radio links in communication sessions, numbers of users in communication sessions, device processing power utilization, user preferences, and/or the like.

At 2101, it is determined if the host server initiated the offload rendering. As an example, the determination may be performed by one or more of the component 199, the transceiver(s) 2746 and/or the antenna 2780 in FIG. 27, the network interface 2880 in FIG. 28. If so, flowchart 2100 may continue to 2102; if not, flowchart 2100 may continue to 2104.

At 2102, the first network entity transmits, to the UE via out-of-band signaling, an offload notification that is associated with the offload indication response and that is indicative of transmission of the offload indication of the rendering offload request. As an example, the transmission may be performed by one or more of the component 199, the transceiver(s) 2746 and/or the antenna 2780 in FIG. 27, the network interface 2880 in FIG. 28. FIG. 8 illustrates, in the context of FIGS. 11-19, an example of the host server 804 transmitting such an offload indication.

For example, in offload rendering initiated (e.g., at 1306 in FIG. 13) by the host server 804, the offload indication response 810 (e.g., 1310 in FIG. 13) may be an offload acknowledgement indicative of an acceptance of the rendering offload request via the offload indication 808 (e.g., 1108 in FIG. 11; 1210 in FIG. 12; 1308 in FIG. 13; 1408 in FIG. 14; 1518 in FIG. 15). In such aspects, e.g., to notify the UE 802 of the offload rendering, the host server 804 may be configured to transmit, to the UE 802 via second out-of-band signaling (e.g., 708, 710 in FIG. 7), an offload notification (e.g., the offload notification or response 814 (e.g., 1112 in FIG. 11; 1214 in FIG. 12; 1314 in FIG. 13; 1412 in FIG. 14; 1514 in FIG. 15)) that is associated with the offload indication response 810 (e.g., 1110 in FIG. 11; 1212 in FIG. 12; 1310 in FIG. 13; 1410, 1416 in FIG. 14) and that is indicative of transmission of the offload indication 808 (e.g., 1108 in FIG. 11; 1210 in FIG. 12; 1308 in FIG. 13; 1408 in FIG. 14; 1518 in FIG. 15) of the rendering offload request 806 (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15).

At 2104, the first network entity receives, from the UE via first out-of-band signaling, the rendering offload request associated with the offload rendering operation of the multi-media content, and transmits, to the UE, a response indication associated with the offload indication response. As an example, the reception and transmission may be performed by one or more of the component 199, the transceiver(s) 2746 and/or the antenna 2780 in FIG. 27, the network interface 2880 in FIG. 28. FIG. 8 illustrates, in the context of FIGS. 11-19, an example of the host server 804 receiving such a rendering offload request and transmitting such a response indication (e.g., to the UE 802).

As another example, in offload rendering initiated by the UE 802, the host server 804 may be configured to receive, from the UE 802, via first out-of-band signaling (e.g., 708, 710 in FIG. 7) (e.g., with user data (e.g., 706a, 706b/c in FIG. 7) associated with the UE 802), the rendering offload request 806 (e.g., 1106 in FIG. 11; 1208 in FIG. 12; at 1306 in FIG. 13; 1406 in FIG. 14; 1510 in FIG. 15) associated with the offload rendering operation (e.g., 1118 in FIG. 11; 1418 in FIG. 14; 1524 in FIG. 15) of the multi-media content (e.g., user data, common scene, viewport in FIGS. 7-19). In aspects, e.g., to acknowledge the UE 802 for the offload rendering, the host server 804 may be configured to transmit, to the UE 802 via second out-of-band signaling (e.g., 708, 710 in FIG. 7), an offload notification (e.g., the offload notification or response 814 (e.g., 1112 in FIG. 11; 1214 in FIG. 12; 1314 in FIG. 13; 1412 in FIG. 14; 1514 in FIG. 15)) that is associated with the offload indication response 810 (e.g., 1110 in FIG. 11; 1212 in FIG. 12; 1310 in FIG. 13; 1410, 1416 in FIG. 14) and that is indicative of transmission of the offload indication 808 (e.g., 1108 in FIG. 11; 1210 in FIG. 12; 1308 in FIG. 13; 1408 in FIG. 14; 1518 in FIG. 15) of the rendering offload request 806 (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15). At 2106, the first network entity transmits, to a second network entity that is different from the first network entity, an offload indication of a rendering offload request associated with an offload rendering operation of multi-media content for a UE. As an example, the transmission may be performed by one or more of the component 199, the transceiver(s) 2746 and/or the antenna 2780 in FIG. 27, the network interface 2880 in FIG. 28. FIG. 8 illustrates, in the context of FIGS. 11-19, an example of the host server 804 transmitting such an offload indication.

The host server 804 (e.g., a first network entity) may be configured to transmit, to a second network entity (e.g., the render server 805) that is different from the first network entity, an offload indication 808 (e.g., 1108 in FIG. 11; 1210 in FIG. 12; 1308 in FIG. 13; 1408 in FIG. 14; 1518 in FIG. 15) of a rendering offload request 806 (e.g., 1106 in FIG. 11; 1208 in FIG. 12; at 1306 in FIG. 13; 1406 in FIG. 14; 1510 in FIG. 15) (via first out-of-band signaling (e.g., 708, 710 in FIG. 7)) associated with an offload rendering operation (e.g., 1118 in FIG. 11; 1418 in FIG. 14; 1524 in FIG. 15) of multi-media content (e.g., user data, common scene, viewport in FIGS. 7-19) for a UE (e.g., the UE 802).

At 2108, the first network entity receives, from the second network entity, an offload indication response based on the offload indication. As an example, the reception may be performed by one or more of the component 199, the transceiver(s) 2746 and/or the antenna 2780 in FIG. 27, the network interface 2880 in FIG. 28. FIG. 8 illustrates, in the context of FIGS. 11-19, an example of the host server 904 receiving such an offload indication response.

The host server 804 may be configured to receive, from the second network entity (e.g., the render server 805), an offload indication response 810 (e.g., 1110 in FIG. 11; 1212 in FIG. 12; 1310 in FIG. 13; 1410, 1416 in FIG. 14) based on the offload indication 808 (e.g., 1108 in FIG. 11; 1210 in FIG. 12; 1308 in FIG. 13; 1408 in FIG. 14; 1518 in FIG. 15). The host server 804 may be configured to transmit, to the UE 802, a response indication (e.g., an offload notification or response 814) (e.g., 1112 in FIG. 11; 1214 in FIG. 12; 1314 in FIG. 13; 1412 in FIG. 14; 1514 in FIG. 15) associated with the offload indication response 810 (e.g., 1110 in FIG. 11; 1212 in FIG. 12; 1310 in FIG. 13; 1410, 1416 in FIG. 14). In some aspects, the UE 802 may initiate offload rendering (e.g., 1510 in FIG. 13) to the render server 805, while in other aspects, the host server 804 may be configured to initiate offload rendering (e.g., at 1306 in FIG. 13) to the render server 805.

At 2110, the first network entity transmits, to the second network entity, information of at least one additional UE that is associated with the offload rendering operation of the multi-media content. As an example, the transmission may be performed by one or more of the component 199, the transceiver(s) 2746 and/or the antenna 2780 in FIG. 27, the network interface 2880 in FIG. 28. FIG. 8 illustrates, in the context of FIGS. 11-19, an example of the host server 904 transmitting such information (e.g., to the render server 905).

In some aspects, at least one of the first out-of-band signaling (e.g., 708, 710 in FIG. 7) or the second out-of-band signaling (e.g., 708, 710 in FIG. 7) may be associated with user data (e.g., 706a, 706b/c in FIG. 7) provision(s), and such user data (e.g., 706a, 706b/c in FIG. 7) (e.g., from the UE 802 and received by the UE 802 from the host server 804 in association with the offload notification or response 814 (e.g., 1112 in FIG. 11; 1214 in FIG. 12; 1314 in FIG. 13; 1412 in FIG. 14; 1514 in FIG. 15) via second out-of-band signaling (e.g., 708, 710 in FIG. 7)) may comprise information of at least one additional UE (e.g., the user data 812 of the UE 803a and/or the UE 803b) that is associated with the offload rendering operation (e.g., 1118 in FIG. 11; 1418 in FIG. 14; 1524 in FIG. 15) of the multi-media content (e.g., user data, common scene, viewport in FIGS. 7-19). In aspects, the host server 804 may receive the user data 812 (e.g., 706a, 706b/c in FIG. 7; 1116 in FIG. 11; 1315 in FIG. 13; 1411 in FIG. 14) for forwarding to other UEs and/or for rendering common scenes (e.g., 1516, 1520 in FIG. 15) of a multi-media communication session between the UEs. In aspects for which the offload indication response 810 (e.g., 1110 in FIG. 11; 1212 in FIG. 12; 1310 in FIG. 13; 1410, 1416 in FIG. 14) may be an offload acknowledgement (e.g., 1514 in FIG. 15) indicative of an acceptance of the rendering offload request 806 (e.g., 1106 in FIG. 11; 1208 in FIG. 12; at 1306 in FIG. 13; 1406 in FIG. 14; 1510 in FIG. 15), the host server 804 may be configured to transmit, to the second network entity (e.g., the render server 805), information (e.g., 706a, 706b/c in FIG. 7; 1116 in FIG. 11; 1315 in FIG. 13; 1411 in FIG. 14) of the at least one additional UE (e.g., the UE 803a and/or the UE 803b) that is associated with the offload rendering operation (e.g., 1118 in FIG. 11; 1418 in FIG. 14; 1524 in FIG. 15) of the multi-media content (e.g., user data 818) (e.g., user data, common scene, viewport in FIGS. 7-19).

Accordingly, the UE 802 may be configured to transmit, to the render server 805, the viewport information 816 (e.g., 1114 in FIG. 11; 1506a-d in FIG. 15). Additionally, the host server 804 may be configured to receive, from the UE 803a and/or the UE 803b, the user data 818 (e.g., 706a, 706b/c in FIG. 7; 1116 in FIG. 11; 1315 in FIG. 13; 1411 in FIG. 14), and to transmit or provide, to the render server 805 for utilization in rendering (e.g., 1118 in FIG. 11; 1418 in FIG. 14; 1524 in FIG. 15), the user data 818 (e.g., 706a, 706b/c in FIG. 7; 1116 in FIG. 11; 1315 in FIG. 13; 1411 in FIG. 14) rather than transmitting or providing the user data 818 of the UE 803a and/or the UE 803b to the UE 802 for utilization in rendering a viewport (e.g., 1120 in FIG. 11; 1524 in FIG. 15) (e.g., transmitted or provided to the UE 802 from the render server 805).

At 2112, it is determined if the host server initiated cancelation of the offload rendering. As an example, the determination may be performed by one or more of the component 199, the transceiver(s) 2746 and/or the antenna 2780 in FIG. 27, the network interface 2880 in FIG. 28. If so, flowchart 2100 may continue to 2114; if not, flowchart 2100 may continue to 2112.

At 2114, the first network entity transmits, to the second network entity and subsequent to reception of the offload indication response, a first offload cancelation indication, and receives, from the second network entity based on the first offload cancelation indication, an offload cancelation acknowledgement (e.g., subsequent to obtainment of an offload cancelation request associated with at least one of a UE request or a determination of a cancelation condition at the first network entity). As an example, the transmission and reception may be performed by one or more of the component 199, the transceiver(s) 2746 and/or the antenna 2780 in FIG. 27, the network interface 2880 in FIG. 28. FIG. 8 illustrates, in the context of FIGS. 11-19, an example of the host server 804 transmitting such an offload cancelation indication and receiving such an offload cancelation acknowledgement.

In aspects, the offload indication response 810 (e.g., 1110 in FIG. 11; 1212 in FIG. 12; 1310 in FIG. 13; 1410, 1416 in FIG. 14) may be an offload rejection (e.g., 1212 in FIG. 12; 1412 in FIG. 14) indicative of a denial of the rendering offload request 806 (e.g., 1106 in FIG. 11; 1208 in FIG. 12; at 1306 in FIG. 13; 1406 in FIG. 14; 1510 in FIG. 15). In such aspects, the response indication (e.g., the offload notification or response 814 (e.g., 1112 in FIG. 11; 1214 in FIG. 12; 1314 in FIG. 13; 1412 in FIG. 14; 1514 in FIG. 15)) may indicate the denial and may comprise second out-of-band signaling (e.g., 708, 710 in FIG. 7) (e.g., associated with the user data (e.g., 706a, 706b/c in FIG. 7) for the UE 803a and/or the UE 803b). The host server 804 may be configured to transmit, to the second network entity (e.g., the render server 805) and subsequent to reception of the offload indication response 810 (e.g., 1110 in FIG. 11; 1212 in FIG. 12; 1310 in FIG. 13; 1410, 1416 in FIG. 14)), a first offload cancelation indication (e.g., 1614 in FIG. 16; 1712 in FIG. 17), and in such aspects, the host server 804 may be configured to receive, from the second network entity based on the first offload cancelation indication (e.g., 1614 in FIG. 16; 1712 in FIG. 17), an offload cancelation acknowledgement (e.g., 1616a in FIG. 16; 1716a in FIG. 17) (e.g., where the UE 802 or the host server 804 initiates cancelation (e.g., at 1610 in FIG. 16; at 1710 in FIG. 7) of the offload rendering). The host server 804 may be configured to obtain an offload cancelation request associated with at least one of a UE request (e.g., 1612 in FIG. 16) (e.g., UE 802 initiates cancelation) or a determination (e.g., at 1710 in FIG. 17) of a cancelation condition at the first network entity (e.g., host server 804 initiates cancelation).

At 2116, the first network entity receives, from the second network entity, a second offload cancelation indication. As an example, the reception may be performed by one or more of the component 199, the transceiver(s) 2746 and/or the antenna 2780 in FIG. 27, the network interface 2880 in FIG. 28. FIG. 8 illustrates, in the context of FIGS. 11-19, an example of the host server 804 receiving such an offload cancelation indication.

In aspects, the offload indication response 810 (e.g., 1110 in FIG. 11; 1212 in FIG. 12; 1310 in FIG. 13; 1410, 1416 in FIG. 14) may be an offload rejection (e.g., 1212 in FIG. 12; 1412 in FIG. 14) indicative of a denial of the rendering offload request 806 (e.g., 1106 in FIG. 11; 1208 in FIG. 12; at 1306 in FIG. 13; 1406 in FIG. 14; 1510 in FIG. 15). In such aspects, the response indication (e.g., the offload notification or response 814 (e.g., 1112 in FIG. 11; 1214 in FIG. 12; 1314 in FIG. 13; 1412 in FIG. 14; 1514 in FIG. 15)) may indicate the denial and may comprise second out-of-band signaling (e.g., 708, 710 in FIG. 7) (e.g., associated with the user data (e.g., 706a, 706b/c in FIG. 7) for the UE 803a and/or the UE 803b). In some aspects, the host server 804 may be configured to receive, from the second network entity (e.g., the render server 805), a second offload cancelation indication (e.g., 1816a in FIG. 18) (e.g., where the render server 805 initiates cancelation (e.g., at 1810 in FIG. 18) of the offload rendering).

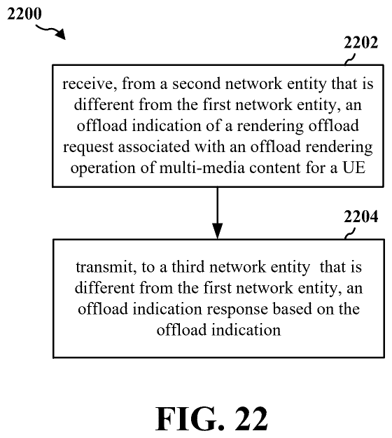

FIG. 22 is a flowchart 2200 of a method of wireless communication. The method may be performed by a base station or a first network entity (such as a server) (e.g., the base station 102; the render server 705, 805, 905, 1005, 1105, 1205, 1305, 1405, 1505, 1605, 1705, 1805, 1905; the network entity 2602, 2702, 2860). The method may be for dynamic rendering offload for multi-media communications. The method may enable a device in a communications session, via a host server, to offload the rendering of viewports to a render server, may enable signaling for dynamic rendering offloads in both SFU and MCU architectures and provide for dynamic rendering offloads to be initiated and/or canceled by a device, by a render server, or by a host server, and may further enable handling of conditions for changes to radio links in communication sessions, numbers of users in communication sessions, device processing power utilization, user preferences, and/or the like.

At 2202, the first network entity receives, from a second network entity that is different from the first network entity, an offload indication of a rendering offload request associated with an offload rendering operation of multi-media content for a UE. As an example, the reception may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 receiving such an offload indication.

The render server 905 (e.g., a first network entity) may be configured to receive, from a second network entity (e.g., the host server 904 when initiating offload rendering (e.g., 1306 in FIG. 13) or the UE 902 when initiating offload rendering (e.g., 1510 in FIG. 13)) that is different from the first network entity, an offload indication (e.g., an offload indication 906a or an offload indication 906b) (e.g., 1108 in FIG. 11; 1210 in FIG. 12; 1308 in FIG. 13; 1408 in FIG. 14; 1510, 1518 in FIG. 15) of a rendering offload request (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15) associated with an offload rendering operation (e.g., 1118 in FIG. 11; 1418 in FIG. 14; 1524 in FIG. 15) of multi-media content (e.g., user data, common scene, viewport in FIGS. 7-19) for the UE 902.

At 2204, the first network entity transmits, to a third network entity that is different from the first network entity, an offload indication response based on the offload indication. As an example, the transmission may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 transmitting such an offload indication response.

The render server 905 (e.g., the first network entity) may be configured to transmit, to a third network entity (e.g., the UE 902 when initiating offload rendering (e.g., 1510 in FIG. 13) or the host server 904 when initiating offload rendering (e.g., at 1306 in FIG. 13)) that is different from the first network entity, an offload indication response (e.g., an offload indication response 908b or an offload indication response 908a) (e.g., 1110 in FIG. 11; 1212 in FIG. 12; 1310 in FIG. 13; 1410, 1416 in FIG. 14; 1514 in FIG. 15) based on the offload indication (e.g., the offload indication 906b or the offload indication 906a) (e.g., 1108 in FIG. 11; 1210 in FIG. 12; 1308 in FIG. 13; 1408 in FIG. 14; 1510, 1518 in FIG. 15).

In some aspects, e.g., where the host server 904 initiates offload rendering (e.g., at 1306 in FIG. 13)), the host server 904 may be configured to receive, from the UE 903a and/or the UE 903b, user data 910 (e.g., 706a, 706b/c in FIG. 7; 1116 in FIG. 11; 1315 in FIG. 13; 1411 in FIG. 14), and to transmit or provide, which may be received by the UE 902, an offload notification 912 (e.g., 1112 in FIG. 11; 1214 in FIG. 12; 1314 in FIG. 13; 1412 in FIG. 14; 1514 in FIG. 15) as out-of-band signaling (e.g., 708, 710 in FIG. 7) with user data 910 (e.g., 706a, 706b/c in FIG. 7; 1116 in FIG. 11; 1315 in FIG. 13; 1411 in FIG. 14). In aspects, the host server 904 may receive the user data 910 (e.g., 706a, 706b/c in FIG. 7; 1116 in FIG. 11; 1315 in FIG. 13; 1411 in FIG. 14) for forwarding to other UEs and/or for rendering common scenes (e.g., 1516, 1520 in FIG. 15) of a multi-media communication session between the UEs.

The render server 905 may be configured to render (at 918) (e.g., 1118 in FIG. 11; 1418 in FIG. 14; 1524 in FIG. 15) a viewport (e.g., 1120 in FIG. 11; 1524 in FIG. 15) based on the viewport information (e.g., 1114 in FIG. 11; 1506a-d in FIG. 15) and an offload notification acknowledgement (e.g., 1518 in FIG. 15). As one example, the host server 904 may be configured to receive, from the UE 903a and/or the UE 903b, user data 916 (e.g., 706a, 706b/c in FIG. 7; 1116 in FIG. 11; 1315 in FIG. 13; 1411 in FIG. 14), and to transmit or provide, which may be received by the render server 905 for utilization in rendering (at 918) (e.g., 1118 in FIG. 11; 1418 in FIG. 14; 1524 in FIG. 15), the user data 916 (e.g., 706a, 706b/c in FIG. 7; 1116 in FIG. 11; 1315 in FIG. 13; 1411 in FIG. 14) rather than transmitting or providing the user data 916 (e.g., 706a, 706b/c in FIG. 7; 1116 in FIG. 11; 1315 in FIG. 13; 1411 in FIG. 14) of the UE 903a and/or the UE 903b to the UE 902 for utilization in rendering (at 918) (e.g., 1118 in FIG. 11; 1418 in FIG. 14; 1524 in FIG. 15) the viewport 920 (e.g., 1120 in FIG. 11; 1524 in FIG. 15). The render server 905 may be configured to transmit or provide the viewport 920 (e.g., 1120 in FIG. 11; 1524 in FIG. 15) (rendered at (918) (e.g., 1118 in FIG. 11; 1418 in FIG. 14; 1524 in FIG. 15)) to the UE 902.

In aspects for which the first network entity is the render server 905 and the second network entity is the UE 902, the render server 905 may be configured to receive the offload indication 906b (e.g., 1108 in FIG. 11; 1210 in FIG. 12; 1308 in FIG. 13; 1408 in FIG. 14; 1518 in FIG. 15) of the rendering offload request (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15), including to receive, from the UE 902, the viewport information 914 (e.g., 1114 in FIG. 11; 1506a-d in FIG. 15) associated with the rendering offload request (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15) and the offload rendering operation (e.g., 1118 in FIG. 11; 1418 in FIG. 14; 1524 in FIG. 15) of the multi-media content (e.g., user data, common scene, viewport in FIGS. 7-19) for the UE 902. In such aspects, the render server 905 may be configured to render (at 918) (e.g., 1118 in FIG. 11; 1418 in FIG. 14; 1524 in FIG. 15) the viewport 920 (e.g., 1120 in FIG. 11; 1524 in FIG. 15) based on the viewport information 914 (e.g., 1114 in FIG. 11; 1506a-d in FIG. 15) and an offload notification acknowledgement (e.g., 1518 in FIG. 15) (e.g., with the offload indication response 908b (e.g., 1110 in FIG. 11; 1212 in FIG. 12; 1310 in FIG. 13; 1410, 1416 in FIG. 14; 1514 in FIG. 15)), and to transmit, to the UE 902, the viewport 920 (e.g., 1120 in FIG. 11; 1524 in FIG. 15).

In aspects for which the third network entity is the host server 904, and the offload indication response 908a is an offload notification (e.g., 1112 in FIG. 11; 1214 in FIG. 12; 1314 in FIG. 13; 1412 in FIG. 14; 1514 in FIG. 15), the render server 905 may be configured to receive, from the host server 904, an offload notification acknowledgement (e.g., 1518 in FIG. 15) subsequent to transmission of the offload notification (e.g., 1112 in FIG. 11; 1214 in FIG. 12; 1314 in FIG. 13; 1412 in FIG. 14; 1514 in FIG. 15).

The render server 905 may be configured to receive, from the third network entity (e.g., the host server 904), information (e.g., user data 916 (e.g., 706a, 706b/c in FIG. 7; 1116 in FIG. 11; 1315 in FIG. 13; 1411 in FIG. 14)) of at least one additional UE (the UE 803a and/or the UE 803b) that is associated with the offload rendering operation (e.g., 1118 in FIG. 11; 1418 in FIG. 14; 1524 in FIG. 15) of the multi-media content (e.g., user data, common scene, viewport in FIGS. 7-19). The render server 905 may be configured to render (at 918) (e.g., 1118 in FIG. 11; 1418 in FIG. 14; 1524 in FIG. 15) the viewport 920 (e.g., 1120 in FIG. 11; 1524 in FIG. 15) further based on the information (e.g., 706a, 706b/c in FIG. 7; 1116 in FIG. 11; 1315 in FIG. 13; 1411 in FIG. 14) of the at least one additional UE.

In some aspects, the render server 905 may be unavailable for offload rendering (e.g., based on a rendering overload (e.g., at 1409 in FIG. 14)). Accordingly, the render server 905 may deny offload requests and/or offload indications. For example, the render server 905 may be configured to transmit or provide the offload indication response (e.g., 908a or 908b) (e.g., 1212 in FIG. 12; 1410 in FIG. 14) as an offload rejection indicative of a denial of the rendering offload request (e.g., 1208, 1210 in FIG. 12; 1406, 1408 in FIG. 14) based on an indication of a rendering overload (e.g., at 1409 in FIG. 14) at the render server 905). In such aspects, the render server 905 may be configured to obtain or determine (e.g., at 1414 in FIG. 14), subsequent to transmission of the offload indication response (e.g., 908a or 908b) (e.g., 1212 in FIG. 12; 1410 in FIG. 14), a rendering availability indication indicative of an absence of the rendering overload. The render server 905 may be configured to the transmit, to the second network entity (e.g., the host server 904) and based on the rendering availability indication, an offload availability indication (e.g., 1416 in FIG. 14) indicative of an availability at the first network entity (e.g., the render server 905) for offload rendering (e.g., 1118 in FIG. 11; 1418 in FIG. 14; 1524 in FIG. 15). In aspects, the offload availability indication (e.g., 1416 in FIG. 14) may be further indicative of a number of rendering processes (e.g., of: 1118 in FIG. 11; 1418 in FIG. 14; 1524 in FIG. 15) associated with the availability (e.g., based on: at 1414, 1416 in FIG. 14) at the first network entity (e.g., the render server 905) for the offload rendering (e.g., 1118 in FIG. 11; 1418 in FIG. 14; 1524 in FIG. 15).

The render server 905 may be configured (i) to receive, from the third network entity (e.g., the host server 904) and subsequent to transmission of the offload indication response (e.g., 1212 in FIG. 12; 1410 in FIG. 14), a first offload cancelation indication (e.g., 1614 in FIG. 16; 1712 in FIG. 17), and transmit, to the third network entity based on the first offload cancelation indication (e.g., 1614 in FIG. 16), an offload cancelation acknowledgement (e.g., 1616a, 1616b in FIG. 16) and/or (ii) to transmit, to at least one of the second network entity or the third network entity (e.g., the UE 902 and/or the host server 904), a second offload cancelation indication (e.g., 1716a, 1716b in FIG. 17; 1816a, 1816b in FIG. 18; 1916a, 1916b in FIG. 19). The render server 905 may be configured to transmit the second offload cancelation indication (e.g., 1716a, 1716b in FIG. 17; 1816a, 1816b in FIG. 18; 1916a, 1916b in FIG. 19) subsequent to obtainment of an offload cancelation request (e.g., 1912 in FIG. 19) associated with at least one of a UE 902 request or a determination (e.g., at 1810 in FIG. 18) of a cancelation condition at the first network entity (e.g., the render server 905).

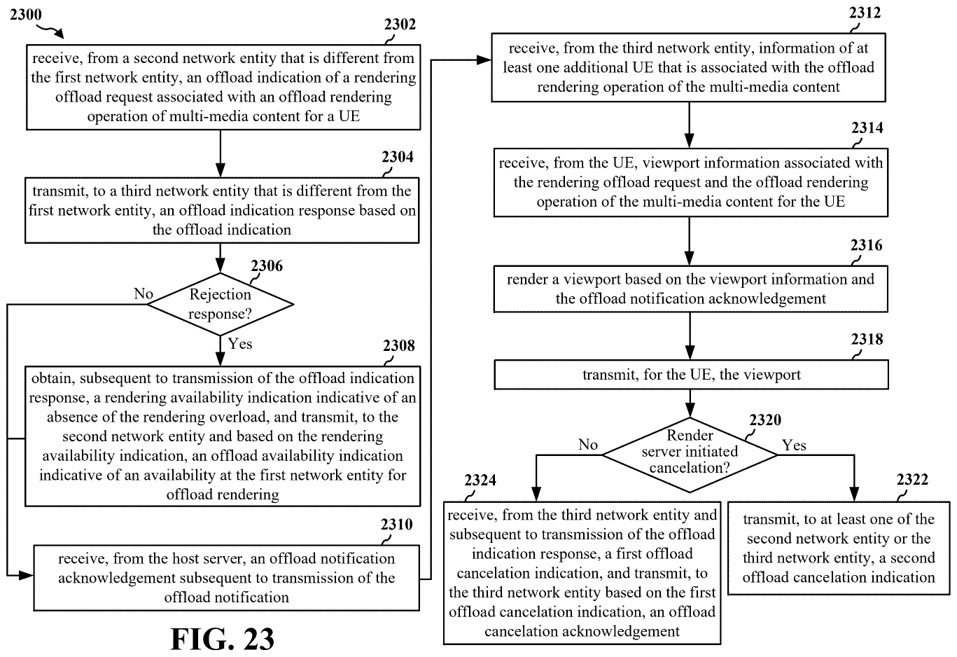

FIG. 23 is a flowchart 2300 of a method of wireless communication. The method may be performed by a base station or a first network entity (such as a server) (e.g., the base station 102; the render server 705, 805, 905, 1005, 1105, 1205, 1305, 1405, 1505, 1605, 1705, 1805, 1905; the network entity 2602, 2702, 2860). The method may be for dynamic rendering offload for multi-media communications. The method may enable a device in a communications session, via a host server, to offload the rendering of viewports to a render server, may enable signaling for dynamic rendering offloads in both SFU and MCU architectures and provide for dynamic rendering offloads to be initiated and/or canceled by a device, by a render server, or by a host server, and may further enable handling of conditions for changes to radio links in communication sessions, numbers of users in communication sessions, device processing power utilization, user preferences, and/or the like.

At 2302, the first network entity receives, from a second network entity that is different from the first network entity, an offload indication of a rendering offload request associated with an offload rendering operation of multi-media content for a UE. As an example, the reception may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 receiving such an offload indication.

The render server 905 (e.g., a first network entity) may be configured to receive, from a second network entity (e.g., the host server 904 when initiating offload rendering (e.g., 1306 in FIG. 13) or the UE 902 when initiating offload rendering (e.g., 1510 in FIG. 13)) that is different from the first network entity, an offload indication (e.g., an offload indication 906a or an offload indication 906b) (e.g., 1108 in FIG. 11; 1210 in FIG. 12; 1308 in FIG. 13; 1408 in FIG. 14; 1510, 1518 in FIG. 15) of a rendering offload request (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15) associated with an offload rendering operation (e.g., 1118 in FIG. 11; 1418 in FIG. 14; 1524 in FIG. 15) of multi-media content (e.g., user data, common scene, viewport in FIGS. 7-19) for the UE 902.

At 2304, the first network entity transmits, to a third network entity that is different from the first network entity, an offload indication response based on the offload indication. As an example, the transmission may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 transmitting such an offload indication response.

The render server 905 (e.g., the first network entity) may be configured to transmit, to a third network entity (e.g., the UE 902 when initiating offload rendering (e.g., 1510 in FIG. 13) or the host server 904 when initiating offload rendering (e.g., at 1306 in FIG. 13)) that is different from the first network entity, an offload indication response (e.g., an offload indication response 908b or an offload indication response 908a) (e.g., 1110 in FIG. 11; 1212 in FIG. 12; 1310 in FIG. 13; 1410, 1416 in FIG. 14; 1514 in FIG. 15) based on the offload indication (e.g., the offload indication 906b or the offload indication 906a) (e.g., 1108 in FIG. 11; 1210 in FIG. 12; 1308 in FIG. 13; 1408 in FIG. 14; 1510, 1518 in FIG. 15).

In some aspects, e.g., where the host server 904 initiates offload rendering (e.g., at 1306 in FIG. 13)), the host server 904 may be configured to receive, from the UE 903a and/or the UE 903b, user data 910 (e.g., 706a, 706b/c in FIG. 7; 1116 in FIG. 11; 1315 in FIG. 13; 1411 in FIG. 14), and to transmit or provide, which may be received by the UE 902, an offload notification 912 (e.g., 1112 in FIG. 11; 1214 in FIG. 12; 1314 in FIG. 13; 1412 in FIG. 14; 1514 in FIG. 15) as out-of-band signaling (e.g., 708, 710 in FIG. 7) with user data 910 (e.g., 706a, 706b/c in FIG. 7; 1116 in FIG. 11; 1315 in FIG. 13; 1411 in FIG. 14). In aspects, the host server 904 may receive the user data 910 (e.g., 706a, 706b/c in FIG. 7; 1116 in FIG. 11; 1315 in FIG. 13; 1411 in FIG. 14) for forwarding to other UEs and/or for rendering common scenes (e.g., 1516, 1520 in FIG. 15) of a multi-media communication session between the UEs.

At 2306, it is determined if the response is a rejection response. As an example, the determination may be performed by one or more of the component 199, the transceiver(s) 2746 and/or the antenna 2780 in FIG. 27, the network interface 2880 in FIG. 28. If so, flowchart 2300 may continue to 2308; if not, flowchart 2300 may continue to 2310.

At 2308, the first network entity obtains, subsequent to transmission of the offload indication response, a rendering availability indication indicative of an absence of the rendering overload, and transmits, to the second network entity and based on the rendering availability indication, an offload availability indication indicative of an availability at the first network entity for offload rendering. As an example, the obtainment and transmission may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 obtaining such a rendering availability indication and transmitting such an offload availability indication.

In some aspects, the render server 905 may be unavailable for offload rendering (e.g., based on a rendering overload (e.g., at 1409 in FIG. 14)). Accordingly, the render server 905 may deny offload requests and/or offload indications. For example, the render server 905 may be configured to transmit or provide the offload indication response (e.g., 908a or 908b) (e.g., 1212 in FIG. 12; 1410 in FIG. 14) as an offload rejection indicative of a denial of the rendering offload request (e.g., 1208, 1210 in FIG. 12; 1406, 1408 in FIG. 14) based on an indication of a rendering overload (e.g., at 1409 in FIG. 14) at the render server 905). In such aspects, the render server 905 may be configured to obtain or determine (e.g., at 1414 in FIG. 14), subsequent to transmission of the offload indication response (e.g., 908a or 908b) (e.g., 1212 in FIG. 12; 1410 in FIG. 14), a rendering availability indication indicative of an absence of the rendering overload. The render server 905 may be configured to the transmit, to the second network entity (e.g., the host server 904) and based on the rendering availability indication, an offload availability indication (e.g., 1416 in FIG. 14) indicative of an availability at the first network entity (e.g., the render server 905) for offload rendering (e.g., 1118 in FIG. 11; 1418 in FIG. 14; 1524 in FIG. 15). In aspects, the offload availability indication (e.g., 1416 in FIG. 14) may be further indicative of a number of rendering processes (e.g., of: 1118 in FIG. 11; 1418 in FIG. 14; 1524 in FIG. 15) associated with the availability (e.g., based on: at 1414, 1416 in FIG. 14) at the first network entity (e.g., the render server 905) for the offload rendering (e.g., 1118 in FIG. 11; 1418 in FIG. 14; 1524 in FIG. 15).

At 2310, the first network entity receives, from the host server, an offload notification acknowledgement subsequent to transmission of the offload notification. As an example, the reception may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 receiving such an offload notification acknowledgement (e.g., from the host server 904).

In aspects for which the third network entity is the host server 904, and the offload indication response 908a is an offload notification (e.g., 1112 in FIG. 11; 1214 in FIG. 12; 1314 in FIG. 13; 1412 in FIG. 14; 1514 in FIG. 15), the render server 905 may be configured to receive, from the host server 904, an offload notification acknowledgement (e.g., 1518 in FIG. 15) subsequent to transmission of the offload notification (e.g., 1112 in FIG. 11; 1214 in FIG. 12; 1314 in FIG. 13; 1412 in FIG. 14; 1514 in FIG. 15).

At 2312, the first network entity receives, from the third network entity, information of at least one additional UE that is associated with the offload rendering operation of the multi-media content. As an example, the reception may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 receiving such an offload notification acknowledgement (e.g., from the host server 904).

The render server 905 may be configured to receive, from the third network entity (e.g., the host server 904), information (e.g., user data 916 (e.g., 706a, 706b/c in FIG. 7; 1116 in FIG. 11; 1315 in FIG. 13; 1411 in FIG. 14)) of at least one additional UE (the UE 803a and/or the UE 803b) that is associated with the offload rendering operation (e.g., 1118 in FIG. 11; 1418 in FIG. 14; 1524 in FIG. 15) of the multi-media content (e.g., user data, common scene, viewport in FIGS. 7-19). The render server 905 may be configured to render (at 918) (e.g., 1118 in FIG. 11; 1418 in FIG. 14; 1524 in FIG. 15) the viewport 920 (e.g., 1120 in FIG. 11; 1524 in FIG. 15) further based on the information (e.g., 706a, 706b/c in FIG. 7; 1116 in FIG. 11; 1315 in FIG. 13; 1411 in FIG. 14) of the at least one additional UE.

At 2314, the first network entity receives, from the UE, viewport information associated with the rendering offload request and the offload rendering operation of the multi-media content for the UE. As an example, the reception may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 receiving such viewport information (e.g., from the UE 902).

In aspects for which the first network entity is the render server 905 and the second network entity is the UE 902, the render server 905 may be configured to receive the offload indication 906b (e.g., 1108 in FIG. 11; 1210 in FIG. 12; 1308 in FIG. 13; 1408 in FIG. 14; 1518 in FIG. 15) of the rendering offload request (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15), including to receive, from the UE 902, the viewport information 914 (e.g., 1114 in FIG. 11; 1506a-d in FIG. 15) associated with the rendering offload request (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15) and the offload rendering operation (e.g., 1118 in FIG. 11; 1418 in FIG. 14; 1524 in FIG. 15) of the multi-media content (e.g., user data, common scene, viewport in FIGS. 7-19) for the UE 902.

At 2316, the first network entity renders a viewport based on the viewport information and the offload notification acknowledgement. As an example, the render may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 rendering such a viewport (e.g., for the UE 902).

The render server 905 may be configured to render (at 918) (e.g., 1118 in FIG. 11; 1418 in FIG. 14; 1524 in FIG. 15) a viewport (e.g., 1120 in FIG. 11; 1524 in FIG. 15) based on the viewport information (e.g., 1114 in FIG. 11; 1506a-d in FIG. 15) and an offload notification acknowledgement (e.g., 1518 in FIG. 15). As one example, the host server 904 may be configured to receive, from the UE 903a and/or the UE 903b, user data 916 (e.g., 706a, 706b/c in FIG. 7; 1116 in FIG. 11; 1315 in FIG. 13; 1411 in FIG. 14), and to transmit or provide, which may be received by the render server 905 for utilization in rendering (at 918) (e.g., 1118 in FIG. 11; 1418 in FIG. 14; 1524 in FIG. 15), the user data 916 (e.g., 706a, 706b/c in FIG. 7; 1116 in FIG. 11; 1315 in FIG. 13; 1411 in FIG. 14) rather than transmitting or providing the user data 916 (e.g., 706a, 706b/c in FIG. 7; 1116 in FIG. 11; 1315 in FIG. 13; 1411 in FIG. 14) of the UE 903a and/or the UE 903b to the UE 902 for utilization in rendering (at 918) (e.g., 1118 in FIG. 11; 1418 in FIG. 14; 1524 in FIG. 15) the viewport 920 (e.g., 1120 in FIG. 11; 1524 in FIG. 15). The render server 905 may be configured to transmit or provide the viewport 920 (e.g., 1120 in FIG. 11; 1524 in FIG. 15) (rendered at (918) (e.g., 1118 in FIG. 11; 1418 in FIG. 14; 1524 in FIG. 15)) to the UE 902. In aspects for which the first network entity is the render server 905 and the second network entity is the UE 902, the render server 905 may be configured to receive the offload indication 906b (e.g., 1108 in FIG. 11; 1210 in FIG. 12; 1308 in FIG. 13; 1408 in FIG. 14; 1518 in FIG. 15) of the rendering offload request (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15), including to receive, from the UE 902, the viewport information 914 (e.g., 1114 in FIG. 11; 1506a-d in FIG. 15) associated with the rendering offload request (e.g., 1106 in FIG. 11; 1208 in FIG. 12; 1406 in FIG. 14) (e.g., 1106 in FIG. 11; 1208 in FIG. 12; at 1306 in FIG. 13; 1406 in FIG. 14; 1510 in FIG. 15) and the offload rendering operation (e.g., 1118 in FIG. 11; 1418 in FIG. 14; 1524 in FIG. 15) of the multi-media content (e.g., user data, common scene, viewport in FIGS. 7-19) for the UE 902. In such aspects, the render server 905 may be configured to render (at 918) (e.g., 1118 in FIG. 11; 1418 in FIG. 14; 1524 in FIG. 15) the viewport 920 (e.g., 1120 in FIG. 11; 1524 in FIG. 15) based on the viewport information 914 (e.g., 1114 in FIG. 11; 1506a-d in FIG. 15) and an offload notification acknowledgement (e.g., 1518 in FIG. 15) (e.g., with the offload indication response 908b (e.g., 1110 in FIG. 11; 1212 in FIG. 12; 1310 in FIG. 13; 1410, 1416 in FIG. 14; 1514 in FIG. 15)), and to transmit, to the UE 902, the viewport 920 (e.g., 1120 in FIG. 11; 1524 in FIG. 15).

At 2318, the first network entity transmits, for the UE, the viewport. As an example, the transmission may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 transmitting such a rendered viewport (e.g., for the UE 902).

In such aspects, the render server 905 may be configured to render (at 918) (e.g., 1118 in FIG. 11; 1418 in FIG. 14; 1524 in FIG. 15) the viewport 920 (e.g., 1120 in FIG. 11; 1524 in FIG. 15) based on the viewport information 914 (e.g., 1114 in FIG. 11; 1506a-d in FIG. 15) and an offload notification acknowledgement (e.g., 1518 in FIG. 15) (e.g., with the offload indication response 908b (e.g., 1110 in FIG. 11; 1212 in FIG. 12; 1310 in FIG. 13; 1410, 1416 in FIG. 14; 1514 in FIG. 15)), and to transmit, to the UE 902, the viewport 920 (e.g., 1120 in FIG. 11; 1524 in FIG. 15).

At 2320, it is determined if the offload rendering is canceled by the render server. As an example, the determination may be performed by one or more of the component 199, the transceiver(s) 2746 and/or the antenna 2780 in FIG. 27, the network interface 2880 in FIG. 28. If so, flowchart 2300 may continue to 2322; if not, flowchart 2300 may continue to 2324.

At 2322, the first network entity transmits, to at least one of the second network entity or the third network entity, a second offload cancelation indication. As an example, the transmission may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 transmitting such a cancelation indication.

The render server 905 may be configured to transmit the second offload cancelation indication (e.g., 1716a, 1716b in FIG. 17; 1816a, 1816b in FIG. 18; 1916a, 1916b in FIG. 19) subsequent to obtainment of an offload cancelation request (e.g., 1912 in FIG. 19) associated with at least one of a UE 902 request or a determination (e.g., at 1810 in FIG. 18) of a cancelation condition at the first network entity (e.g., the render server 905).

At 2324, the first network entity receives, from the third network entity and subsequent to transmission of the offload indication response, a first offload cancelation indication, and transmits, to the third network entity based on the first offload cancelation indication, an offload cancelation acknowledgement. As an example, the reception and transmission may be performed by one or more of the component 199, the transceiver(s) 2746 and/or the antenna 2780 in FIG. 27, the network interface 2880 in FIG. 28. FIG. 9 illustrates, in the context of FIGS. 11-19, an example of the render server 905 receiving such a cancelation indication and transmitting such an acknowledgment.

The render server 905 may be configured (i) to receive, from the third network entity (e.g., the host server 904) and subsequent to transmission of the offload indication response (e.g., 1212 in FIG. 12; 1410 in FIG. 14), a first offload cancelation indication (e.g., 1614 in FIG. 16; 1712 in FIG. 17), and transmit, to the third network entity based on the first offload cancelation indication (e.g., 1614 in FIG. 16), an offload cancelation acknowledgement (e.g., 1616a, 1616b in FIG. 16) and/or (ii) to transmit, to at least one of the second network entity or the third network entity (e.g., the UE 902 and/or the host server 904), a second offload cancelation indication (e.g., 1716a, 1716b in FIG. 17; 1816a, 1816b in FIG. 18; 1916a, 1916b in FIG. 19).

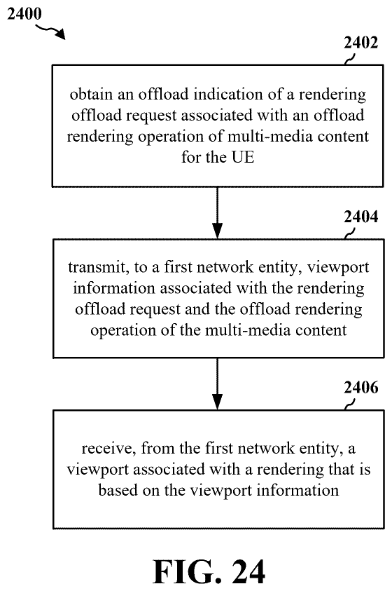

FIG. 24 is a flowchart 2400 of a method of wireless communication. The method may be performed by a wireless device or a UE (e.g., the UE 104, 702a, 802, 902, 1002, 1202, 1202, 1302, 1402, 1502, 1602, 1702, 1802, 1902; the apparatus 2604). The method may be for dynamic rendering offload for multi-media communications. The method may enable a device in a communications session, via a host server, to offload the rendering of viewports to a render server, may enable signaling for dynamic rendering offloads in both SFU and MCU architectures and provide for dynamic rendering offloads to be initiated and/or canceled by a device, by a render server, or by a host server, and may further enable handling of conditions for changes to radio links in communication sessions, numbers of users in communication sessions, device processing power utilization, user preferences, and/or the like.

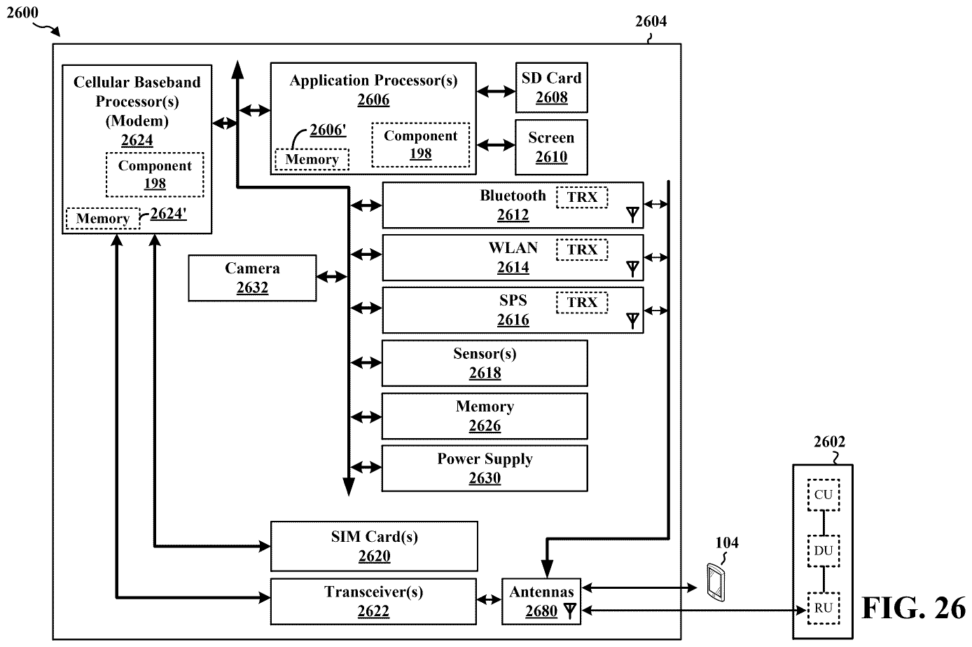

At 2402, the UE obtains an offload indication of a rendering offload request associated with an offload rendering operation of multi-media content for the UE. As an example, the obtainment may be performed by one or more of the component 198, the transceiver(s) 2622, and/or the antenna 2680 in FIG. 26. FIG. 10 illustrates, in the context of FIGS. 11-19, an example of the UE 1002 obtaining such an offload indication.

The UE 1002 may be configured to obtain (at 1006) (e.g., 1314 in FIG. 13; at 1508 in FIG. 15) an offload indication 1007 of a rendering offload request 1008 (e.g., 1106 in FIG. 11; 1208 in FIG. 12; at 1306 in FIG. 13; 1406 in FIG. 14; 1510 in FIG. 15) associated with an offload rendering operation (e.g., 1118 in FIG. 11; 1418 in FIG. 14; 1524 in FIG. 15) of multi-media content (e.g., user data, common scene, viewport in FIGS. 7-19) for the UE 1002. In aspects, to obtain (at 1006) (e.g., 1314 in FIG. 13; at 1508 in FIG. 15) the offload indication 1007 of the rendering offload request 1008 (e.g., 1106 in FIG. 11; 1208 in FIG. 12; at 1306 in FIG. 13; 1406 in FIG. 14; 1510 in FIG. 15), the UE 1002 may be configured to at least one of determine or obtain (e.g., at 1508 in FIG. 15) an offload condition at the UE 1002 and/or to receive, from a second network entity (e.g., the host server 1004) via first out-of-band signaling (e.g., 708, 710 in FIG. 7), the offload indication 1007 (e.g., 1314 in FIG. 13) of the rendering offload request 1008 (e.g., 1106 in FIG. 11; 1208 in FIG. 12; at 1306 in FIG. 13; 1406 in FIG. 14; 1510 in FIG. 15). In aspects, the host server 1004 may receive the user data (e.g., 706a, 706b/c in FIG. 7; 1116 in FIG. 11; 1315 in FIG. 13; 1411 in FIG. 14) for forwarding to other UEs and/or for rendering common scenes (e.g., 1516, 1520 in FIG. 15) of a multi-media communication session between the UEs.

At 2404, the UE transmits, to a first network entity, viewport information associated with the rendering offload request and the offload rendering operation of the multi-media content. As an example, the transmission may be performed by one or more of the component 198, the transceiver(s) 2622, and/or the antenna 2680 in FIG. 26. FIG. 10 illustrates, in the context of FIGS. 11-19, an example of the UE 1002 transmitting such a rendering offload request to a network entity (e.g., the host server 1004; the render server 1005).

In some aspects, the UE 1002 may be configured to transmit, to the second network entity (e.g., the host server 1004) via second out-of-band signaling (e.g., 708, 710 in FIG. 7) and based on the determined offload condition (e.g., at 1508 in FIG. 15), the rendering offload request 1008 (e.g., 1106 in FIG. 11; 1208 in FIG. 12; at 1306 in FIG. 13; 1406 in FIG. 14; 1510 in FIG. 15) associated with the offload rendering operation (e.g., 1118 in FIG. 11; 1418 in FIG. 14; 1524 in FIG. 15) of the multi-media content (e.g., user data, common scene, viewport in FIGS. 7-19). In such aspects, the UE 1002 may be configured to receive, from the second network entity, a response indication (e.g., 1112 in FIG. 11; 1214 in FIG. 12; 1314 in FIG. 13; 1412 in FIG. 14; 1514 in FIG. 15) associated with an offload indication response (e.g., 1110 in FIG. 11; 1212 in FIG. 12; 1310 in FIG. 13; 1410, 1416 in FIG. 14). The offload indication response (e.g., 1110 in FIG. 11; 1212 in FIG. 12; 1310 in FIG. 13; 1410, 1416 in FIG. 14) may be an offload acknowledgement indicative of an acceptance of the rendering offload request 1008 (e.g., 1106 in FIG. 11; 1208 in FIG. 12; at 1306 in FIG. 13; 1406 in FIG. 14; 1510 in FIG. 15), and the UE 1002 may be configured to transmit, to the first network entity (e.g., the render server 1005), the viewport information 1012 (e.g., 1114 in FIG. 11; 1506a-d in FIG. 15), the UE 1002 may be configured to transmit the viewport information 1012 (e.g., 1114 in FIG. 11; 1506a-d in FIG. 15) based on the offload acknowledgement indicative of the acceptance of the rendering offload request via the offload indication 808 (e.g., 1108 in FIG. 11; 1210 in FIG. 12; 1308 in FIG. 13; 1408 in FIG. 14; 1518 in FIG. 15). In aspects, state information associated with a session of the multi-media communications may comprise the viewport information 1012 (e.g., 1114 in FIG. 11; 1506a-d in FIG. 15).

The UE 1003a and/or the UE 1003b may be configured to transmit, to the second network entity (e.g., the host server 1004), respective instances of user data 1014 (e.g., 706a, 706b/c in FIG. 7; 1116 in FIG. 11; 1315 in FIG. 13; 1411 in FIG. 14), and the host server 1004 may be configured to transmit or provide the user data 1014 (e.g., 706a, 706b/c in FIG. 7; 1116 in FIG. 11; 1315 in FIG. 13; 1411 in FIG. 14) to the render server 1005 (e.g., the first network entity) for the offload rendering operation (e.g., 1118 in FIG. 11; 1418 in FIG. 14; 1524 in FIG. 15) of the multi-media content (e.g., user data, common scene, viewport in FIGS. 7-19) (e.g., rendering (at 1016) (e.g., 1118 in FIG. 11; 1418 in FIG. 14; 1524 in FIG. 15) of the viewport 1018 (e.g., 1120 in FIG. 11; 1524 in FIG. 15)). That is, rather than provide the user data 1014 (e.g., 706a, 706b/c in FIG. 7; 1116 in FIG. 11; 1315 in FIG. 13; 1411 in FIG. 14) of the UE 1003a and/or the UE 1003b to the UE 1002, the host server 1004 may provide the user data 1014 (e.g., 706a, 706b/c in FIG. 7; 1116 in FIG. 11; 1315 in FIG. 13; 1411 in FIG. 14) to the render server 1005 in accordance with the offload rendering (e.g., 1118 in FIG. 11; 1418 in FIG. 14; 1524 in FIG. 15).

At 2406, the UE receives, from the first network entity, a viewport associated with a rendering that is based on the viewport information. As an example, the reception may be performed by one or more of the component 198, the transceiver(s) 2622, and/or the antenna 2680 in FIG. 26. FIG. 10 illustrates, in the context of FIGS. 11-19, an example of the UE 1002 receiving such a viewport from a network entity (e.g., the render server 1005).

The UE 1002 may be configured to receive, from the first network entity (e.g., the render server 1005), a viewport 1018 (e.g., 1120 in FIG. 11; 1524 in FIG. 15) associated with a rendering (at 1016) (e.g., 1118 in FIG. 11; 1418 in FIG. 14; 1524 in FIG. 15) that is based on the viewport information 1012 (e.g., 1114 in FIG. 11; 1506a-d in FIG. 15). In aspects, the UE 1002 may be configured to display the viewport 1018 (e.g., 1120 in FIG. 11; 1524 in FIG. 15) that was rendered (at 1016) (e.g., 1118 in FIG. 11; 1418 in FIG. 14; 1524 in FIG. 15) by the render server 1005.

In aspects, the UE 1002 may be configured to transmit, to the first network entity (e.g., the render server 1005) via first out-of-band signaling (e.g., 708, 710 in FIG. 7) (e.g., accompanying viewport information (e.g., 1114 in FIG. 11; 1506a-d in FIG. 15)) and subsequent to reception of the viewport 1018 (e.g., 1120 in FIG. 11; 1524 in FIG. 15), a first offload cancelation indication (e.g., 1912 in FIG. 19), and to receive, from the first network entity via second out-of-band signaling (e.g., 708, 710 in FIG. 7) (e.g., accompanying a viewport 1018 (e.g., 1120 in FIG. 11; 1524 in FIG. 15)) and based on the first offload cancelation indication (e.g., 1912 in FIG. 19), an offload cancelation acknowledgement (e.g., 1916b in FIG. 19). To transmit the first offload cancelation indication (e.g., 1912 in FIG. 19), the UE 1002 may be configured to obtain an offload cancelation request (e.g., 1912 in FIG. 19) associated with a determination (e.g., at 1910 in FIG. 19) of a cancelation condition at the UE 1002, in aspects, while in some aspects, the UE 1002 may be configured to cease transmissions of further viewport information (e.g., subsequent to the viewport information 1012 (e.g., 1114 in FIG. 11; 1506a-d in FIG. 15)) based on at least one of the first offload cancelation indication (e.g., 1912 in FIG. 19) or a second offload cancelation indication (e.g., 1716a, 1716b in FIG. 17; 1816a, 1816b in FIG. 18; 1916a, 1916b in FIG. 19). In some aspects, the UE 1002 may be configured to receive, from the first network entity, the second offload cancelation indication (e.g., 1716a, 1716b in FIG. 17; 1816a, 1816b in FIG. 18; 1916a, 1916b in FIG. 19) (e.g., from the host server 1004 or from the render server 1005 via out-of-band signaling (e.g., 708, 710 in FIG. 7), such as with user data (e.g., 706a, 706b/c in FIG. 7; 1116 in FIG. 11; 1315 in FIG. 13; 1411 in FIG. 14) or with a common scene (e.g., 1516, 1520 in FIG. 15)).

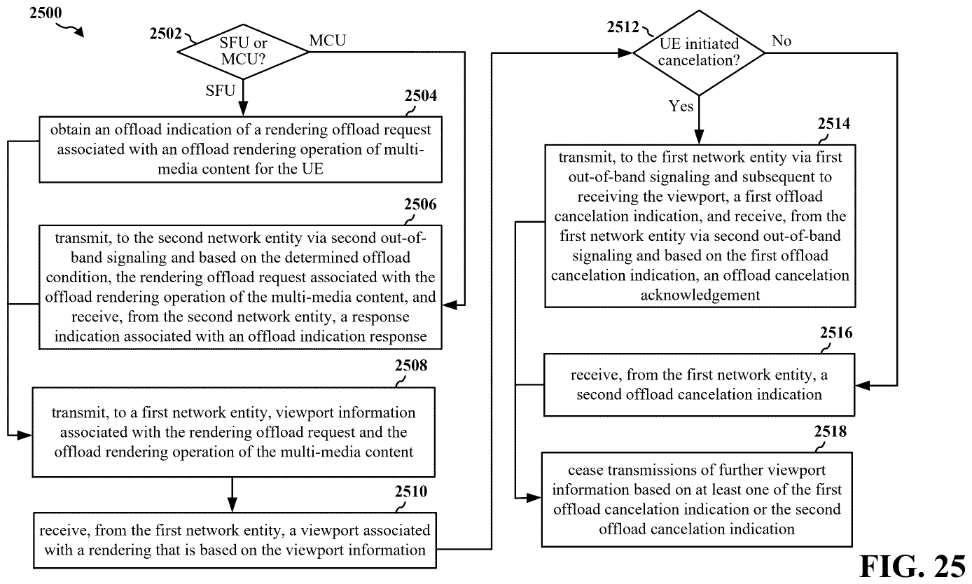

FIG. 25 is a flowchart 2500 of a method of wireless communication. The method may be performed by a wireless device or a UE (e.g., the UE 104, 702a, 802, 902, 1002, 1202, 1202, 1302, 1402, 1502, 1602, 1702, 1802, 1902; the apparatus 2604). The method may be for dynamic rendering offload for multi-media communications. The method may enable a device in a communications session, via a host server, to offload the rendering of viewports to a render server, may enable signaling for dynamic rendering offloads in both SFU and MCU architectures and provide for dynamic rendering offloads to be initiated and/or canceled by a device, by a render server, or by a host server, and may further enable handling of conditions for changes to radio links in communication sessions, numbers of users in communication sessions, device processing power utilization, user preferences, and/or the like.

At 2502, it is determined if flowchart 2500 is in the context of an SFU or an MCU architecture. As an example, the obtainment may be performed by one or more of the component 198, the transceiver(s) 2622, and/or the antenna 2680 in FIG. 26. If SFU, flowchart 2500 may continue to 2504; if MCU, flowchart 2500 may continue to 2506.

At 2504, the UE obtains an offload indication of a rendering offload request associated with an offload rendering operation of multi-media content for the UE. As an example, the obtainment may be performed by one or more of the component 198, the transceiver(s) 2622, and/or the antenna 2680 in FIG. 26. FIG. 10 illustrates, in the context of FIGS. 11-19, an example of the UE 1002 obtaining such an offload indication.

The UE 1002 may be configured to obtain (at 1006) (e.g., 1314 in FIG. 13; at 1508 in FIG. 15) an offload indication 1007 of a rendering offload request 1008 (e.g., 1106 in FIG. 11; 1208 in FIG. 12; at 1306 in FIG. 13; 1406 in FIG. 14; 1510 in FIG. 15) associated with an offload rendering operation (e.g., 1118 in FIG. 11; 1418 in FIG. 14; 1524 in FIG. 15) of multi-media content (e.g., user data, common scene, viewport in FIGS. 7-19) for the UE 1002. In aspects, to obtain (at 1006) (e.g., 1314 in FIG. 13; at 1508 in FIG. 15) the offload indication 1007 of the rendering offload request 1008 (e.g., 1106 in FIG. 11; 1208 in FIG. 12; at 1306 in FIG. 13; 1406 in FIG. 14; 1510 in FIG. 15), the UE 1002 may be configured to at least one of determine or obtain (e.g., at 1508 in FIG. 15) an offload condition at the UE 1002 and/or to receive, from a second network entity (e.g., the host server 1004) via first out-of-band signaling (e.g., 708, 710 in FIG. 7), the offload indication 1007 (e.g., 1314 in FIG. 13) of the rendering offload request 1008 (e.g., 1106 in FIG. 11; 1208 in FIG. 12; at 1306 in FIG. 13; 1406 in FIG. 14; 1510 in FIG. 15). In aspects, the host server 1004 may receive the user data (e.g., 706a, 706b/c in FIG. 7; 1116 in FIG. 11; 1315 in FIG. 13; 1411 in FIG. 14) for forwarding to other UEs and/or for rendering common scenes (e.g., 1516, 1520 in FIG. 15) of a multi-media communication session between the UEs.

At 2506, the UE transmits, to the second network entity via second out-of-band signaling and based on the determined offload condition, the rendering offload request associated with the offload rendering operation of the multi-media content, and receives, from the second network entity, a response indication associated with an offload indication response. As an example, the transmission and reception may be performed by one or more of the component 198, the transceiver(s) 2622, and/or the antenna 2680 in FIG. 26. FIG. 10 illustrates, in the context of FIGS. 11-19, an example of the UE 1002 transmitting such a rendering offload request to a network entity (e.g., the host server 1004; the render server 1005) and receiving such a response indication from the network entity (e.g., the host server 1004; the render server 1005).

In some aspects, the UE 1002 may be configured to transmit, to the second network entity (e.g., the host server 1004) via second out-of-band signaling (e.g., 708, 710 in FIG. 7) and based on the determined offload condition (e.g., at 1508 in FIG. 15), the rendering offload request 1008 (e.g., 1106 in FIG. 11; 1208 in FIG. 12; at 1306 in FIG. 13; 1406 in FIG. 14; 1510 in FIG. 15) associated with the offload rendering operation (e.g., 1118 in FIG. 11; 1418 in FIG. 14; 1524 in FIG. 15) of the multi-media content (e.g., user data, common scene, viewport in FIGS. 7-19). In such aspects, the UE 1002 may be configured to receive, from the second network entity, a response indication (e.g., 1112 in FIG. 11; 1214 in FIG. 12; 1314 in FIG. 13; 1412 in FIG. 14; 1514 in FIG. 15) associated with an offload indication response (e.g., 1110 in FIG. 11; 1212 in FIG. 12; 1310 in FIG. 13; 1410, 1416 in FIG. 14). The offload indication response (e.g., 1110 in FIG. 11; 1212 in FIG. 12; 1310 in FIG. 13; 1410, 1416 in FIG. 14) may be an offload acknowledgement indicative of an acceptance of the rendering offload request 1008 (e.g., 1106 in FIG. 11; 1208 in FIG. 12; at 1306 in FIG. 13; 1406 in FIG. 14; 1510 in FIG. 15).

At 2508, the UE transmits, to a first network entity, viewport information associated with the rendering offload request and the offload rendering operation of the multi-media content. As an example, the transmission may be performed by one or more of the component 198, the transceiver(s) 2622, and/or the antenna 2680 in FIG. 26. FIG. 10 illustrates, in the context of FIGS. 11-19, an example of the UE 1002 transmitting such a rendering offload request to a network entity (e.g., the host server 1004; the render server 1005).

In some aspects, the UE 1002 may be configured to transmit, to the first network entity (e.g., the render server 1005), the viewport information 1012 (e.g., 1114 in FIG. 11; 1506a-d in FIG. 15), the UE 1002 may be configured to transmit the viewport information 1012 (e.g., 1114 in FIG. 11; 1506a-d in FIG. 15) based on the offload acknowledgement indicative of the acceptance of the rendering offload request via the offload indication 808 (e.g., 1108 in FIG. 11; 1210 in FIG. 12; 1308 in FIG. 13; 1408 in FIG. 14; 1518 in FIG. 15). In aspects, state information associated with a session of the multi-media communications may comprise the viewport information 1012 (e.g., 1114 in FIG. 11; 1506a-d in FIG. 15).

The UE 1003a and/or the UE 1003b may be configured to transmit, to the second network entity (e.g., the host server 1004), respective instances of user data 1014 (e.g., 706a, 706b/c in FIG. 7; 1116 in FIG. 11; 1315 in FIG. 13; 1411 in FIG. 14), and the host server 1004 may be configured to transmit or provide the user data 1014 (e.g., 706a, 706b/c in FIG. 7; 1116 in FIG. 11; 1315 in FIG. 13; 1411 in FIG. 14) to the render server 1005 (e.g., the first network entity) for the offload rendering operation (e.g., 1118 in FIG. 11; 1418 in FIG. 14; 1524 in FIG. 15) of the multi-media content (e.g., user data, common scene, viewport in FIGS. 7-19) (e.g., rendering (at 1016) (e.g., 1118 in FIG. 11; 1418 in FIG. 14; 1524 in FIG. 15) of the viewport 1018 (e.g., 1120 in FIG. 11; 1524 in FIG. 15)). That is, rather than provide the user data 1014 (e.g., 706a, 706b/c in FIG. 7; 1116 in FIG. 11; 1315 in FIG. 13; 1411 in FIG. 14) of the UE 1003a and/or the UE 1003b to the UE 1002, the host server 1004 may provide the user data 1014 (e.g., 706a, 706b/c in FIG. 7; 1116 in FIG. 11; 1315 in FIG. 13; 1411 in FIG. 14) to the render server 1005 in accordance with the offload rendering (e.g., 1118 in FIG. 11; 1418 in FIG. 14; 1524 in FIG. 15).

At 2510, the UE receives, from the first network entity, a viewport associated with a rendering that is based on the viewport information. As an example, the reception may be performed by one or more of the component 198, the transceiver(s) 2622, and/or the antenna 2680 in FIG. 26. FIG. 10 illustrates, in the context of FIGS. 11-19, an example of the UE 1002 receiving such a viewport from a network entity (e.g., the render server 1005).

The UE 1002 may be configured to receive, from the first network entity (e.g., the render server 1005), a viewport 1018 (e.g., 1120 in FIG. 11; 1524 in FIG. 15) associated with a rendering (at 1016) (e.g., 1118 in FIG. 11; 1418 in FIG. 14; 1524 in FIG. 15) that is based on the viewport information 1012 (e.g., 1114 in FIG. 11; 1506a-d in FIG. 15). In aspects, the UE 1002 may be configured to display the viewport 1018 (e.g., 1120 in FIG. 11; 1524 in FIG. 15) that was rendered (at 1016) (e.g., 1118 in FIG. 11; 1418 in FIG. 14; 1524 in FIG. 15) by the render server 1005.

At 2512, it is determined if cancelation of the offload rendering is initiated by the UE. As an example, the determination may be performed by one or more of the component 198, the transceiver(s) 2622, and/or the antenna 2680 in FIG. 26. If so, flowchart 2500 may continue to 2514; if not, flowchart 2500 may continue to 2516.

At 2514, the UE transmits, to the first network entity via first out-of-band signaling and subsequent to receiving the viewport, a first offload cancelation indication, and receives, from the first network entity via second out-of-band signaling and based on the first offload cancelation indication, an offload cancelation acknowledgement. As an example, the transmission and reception may be performed by one or more of the component 198, the transceiver(s) 2622, and/or the antenna 2680 in FIG. 26. FIG. 10 illustrates, in the context of FIGS. 11-19, an example of the UE 1002 transmitting such a offload cancelation indication to a network entity (e.g., the host server 1004; the render server 1005) and receiving such a offload cancelation indication from the network entity (e.g., the host server 1004; the render server 1005).

In aspects, the UE 1002 may be configured to transmit, to the first network entity (e.g., the render server 1005) via first out-of-band signaling (e.g., 708, 710 in FIG. 7) (e.g., accompanying viewport information (e.g., 1114 in FIG. 11; 1506a-d in FIG. 15)) and subsequent to reception of the viewport 1018 (e.g., 1120 in FIG. 11; 1524 in FIG. 15), a first offload cancelation indication (e.g., 1912 in FIG. 19), and to receive, from the first network entity via second out-of-band signaling (e.g., 708, 710 in FIG. 7) (e.g., accompanying a viewport 1018 (e.g., 1120 in FIG. 11; 1524 in FIG. 15)) and based on the first offload cancelation indication (e.g., 1912 in FIG. 19), an offload cancelation acknowledgement (e.g., 1916b in FIG. 19). To transmit the first offload cancelation indication (e.g., 1912 in FIG. 19), the UE 1002 may be configured to obtain an offload cancelation request (e.g., 1912 in FIG. 19) associated with a determination (e.g., at 1910 in FIG. 19) of a cancelation condition at the UE 1002, in aspects.

At 2516, the UE receives, from the first network entity, a second offload cancelation indication. As an example, the reception may be performed by one or more of the component 198, the transceiver(s) 2622, and/or the antenna 2680 in FIG. 26. FIG. 10 illustrates, in the context of FIGS. 11-19, an example of the UE 1002 receiving such a offload cancelation indication from the network entity.

In some aspects, the UE 1002 may be configured to receive, from the first network entity, the second offload cancelation indication (e.g., 1716a, 1716b in FIG. 17; 1816a, 1816b in FIG. 18; 1916a, 1916b in FIG. 19) (e.g., from the host server 1004 or from the render server 1005 via out-of-band signaling (e.g., 708, 710 in FIG. 7), such as with user data (e.g., 706a, 706b/c in FIG. 7; 1116 in FIG. 11; 1315 in FIG. 13; 1411 in FIG. 14) or with a common scene (e.g., 1516, 1520 in FIG. 15))

At 2518, the UE ceases transmissions of further viewport information based on at least one of the first offload cancelation indication or the second offload cancelation indication. As an example, the cessation may be performed by one or more of the component 198, the transceiver(s) 2622, and/or the antenna 2680 in FIG. 26. FIG. 10 illustrates, in the context of FIGS. 11-19, an example of the UE 1002 ceasing such transmissions.

In some aspects, the UE 1002 may be configured to cease transmissions of further viewport information (e.g., subsequent to the viewport information 1012 (e.g., 1114 in FIG. 11; 1506a-d in FIG. 15)) based on at least one of the first offload cancelation indication (e.g., 1912 in FIG. 19) or a second offload cancelation indication (e.g., 1716a, 1716b in FIG. 17; 1816a, 1816b in FIG. 18; 1916a, 1916b in FIG. 19).

FIG. 26 is a diagram 2600 illustrating an example of a hardware implementation for an apparatus 2604. The apparatus 2604 may be a UE, a component of a UE, or may implement UE functionality. In some aspects, the apparatus 2604 may include at least one cellular baseband processor 2624 (also referred to as a modem) coupled to one or more transceivers 2622 (e.g., cellular RF transceiver). The cellular baseband processor(s) 2624 may include at least one on-chip memory 2624′. In some aspects, the apparatus 2604 may further include one or more subscriber identity modules (SIM) cards 2620 and at least one application processor 2606 coupled to a secure digital (SD) card 2608 and a screen 2610. The application processor(s) 2606 may include on-chip memory 2606′. In some aspects, the apparatus 2604 may further include a Bluetooth module 2612, a WLAN module 2614, an SPS module 2616 (e.g., GNSS module), one or more sensor modules 2618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2626, a power supply 2630, and/or a camera 2632. The Bluetooth module 2612, the WLAN module 2614, and the SPS module 2616 may include an on-chip transceiver (TRX) (or in some cases, just a receiver (RX)). The Bluetooth module 2612, the WLAN module 2614, and the SPS module 2616 may include their own dedicated antennas and/or utilize the antennas 2680 for communication. The cellular baseband processor(s) 2624 communicates through the transceiver(s) 2622 via one or more antennas 2680 with the UE 104 and/or with an RU associated with a network entity 2602. The cellular baseband processor(s) 2624 and the application processor(s) 2606 may each include a computer-readable medium/memory 2624′, 2606′, respectively. The additional memory modules 2626 may also be considered a computer-readable medium/memory. Each computer-readable medium/memory 2624′, 2606′, 2626 may be non-transitory. The cellular baseband processor(s) 2624 and the application processor(s) 2606 are each responsible for general processing, including the execution of software stored on the computer-readable medium/memory. The software, when executed by the cellular baseband processor(s) 2624/application processor(s) 2606, causes the cellular baseband processor(s) 2624/application processor(s) 2606 to perform the various functions described supra. The cellular baseband processor(s) 2624 and the application processor(s) 2606 are configured to perform the various functions described supra based at least in part of the information stored in the memory. That is, the cellular baseband processor(s) 2624 and the application processor(s) 2606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2624/application processor(s) 2606 when executing software. The cellular baseband processor(s) 2624/application processor(s) 2606 may be a component of the UE 350 and may include the at least one memory 360 and/or at least one of the TX processor 368, the RX processor 356, and the controller/processor 359. In one configuration, the apparatus 2604 may be at least one processor chip (modem and/or application) and include just the cellular baseband processor(s) 2624 and/or the application processor(s) 2606, and in another configuration, the apparatus 2604 may be the entire UE (e.g., see UE 350 of FIG. 3) and include the additional modules of the apparatus 2604.

As discussed supra, the component 198 may be configured to obtain an offload indication of a rendering offload request associated with an offload rendering operation of multi-media content for the UE. The component 198 may be configured to transmit, to a first network entity via first out-of-band signaling, viewport information associated with the rendering offload request and the offload rendering operation of the multi-media content. The component 198 may be configured to receive, from the first network entity, a viewport associated with a rendering that is based on the viewport information. The component 198 may be configured to transmit, to the second network entity via second out-of-band signaling and based on the determined offload condition, the rendering offload request associated with the offload rendering operation of the multi-media content. The component 198 may be configured to receive, from the second network entity, a response indication associated with an offload indication response. The component 198 may be configured to transmit, to the first network entity via first out-of-band signaling and subsequent to reception of the viewport, a first offload cancelation indication, and receive, from the first network entity via second out-of-band signaling and based on the first offload cancelation indication, an offload cancelation acknowledgement. The component 198 may be configured to receive, from the first network entity, a second offload cancelation indication. The component 198 may be configured to cease transmissions of further viewport information based on at least one of the first offload cancelation indication or the second offload cancelation indication. The component 198 may be further configured to perform any of the aspects described in connection with the flowcharts in any of FIGS. 20-25, and/or any of the aspects performed by a device and/or a UE for any of FIGS. 4-19. The component 198 may be within the cellular baseband processor(s) 2624, the application processor(s) 2606, or both the cellular baseband processor(s) 2624 and the application processor(s) 2606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2604 may include a variety of components configured for various functions. In one configuration, the apparatus 2604, and in particular the cellular baseband processor(s) 2624 and/or the application processor(s) 2606, may include means for obtaining an offload indication of a rendering offload request associated with an offload rendering operation of multi-media content for the UE. In one configuration, the apparatus 2604, and in particular the cellular baseband processor(s) 2624 and/or the application processor(s) 2606, may include means for transmitting, to a first network entity via first out-of-band signaling, viewport information associated with the rendering offload request and the offload rendering operation of the multi-media content. In one configuration, the apparatus 2604, and in particular the cellular baseband processor(s) 2624 and/or the application processor(s) 2606, may include means for receiving, from the first network entity, a viewport associated with a rendering that is based on the viewport information. In one configuration, the apparatus 2604, and in particular the cellular baseband processor(s) 2624 and/or the application processor(s) 2606, may include means for transmitting, to the second network entity via second out-of-band signaling and based on the determined offload condition, the rendering offload request associated with the offload rendering operation of the multi-media content. In one configuration, the apparatus 2604, and in particular the cellular baseband processor(s) 2624 and/or the application processor(s) 2606, may include means for receiving, from the second network entity, a response indication associated with an offload indication response. In one configuration, the apparatus 2604, and in particular the cellular baseband processor(s) 2624 and/or the application processor(s) 2606, may include means for transmitting, to the first network entity via first out-of-band signaling and subsequent to reception of the viewport, a first offload cancelation indication, and means for receiving, from the first network entity via second out-of-band signaling and based on the first offload cancelation indication, an offload cancelation acknowledgement. In one configuration, the apparatus 2604, and in particular the cellular baseband processor(s) 2624 and/or the application processor(s) 2606, may include means for receiving, from the first network entity, a second offload cancelation indication. In one configuration, the apparatus 2604, and in particular the cellular baseband processor(s) 2624 and/or the application processor(s) 2606, may include means for ceasing transmissions of further viewport information based on at least one of the first offload cancelation indication or the second offload cancelation indication. The means may be the component 198 of the apparatus 2604 configured to perform the functions recited by the means. As described supra, the apparatus 2604 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 27 is a diagram 2700 illustrating an example of a hardware implementation for a network entity 2702. The network entity 2702 may be a BS, a component of a BS, or may implement BS functionality. The network entity 2702 may include at least one of a CU 2710, a DU 2730, or an RU 2740. For example, depending on the layer functionality handled by the component 199, the network entity 2702 may include the CU 2710; both the CU 2710 and the DU 2730; each of the CU 2710, the DU 2730, and the RU 2740; the DU 2730; both the DU 2730 and the RU 2740; or the RU 2740. The CU 2710 may include at least one CU processor 2712. The CU processor(s) 2712 may include on-chip memory 2712′. In some aspects, the CU 2710 may further include additional memory modules 2714 and a communications interface 2718. The CU 2710 communicates with the DU 2730 through a midhaul link, such as an F1 interface. The DU 2730 may include at least one DU processor 2732. The DU processor(s) 2732 may include on-chip memory 2732′. In some aspects, the DU 2730 may further include additional memory modules 2734 and a communications interface 2738. The DU 2730 communicates with the RU 2740 through a fronthaul link. The RU 2740 may include at least one RU processor 2742. The RU processor(s) 2742 may include on-chip memory 2742′. In some aspects, the RU 2740 may further include additional memory modules 2744, one or more transceivers 2746, antennas 2780, and a communications interface 2748. The RU 2740 communicates with the UE 104. The on-chip memory 2712′, 2732′, 2742′ and the additional memory modules 2714, 2734, 2744 may each be considered a computer-readable medium/memory. Each computer-readable medium/memory may be non-transitory. Each of the processors 2712, 2732, 2742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, to a second network entity that is different from the first network entity, an offload indication of a rendering offload request associated with an offload rendering operation of multi-media content for a UE. The component 199 may also be configured to receive, from the second network entity, an offload indication response based on the offload indication. The component 199 may also be configured to receive, from the UE via first out-of-band signaling, the rendering offload request associated with the offload rendering operation of the multi-media content. The component 199 may also be configured to transmit, to the UE, a response indication associated with the offload indication response. The component 199 may also be configured to transmit, to the second network entity, information of at least one additional UE that is associated with the offload rendering operation of the multi-media content. The component 199 may also be configured to transmit, to the UE via out-of-band signaling, an offload notification that is associated with the offload indication response and that is indicative of transmission of the offload indication of the rendering offload request. The component 199 may also be configured to transmit, to the second network entity and subsequent to reception of the offload indication response, a first offload cancelation indication, and receive, from the second network entity based on the first offload cancelation indication, an offload cancelation acknowledgement. The component 199 may also be configured to receive, from the second network entity, a second offload cancelation indication. The component 199 may be configured to receive, from a second network entity that is different from the first network entity, an offload indication of a rendering offload request associated with an offload rendering operation of multi-media content for a UE. The component 199 may also be configured to transmit, to a third network entity that is different from the first network entity, an offload indication response based on the offload indication. The component 199 may also be configured to obtain, subsequent to transmission of the offload indication response, a rendering availability indication indicative of an absence of the rendering overload. The component 199 may also be configured to transmit, to the second network entity and based on the rendering availability indication, an offload availability indication indicative of an availability at the first network entity for offload rendering. The component 199 may also be configured to render a viewport based on the viewport information and an offload notification acknowledgement. The component 199 may also be configured to transmit, for the UE, the viewport. The component 199 may also be configured to receive, from the host server, the offload notification acknowledgement subsequent to transmission of the offload notification. The component 199 may also be configured to receive, from the third network entity, information of at least one additional UE that is associated with the offload rendering operation of the multi-media content. The component 199 may also be configured to receive, from the third network entity and subsequent to transmission of the offload indication response, a first offload cancelation indication, and transmit, to the third network entity based on the first offload cancelation indication, an offload cancelation acknowledgement. The component 199 may also be configured to transmit, to at least one of the second network entity or the third network entity, a second offload cancelation indication. The component 199 may be further configured to perform any of the aspects described in connection with the flowcharts in any of FIGS. 20-25, and/or any of the aspects performed by a server and/or a network entity for any of FIGS. 4-19. The component 199 may be within one or more processors of one or more of the CU 2710, DU 2730, and the RU 2740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2702 may include a variety of components configured for various functions. In one configuration, the network entity 2702 may include means for transmitting, to a second network entity that is different from the first network entity, an offload indication of a rendering offload request associated with an offload rendering operation of multi-media content for a UE. In one configuration, the network entity 2702 may include means for receiving, from the second network entity, an offload indication response based on the offload indication. In one configuration, the network entity 2702 may include means for receiving, from the UE via first out-of-band signaling, the rendering offload request associated with the offload rendering operation of the multi-media content. In one configuration, the network entity 2702 may include means for transmitting, to the UE, a response indication associated with the offload indication response. In one configuration, the network entity 2702 may include means for transmitting, to the second network entity, information of at least one additional UE that is associated with the offload rendering operation of the multi-media content. In one configuration, the network entity 2702 may include means for transmitting, to the UE via out-of-band signaling, an offload notification that is associated with the offload indication response and that is indicative of transmission of the offload indication of the rendering offload request. In one configuration, the network entity 2702 may include means for transmitting, to the second network entity and subsequent to reception of the offload indication response, a first offload cancelation indication, and means for receiving, from the second network entity based on the first offload cancelation indication, an offload cancelation acknowledgement. In one configuration, the network entity 2702 may include means for receiving, from the second network entity, a second offload cancelation indication. In one configuration, the network entity 2702 may include means for receiving from a second network entity that is different from the first network entity, an offload indication of a rendering offload request associated with an offload rendering operation of multi-media content for a UE. In one configuration, the network entity 2702 may include means for transmitting, to a third network entity that is different from the first network entity, an offload indication response based on the offload indication. In one configuration, the network entity 2702 may include means for obtaining, subsequent to transmission of the offload indication response, a rendering availability indication indicative of an absence of the rendering overload. In one configuration, the network entity 2702 may include means for transmitting, to the second network entity and based on the rendering availability indication, an offload availability indication indicative of an availability at the first network entity for offload rendering. In one configuration, the network entity 2702 may include means for rendering a viewport based on the viewport information and an offload notification acknowledgement. In one configuration, the network entity 2702 may include means for transmitting, for the UE, the viewport. In one configuration, the network entity 2702 may include means for receiving, from the host server, the offload notification acknowledgement subsequent to transmission of the offload notification. In one configuration, the network entity 2702 may include means for receiving, from the third network entity, information of at least one additional UE that is associated with the offload rendering operation of the multi-media content. In one configuration, the network entity 2702 may include means for receiving, from the third network entity and subsequent to transmission of the offload indication response, a first offload cancelation indication, and means for transmitting, to the third network entity based on the first offload cancelation indication, an offload cancelation acknowledgement. In one configuration, the network entity 2702 may include means for transmitting, to at least one of the second network entity or the third network entity, a second offload cancelation indication. The means may be the component 199 of the network entity 2702 configured to perform the functions recited by the means. As described supra, the network entity 2702 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 28 is a diagram 2800 illustrating an example of a hardware implementation for a network entity 2860. In one example, the network entity 2860 may be within the core network 120. The network entity 2860 may include at least one network processor 2812. The network processor(s) 2812 may include on-chip memory 2812′. In some aspects, the network entity 2860 may further include additional memory modules 2814. The network entity 2860 communicates via the network interface 2880 directly (e.g., backhaul link) or indirectly (e.g., through a RIC) with the CU 2802 and/or the UE 104. The on-chip memory 2812′ and the additional memory modules 2814 may each be considered a computer-readable medium/memory. Each computer-readable medium/memory may be non-transitory. The network processor(s) 2812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, to a second network entity that is different from the first network entity, an offload indication of a rendering offload request associated with an offload rendering operation of multi-media content for a UE. The component 199 may also be configured to receive, from the second network entity, an offload indication response based on the offload indication. The component 199 may also be configured to receive, from the UE via first out-of-band signaling, the rendering offload request associated with the offload rendering operation of the multi-media content. The component 199 may also be configured to transmit, to the UE, a response indication associated with the offload indication response. The component 199 may also be configured to transmit, to the second network entity, information of at least one additional UE that is associated with the offload rendering operation of the multi-media content. The component 199 may also be configured to transmit, to the UE via out-of-band signaling, an offload notification that is associated with the offload indication response and that is indicative of transmission of the offload indication of the rendering offload request. The component 199 may also be configured to transmit, to the second network entity and subsequent to reception of the offload indication response, a first offload cancelation indication, and receive, from the second network entity based on the first offload cancelation indication, an offload cancelation acknowledgement. The component 199 may also be configured to receive, from the second network entity, a second offload cancelation indication. The component 199 may be configured to receive, from a second network entity that is different from the first network entity, an offload indication of a rendering offload request associated with an offload rendering operation of multi-media content for a UE. The component 199 may also be configured to transmit, to a third network entity that is different from the first network entity, an offload indication response based on the offload indication. The component 199 may also be configured to obtain, subsequent to transmission of the offload indication response, a rendering availability indication indicative of an absence of the rendering overload. The component 199 may also be configured to transmit, to the second network entity and based on the rendering availability indication, an offload availability indication indicative of an availability at the first network entity for offload rendering. The component 199 may also be configured to render a viewport based on the viewport information and an offload notification acknowledgement. The component 199 may also be configured to transmit, for the UE, the viewport. The component 199 may also be configured to receive, from the host server, the offload notification acknowledgement subsequent to transmission of the offload notification. The component 199 may also be configured to receive, from the third network entity, information of at least one additional UE that is associated with the offload rendering operation of the multi-media content. The component 199 may also be configured to receive, from the third network entity and subsequent to transmission of the offload indication response, a first offload cancelation indication, and transmit, to the third network entity based on the first offload cancelation indication, an offload cancelation acknowledgement. The component 199 may also be configured to transmit, to at least one of the second network entity or the third network entity, a second offload cancelation indication. The component 199 may be further configured to perform any of the aspects described in connection with the flowcharts in any of FIGS. 20-25, and/or any of the aspects performed by a server and/or a network entity for any of FIGS. 4-19. The component 199 may be within the network processor(s) 2812. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2860 may include a variety of components configured for various functions. In one configuration, the network entity 2860 may include means for include means for transmitting, to a second network entity that is different from the first network entity, an offload indication of a rendering offload request associated with an offload rendering operation of multi-media content for a UE. In one configuration, the network entity 2860 may include means for receiving, from the second network entity, an offload indication response based on the offload indication. In one configuration, the network entity 2860 may include means for receiving, from the UE via first out-of-band signaling, the rendering offload request associated with the offload rendering operation of the multi-media content. In one configuration, the network entity 2860 may include means for transmitting, to the UE, a response indication associated with the offload indication response. In one configuration, the network entity 2860 may include means for transmitting, to the second network entity, information of at least one additional UE that is associated with the offload rendering operation of the multi-media content. In one configuration, the network entity 2860 may include means for transmitting, to the UE via out-of-band signaling, an offload notification that is associated with the offload indication response and that is indicative of transmission of the offload indication of the rendering offload request. In one configuration, the network entity 2860 may include means for transmitting, to the second network entity and subsequent to reception of the offload indication response, a first offload cancelation indication, and means for receiving, from the second network entity based on the first offload cancelation indication, an offload cancelation acknowledgement. In one configuration, the network entity 2860 may include means for receiving, from the second network entity, a second offload cancelation indication. In one configuration, the network entity 2860 may include means for receiving from a second network entity that is different from the first network entity, an offload indication of a rendering offload request associated with an offload rendering operation of multi-media content for a UE. In one configuration, the network entity 2860 may include means for transmitting, to a third network entity that is different from the first network entity, an offload indication response based on the offload indication. In one configuration, the network entity 2860 may include means for obtaining, subsequent to transmission of the offload indication response, a rendering availability indication indicative of an absence of the rendering overload. In one configuration, the network entity 2860 may include means for transmitting, to the second network entity and based on the rendering availability indication, an offload availability indication indicative of an availability at the first network entity for offload rendering. In one configuration, the network entity 2860 may include means for rendering a viewport based on the viewport information and an offload notification acknowledgement. In one configuration, the network entity 2860 may include means for transmitting, for the UE, the viewport. In one configuration, the network entity 2860 may include means for receiving, from the host server, the offload notification acknowledgement subsequent to transmission of the offload notification. In one configuration, the network entity 2860 may include means for receiving, from the third network entity, information of at least one additional UE that is associated with the offload rendering operation of the multi-media content. In one configuration, the network entity 2860 may include means for receiving, from the third network entity and subsequent to transmission of the offload indication response, a first offload cancelation indication, and means for transmitting, to the third network entity based on the first offload cancelation indication, an offload cancelation acknowledgement. In one configuration, the network entity 2860 may include means for transmitting, to at least one of the second network entity or the third network entity, a second offload cancelation indication. The means may be the component 199 of the network entity 2860 configured to perform the functions recited by the means.

Some wireless communication systems may provide multi-media communications (e.g., holographic communications) between UEs utilizing host servers that provide applications for such communications. Each UE participating in multi-media communication sessions may provide user data (e.g., video capture data) to a host server. In some implementations, a host server may forward the user data of other UEs to each UE such that each UE renders image content, such as a viewport, based on its own user data and user data from the other UEs. In other implementations, a host server may periodically render a common scene based on the user data of each UE and forward the rendered common scene to each UE, while each UE renders image content, such as a viewport, based on its own user data. However, adaptations to scenarios associated with radio conditions, numbers of users or UEs in multi-media sessions, device (e.g., a UE) processing power, host server and/or edge server processing power, user preferences, and/or the like, may be improved through adaptive utilization of offload rendering from a device to a render server (also a render server herein) and rendering at the device without offloading.

Aspects provide for dynamic rendering offload for multi-media communications (e.g., holographic communications). Aspects of dynamic rendering offload for multi-media communications, enable a device in a communications session, via a host server, to offload rendering of viewports to a render server. Aspects herein also enable signaling techniques for dynamic rendering offloads in both SFU and MCU architectures, and provide for dynamic rendering offloads for multi-media communications that may be initiated by a device, by a render server, or by a host server, and similarly may be canceled by a device, by a render server, or by a host server. Aspects account for changes to radio links in communication sessions, numbers of users in communication sessions, device processing power utilization, and user preferences by providing adaptive utilization of offload rendering from a device to a render server. Further, aspects account for changes to radio links in communication sessions, numbers of users in communication sessions, server (e.g., including edge server) and/or device processing power utilization, and user preferences by providing adaptive utilization of offload rendering to switch back from offloading to rendering at the device without offloading.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. A device may transmit or provide data and/or information to another device directly or indirectly, and the terms transmit or provide may be used in the context of any type of communications, e.g., wired communications, wireless communications, combinations thereof, and/or the like. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.
Aspect 1 is method of wireless communication at a first network entity, comprising: transmitting, to a second network entity that is different from the first network entity, an offload indication of a rendering offload request associated with an offload rendering operation of multi-media content for a user equipment (UE); and receiving, from the second network entity, an offload indication response based on the offload indication.
Aspect 2 is the method of aspect 1, further comprising: receiving, from the UE via first out-of-band signaling, the rendering offload request associated with the offload rendering operation of the multi-media content; and transmitting, to the UE, a response indication associated with the offload indication response.
Aspect 3 is the method of aspect 2, wherein the offload indication response is an offload rejection indicative of a denial of the rendering offload request, and wherein the response indication indicates the denial and comprises second out-of-band signaling.
Aspect 4 is the method of aspect 3, wherein at least one of the first out-of-band signaling or the second out-of-band signaling comprise information of at least one additional UE that is associated with the offload rendering operation of the multi-media content.
Aspect 5 is the method of any of aspects 1 to 4, wherein the offload indication response is an offload acknowledgement indicative of an acceptance of the rendering offload request; the method further comprising: transmitting, to the second network entity, information of at least one additional UE that is associated with the offload rendering operation of the multi-media content.
Aspect 6 is the method of any of aspects 1 to 5, wherein the offload indication response is an offload acknowledgement indicative of an acceptance of the rendering offload request; the method further comprising: transmitting, to the UE via out-of-band signaling, an offload notification that is associated with the offload indication response and that is indicative of transmission of the offload indication of the rendering offload request.
Aspect 7 is the method of any of aspects 1 to 6, further comprising at least one of: transmitting, to the second network entity and subsequent to receiving the offload indication response, a first offload cancelation indication, and receiving, from the second network entity based on the first offload cancelation indication, an offload cancelation acknowledgement; or receiving, from the second network entity, a second offload cancelation indication.
Aspect 8 is the method of aspect 7, wherein transmitting the first offload cancelation indication includes obtaining an offload cancelation request associated with at least one of a UE request or a determination of a cancelation condition at the first network entity.
Aspect 9 is a method of wireless communication at a first network entity, comprising: receiving, from a second network entity that is different from the first network entity, an offload indication of a rendering offload request associated with an offload rendering operation of multi-media content for a user equipment (UE); and transmitting, to a third network entity that is different from the first network entity, an offload indication response based on the offload indication.
Aspect 10 is the method of aspect 9, wherein the offload indication response is an offload rejection indicative of a denial of the rendering offload request based on an indication of a rendering overload; the method further comprising: obtaining, subsequent to transmission of the offload indication response, a rendering availability indication indicative of an absence of the rendering overload; and transmitting, to the second network entity and based on the rendering availability indication, an offload availability indication indicative of an availability at the first network entity for offload rendering.
Aspect 11 is the method of aspect 10, wherein the offload availability indication is further indicative of a number of rendering processes associated with the availability at the first network entity for the offload rendering.
Aspect 12 is the method of aspect 9, wherein the first network entity is a render server and the second network entity is the UE; wherein receiving the offload indication of the rendering offload request includes: receiving, from the UE, viewport information associated with the rendering offload request and the offload rendering operation of the multi-media content for the UE; the method further comprising: rendering a viewport based on the viewport information and an offload notification acknowledgement; and transmitting, for the UE, the viewport.
Aspect 13 is the method of aspect 12, wherein the third network entity is a host server, and wherein the offload indication response is an offload notification; the method further comprising: receiving, from the host server, the offload notification acknowledgement subsequent to transmission of the offload notification.
Aspect 14 is the method of any of aspects 12 and 13, further comprising: receiving, from the third network entity, information of at least one additional UE that is associated with the offload rendering operation of the multi-media content; wherein rendering the viewport is further based on the information of the at least one additional UE.
Aspect 15 is the method of any of aspects 9 to 14, further comprising at least one of: receiving, from the third network entity and subsequent to transmitting the offload indication response, a first offload cancelation indication, and transmitting, to the third network entity based on the first offload cancelation indication, an offload cancelation acknowledgement; or transmitting, to at least one of the second network entity or the third network entity, a second offload cancelation indication.
Aspect 16 is the method of aspect 15, wherein transmitting the second offload cancelation indication includes obtaining an offload cancelation request associated with at least one of a UE request or a determination of a cancelation condition at the first network entity.
Aspect 17 is a method of wireless communication at a user equipment (UE), comprising: obtaining an offload indication of a rendering offload request associated with an offload rendering operation of multi-media content for the UE; transmitting, to a first network entity via first out-of-band signaling, viewport information associated with the rendering offload request and the offload rendering operation of the multi-media content; and receiving, from the first network entity, a viewport associated with a rendering that is based on the viewport information.
Aspect 18 is the method of aspect 17, wherein obtaining the offload indication of the rendering offload request includes one of: determining an offload condition at the UE; or receiving, from a second network entity via second out-of-band signaling, the offload indication of the rendering offload request.
Aspect 19 is the method of aspect 18, further comprising: transmitting, to the second network entity via third out-of-band signaling and based on the determined offload condition, the rendering offload request associated with the offload rendering operation of the multi-media content; and receiving, from the second network entity, a response indication associated with an offload indication response.
Aspect 20 is the method of aspect 19, wherein the offload indication response is an offload acknowledgement indicative of an acceptance of the rendering offload request; wherein transmitting, to the first network entity via the first out-of-band signaling, the viewport information is based on the offload acknowledgement indicative of the acceptance of the rendering offload request.
Aspect 21 is the method of any of aspects 17 to 20, further comprising: transmitting, to the first network entity via second out-of-band signaling and subsequent to receiving the viewport, a first offload cancelation indication, and receiving, from the first network entity via third out-of-band signaling and based on the first offload cancelation indication, an offload cancelation acknowledgement; or receiving, from the first network entity, a second offload cancelation indication.
Aspect 22 is the method of aspect 21, wherein transmitting the first offload cancelation indication includes obtaining an offload cancelation request associated with a determination of a cancelation condition at the UE; or the method further comprising: ceasing transmissions of further viewport information based on at least one of the first offload cancelation indication or the second offload cancelation indication.
Aspect 23 is an apparatus for wireless communication at a network entity, comprising: at least one memory; and at least one processor coupled to the at least one memory, the at least one processor is configured to perform the method of any of aspects 1 to 8.
Aspect 24 is an apparatus for wireless communication at a network entity, comprising means for performing each step in the method of any of aspects 1 to 8.
Aspect 25 is the apparatus of any of aspects 23 to 24, further comprising a transceiver configured to receive or to transmit in association with the method of any of aspects 1 to 8.
Aspect 26 is a computer-readable medium storing computer executable code at a network entity, the code when executed by at least one processor causes the at least one processor to perform the method of any of aspects 1 to 8.
Aspect 27 is an apparatus for wireless communication at a network entity, comprising: at least one memory; and at least one processor coupled to the at least one memory, the at least one processor is configured to perform the method of any of aspects 9 to 16.
Aspect 28 is an apparatus for wireless communication at a network entity, comprising means for performing each step in the method of any of aspects 9 to 16.
Aspect 29 is the apparatus of any of aspects 27 to 28, further comprising a transceiver configured to receive or to transmit in association with the method of any of aspects 9 to 16.
Aspect 30 is a computer-readable medium storing computer executable code at a network entity, the code when executed by at least one processor causes the at least one processor to perform the method of any of aspects 9 to 16.
Aspect 31 is an apparatus for wireless communication at a UE, comprising: at least one memory; and at least one processor coupled to the at least one memory, the at least one processor is configured to perform the method of any of aspects 17 to 22.
Aspect 32 is an apparatus for wireless communication at a UE, comprising means for performing each step in the method of any of aspects 17 to 22.
Aspect 33 is the apparatus of any of aspects 31 to 32, further comprising a transceiver configured to receive or to transmit in association with the method of any of aspects 17 to 22.
Aspect 34 is a computer-readable medium storing computer executable code at a UE, the code when executed by at least one processor causes the at least one processor to perform the method of any of aspects 17 to 22.

What is claimed is:

1. An apparatus for wireless communication at a first network entity, comprising:
at least one memory; and
at least one processor coupled to the at least one memory and, based at least in part on stored information that is stored in the at least one memory, the at least one processor is configured to:
transmit, to a second network entity that is different from the first network entity, an offload indication of a rendering offload request associated with an offload rendering operation of multi-media content for a user equipment (UE); and
receive, from the second network entity, an offload indication response based on the offload indication.

2. The apparatus of claim 1, wherein the at least one processor is further configured to:
receive, from the UE via first out-of-band signaling, the rendering offload request associated with the offload rendering operation of the multi-media content; and
transmit, to the UE, a response indication associated with the offload indication response.

3. The apparatus of claim 2, wherein the offload indication response is an offload rejection indicative of a denial of the rendering offload request, and wherein the response indication indicates the denial and comprises second out-of-band signaling.

4. The apparatus of claim 3, wherein at least one of the first out-of-band signaling or the second out-of-band signaling comprise information of at least one additional UE that is associated with the offload rendering operation of the multi-media content.

5. The apparatus of claim 1, wherein the offload indication response is an offload acknowledgement indicative of an acceptance of the rendering offload request;
wherein the at least one processor is further configured to:
transmit, to the second network entity, information of at least one additional UE that is associated with the offload rendering operation of the multi-media content.

6. The apparatus of claim 1, wherein the offload indication response is an offload acknowledgement indicative of an acceptance of the rendering offload request;
wherein the at least one processor is further configured to:
transmit, to the UE via out-of-band signaling, an offload notification that is associated with the offload indication response and that is indicative of transmission of the offload indication of the rendering offload request.

7. The apparatus of claim 1, wherein the at least one processor is further configured to at least one of:
transmit, to the second network entity and subsequent to reception of the offload indication response, a first offload cancelation indication, and receive, from the second network entity based on the first offload cancelation indication, an offload cancelation acknowledgement; or
receive, from the second network entity, a second offload cancelation indication.

8. The apparatus of claim 7, wherein to transmit the first offload cancelation indication, the at least one processor is configured to:
obtain an offload cancelation request associated with at least one of a UE request or a determination of a cancelation condition at the first network entity.

9. An apparatus for wireless communication at a first network entity, comprising:
at least one memory; and
at least one processor coupled to the at least one memory and, based at least in part on stored information that is stored in the at least one memory, the at least one processor is configured to:
receive, from a second network entity that is different from the first network entity, an offload indication of a rendering offload request associated with an offload rendering operation of multi-media content for a user equipment (UE); and
transmit, to a third network entity that is different from the first network entity, an offload indication response based on the offload indication.

10. The apparatus of claim 9, wherein the offload indication response is an offload rejection indicative of a denial of the rendering offload request based on an indication of a rendering overload;
wherein the at least one processor is further configured to:
obtain, subsequent to transmission of the offload indication response, a rendering availability indication indicative of an absence of the rendering overload; and
transmit, to the second network entity and based on the rendering availability indication, an offload availability indication indicative of an availability at the first network entity for offload rendering.

11. The apparatus of claim 10, wherein the offload availability indication is further indicative of a number of rendering processes associated with the availability at the first network entity for the offload rendering.

12. The apparatus of claim 9, wherein the first network entity is a render server and the second network entity is the UE;
wherein to receive the offload indication of the rendering offload request, the at least one processor is configured to:
receive, from the UE, viewport information associated with the rendering offload request and the offload rendering operation of the multi-media content for the UE;
wherein the at least one processor is further configured to:
render a viewport based on the viewport information and an offload notification acknowledgement; and
transmit, for the UE, the viewport.

13. The apparatus of claim 12, wherein the third network entity is a host server, and wherein the offload indication response is an offload notification;
wherein the at least one processor is further configured to:
receive, from the host server, the offload notification acknowledgement subsequent to transmission of the offload notification.

14. The apparatus of claim 12, wherein the at least one processor is further configured to:
receive, from the third network entity, information of at least one additional UE that is associated with the offload rendering operation of the multi-media content;
wherein to render the viewport, the at least one processor is configured to render the viewport further based on the information of the at least one additional UE.

15. The apparatus of claim 9, wherein the at least one processor is further configured to at least one of:
receive, from the third network entity and subsequent to transmission of the offload indication response, a first offload cancelation indication, and transmit, to the third network entity based on the first offload cancelation indication, an offload cancelation acknowledgement; or
transmit, to at least one of the second network entity or the third network entity, a second offload cancelation indication.

16. The apparatus of claim 15, wherein to transmit the second offload cancelation indication, the at least one processor is configured to obtain an offload cancelation request associated with at least one of a UE request or a determination of a cancelation condition at the first network entity.

17. An apparatus for wireless communication at a user equipment (UE), comprising:
at least one memory; and
at least one processor coupled to the at least one memory and, based at least in part on information stored in the at least one memory, the at least one processor is configured to:
obtain an offload indication of a rendering offload request associated with an offload rendering operation of multi-media content for the UE;
transmit, to a first network entity, viewport information associated with the rendering offload request and the offload rendering operation of the multi-media content; and
receive, from the first network entity, a viewport associated with a rendering that is based on the viewport information.

18. The apparatus of claim 17, wherein to obtain the offload indication of the rendering offload request, the at least one processor is configured to at least one of:
determine an offload condition at the UE; or
receive, from a second network entity via first out-of-band signaling, the offload indication of the rendering offload request.

19. The apparatus of claim 18, wherein the at least one processor is further configured to:
transmit, to the second network entity via second out-of-band signaling and based on the determined offload condition, the rendering offload request associated with the offload rendering operation of the multi-media content; and
receive, from the second network entity, a response indication associated with an offload indication response.

20. The apparatus of claim 19, wherein the offload indication response is an offload acknowledgement indicative of an acceptance of the rendering offload request;
wherein to transmit, to the first network entity, the viewport information, the at least one processor is configured to transmit the viewport information based on the offload acknowledgement indicative of the acceptance of the rendering offload request.

21. The apparatus of claim 17, wherein the at least one processor is further configured to at least one of:
transmit, to the first network entity via first out-of-band signaling and subsequent to reception of the viewport, a first offload cancelation indication, and receive, from the first network entity via second out-of-band signaling and based on the first offload cancelation indication, an offload cancelation acknowledgement; or
receive, from the first network entity, a second offload cancelation indication.

22. The apparatus of claim 21, wherein to transmit the first offload cancelation indication, the at least one processor is configured to obtain an offload cancelation request associated with a determination of a cancelation condition at the UE; or
wherein the at least one processor is further configured to:
cease transmissions of further viewport information based on at least one of the first offload cancelation indication or the second offload cancelation indication.
